(19) United States
(12) Patent Application Publication
(10) Pub. No.: US 2026/0329637 A1
(43) Pub. Date: Oct. 22, 2026

(54) SYSTEM

(71) Applicant: SoftBank Group Corp., Tokyo (JP)

(72) Inventor: Akira SUGIHARA, Tokyo (JP)

(73) Assignee: SoftBank Group Corp., Tokyo (JP)

(21) Appl. No.: 19/650,407

(22) Filed: Apr. 17, 2026

(30) Foreign Application Priority Data
Apr. 22, 2025 (JP) 2025-070240

(51) Int. Cl. G06F 9/48; G06N 5/04; G16Y 10/60

(52) U.S. Cl. CPC G06F 9/4881; G06N 5/04; G16Y 10/60

(57) ABSTRACT

The present invention relates to a system that multilaterally and comprehensively collects and integrates health data, behavior data, and communication data, and performs cognitive function evaluation, risk prediction, individually optimized intervention plan generation, AI coaching, and feedback generation using a generative AI, in order to eliminate anxiety about cognitive function decline and dementia risk of elderly people and realize extension of healthy life expectancy. The system continuously proposes brain training, lifestyle improvement advice, introduction of a social participation event, and the like optimized for each user, detects a minute change in cognitive function at an early stage, and encourages a medical examination at a specialized institution, thereby comprehensively supporting dementia prevention and quality of life improvement.

### CROSS-REFERENCE TO RELATED APPLICATION

The present application claims priority to and incorporates by reference the entire contents of Japanese Patent Application No. 2025-070240 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to integrally and comprehensively collect and analyze diverse data such as health conditions, lifestyle habits, behavior patterns, and communication statuses that differ for each user, predict individual cognitive function states and risks with high accuracy, automatically generate a dementia prevention program optimized for interests and a living situation of the user, further maintain motivation and monitor an implementation status through continuous coaching and feedback by AI, and detect a minute change in cognitive function at an early stage and encourage a medical examination at a specialized institution as necessary, thereby realizing reduction of dementia risk, extension of healthy life expectancy, and reduction of medical expense burden, and contributing to the realization of a society where elderly people can live safely in their own way, because of the current situation where there are few opportunities to perform appropriate and continuous cognitive function maintenance activities in daily life and early detection of dementia is difficult despite increasing anxiety about cognitive function decline and dementia onset risk associated with aging among elderly people, especially married couple households around 80 years old.

### SUMMARY OF THE INVENTION

Means for solving the problem according to the present invention is to configure a system comprising a health data acquisition unit, a behavior data acquisition unit, a communication data acquisition unit, a data integration unit, a cognitive function evaluation unit, a risk prediction unit, an intervention plan generation unit, and an AI coaching unit, automatically acquire health-related data such as vital information, medical history, and family history of a user from an external service, a wearable terminal, or the like by the health data acquisition unit, acquire behavior data such as a behavior pattern in daily life of the user, a frequency of forgetfulness, an implementation status of social activities, an amount of exercise, and a frequency of going out by the behavior data acquisition unit, acquire communication data such as a conversation frequency of the user, a usage status of an SNS or a message application, and contents and a number of times of interpersonal communication by the communication data acquisition unit, integrate these health data, behavior data, and communication data to generate an integrated data set for each user by the data integration unit, analyze daily conversation contents and behavior patterns of the user using a generative AI based on the integrated data set to calculate a cognitive function score by the cognitive function evaluation unit, individually predict a dementia onset risk using a generative AI based on the cognitive function score and the integrated data set by the risk prediction unit, automatically generate an individually optimized prevention program using a generative AI based on the risk prediction result and interests and a living situation of the user by the intervention plan generation unit, and propose the prevention program to the user by voice or text, monitor an implementation status of the user, perform periodic cognitive function evaluation and feedback, detect a minute change in cognitive function at an early stage, and recommend a medical examination at a specialized institution as necessary by the AI coaching unit, thereby continuously and effectively realizing dementia prevention activities optimized for each user.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### First Embodiment

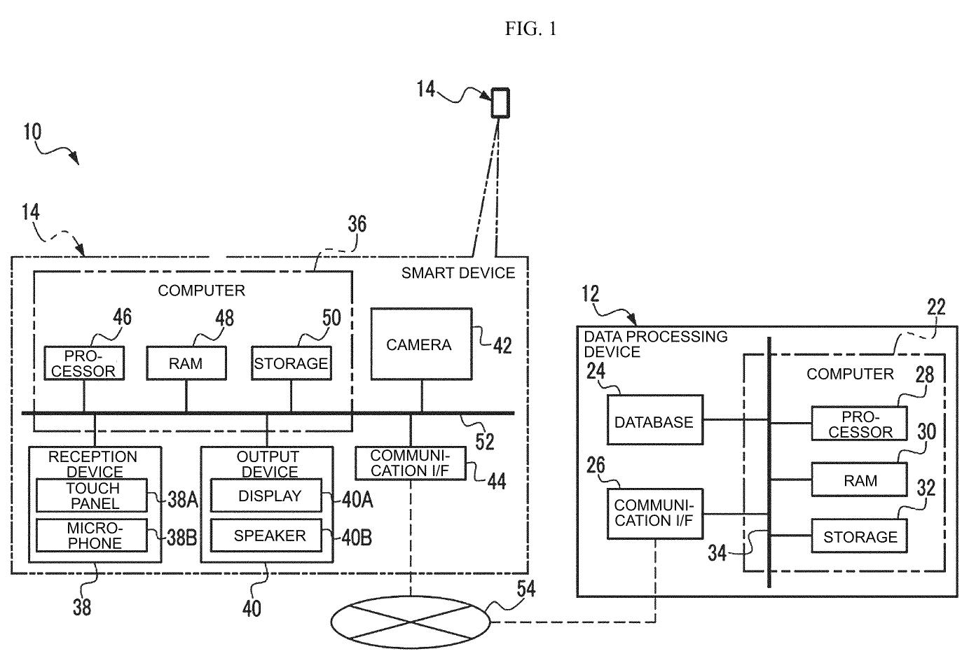

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40Adisplays visible information such as text and images according to instructions from the processor 46. The speaker 40Boutputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

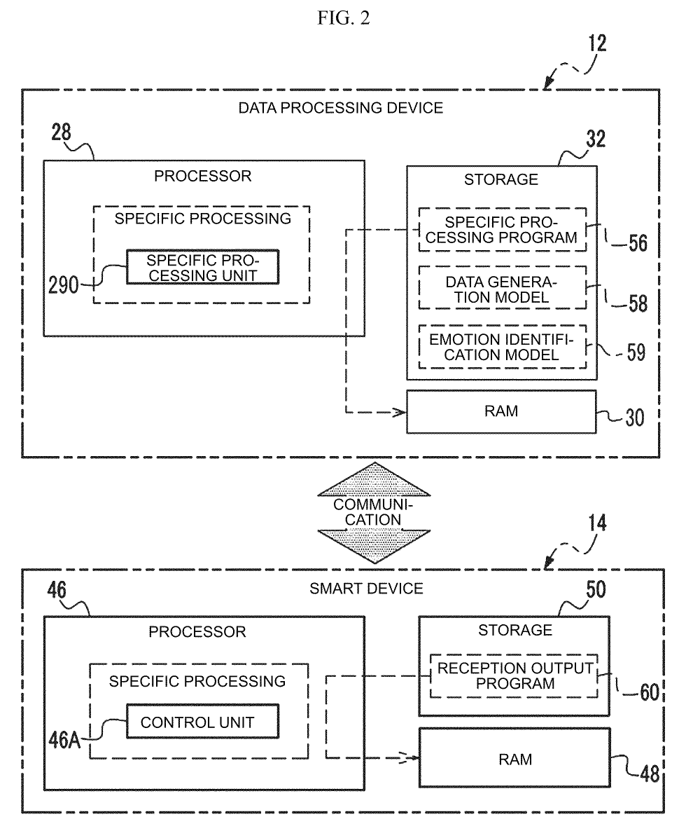

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a "server," and the smart device 14 is referred to as a "terminal."

### Embodiment for carrying out the present invention

Embodiments for carrying out the present invention will be described in more detail and comprehensively with higher specificity.

The system of the present invention is configured by connecting a server and a user terminal (a smartphone, a tablet, a personal computer, a wearable device, or the like) via a network. Among each unit of the system, the health data acquisition unit, the behavior data acquisition unit, the communication data acquisition unit, the data integration unit, the cognitive function evaluation unit, the risk prediction unit, the intervention plan generation unit, and the AI coaching unit are mainly realized on the server, but a part of data acquisition, a user interface, voice input/output, notification, feedback transmission, and the like are also executed on the user terminal side. Specifically, the present system adopts a distributed processing architecture that connects the server and the user terminal via a network. The present system arranges a parallel computing cluster using a GPU on the server side. The present system implements an edge computing module on the user terminal side. The present system primarily processes raw data acquired on the user terminal side on the edge side. The present system transmits only a feature vector extracted by the primary processing to the server. The present system significantly reduces a load on a communication band by this configuration. The present system optimizes consumption of computing resources on the server side. The present system realizes real-time data processing. The present system improves a processing speed of the entire system by this technical improvement. The present system provides a user experience without delay. The present system is used for a monitoring service for the elderly and a telemedicine monitoring system as specific application fields. The present system containerizes each processing unit operating on the server as a microservice architecture. The present system asynchronously executes communication between the respective processing units using a lightweight messaging protocol. The present system thereby ensures scalability of the system. The present system executes a part of data acquisition and user interface processing by a local processor of the user terminal. The present system thereby realizes fault tolerance that provides a minimum function even when the network is disconnected.

First, the health data acquisition unit automatically acquires vital information (for example, a heart rate, a blood pressure, a body temperature, a number of steps, a sleep time, a body weight, a blood glucose level, an oxygen saturation, consumed calories, a resting heart rate, an exercise intensity, a wake-up/bedtime, and the like), a medical history (for example, a stroke, a heart disease, diabetes, hypertension, depression, a fracture history, a surgery history, and the like), a family history (for example, whether there is a person who has developed dementia, a stroke, Parkinson's disease, or the like in relatives), a medication history (for example, an antihypertensive drug, an anti-dementia drug, an antidepressant, a sleeping pill, a supplement, and the like), allergy information, and a periodic health examination result (for example, a blood test value, a urine test value, an imaging diagnosis result, and the like) of the user from a health management application or a wearable device (for example, a smart watch, an activity meter, a sphygmomanometer, a thermometer, a pulse oximeter, a blood glucose meter, and the like) installed in the user terminal. These data are transmitted from the terminal to the server by encrypted communication, and are accumulated and managed in a time-series database on the server side. For example, data is recorded at a fine granularity, such as a blood pressure measurement value every morning, a total number of steps per week, and a body weight transition per month. Specifically, the present health data acquisition unit constructs a data pipeline that continuously collects time-series data from an IoT device. The present health data acquisition unit digitizes a biological signal acquired from each device at a predetermined sampling rate. The present health data acquisition unit expands the digitized data on a memory as a time-series tensor. The present health data acquisition unit executes preprocessing on this time-series tensor. The present health data acquisition unit executes a high-frequency noise removal process using a moving average filter as the preprocessing. The present health data acquisition unit executes an interpolation process of a missing value using a spline interpolation algorithm as the preprocessing. The present health data acquisition unit stores the preprocessed data in the time-series database on the server side. The present health data acquisition unit adopts a columnar format using a time stamp as a primary key in the time-series database. The present health data acquisition unit thereby dramatically improves a data writing speed and a search speed. The present health data acquisition unit optimizes management efficiency of enormous vital data by this technical improvement. The present health data acquisition unit provides a foundation for a subsequent AI model to extract a highly accurate feature amount. The present health data acquisition unit is used for a sign detection system for a chronic disease and a personalized health management platform as specific application fields. The present health data acquisition unit stores static data such as a periodic health examination result in a relational database as structured data. The present health data acquisition unit centrally manages dynamic time-series data and static structured data by linking them with a user ID.

The behavior data acquisition unit acquires a behavior pattern in daily life of the user (for example, a frequency of going out, a moving distance, an amount of exercise, a number of times of participation in shopping or hobby activities, an implementation status of housework, a sleep rhythm, a meal time, a bathing time, a number of times of going to a toilet, a television viewing time, a reading time, presence or absence of a nap, a diversity of walking courses, a usage status of public transportation, and the like), a frequency of forgetfulness (for example, forgetting a schedule, misplacing belongings, forgetting a promise, a mistake in a cooking procedure, forgetting a shopping list, forgetting to take out garbage, forgetting to take medication, and the like), and an implementation status of social activities (for example, participation in a local event, volunteer activity, attendance at a hobby circle, visiting a friend's house, neighborhood association activity, travel, eating out with family, attendance at a ceremonial occasion, and the like) using a GPS function, an acceleration sensor, a gyro sensor, a calendar application, a behavior recording application, a voice input application, an image recognition application, and the like of the user terminal. For example, in cooperation with the calendar application, input, execution, and forgetting of a schedule are automatically recorded, a destination and a moving route are automatically determined from GPS data, and an exercise intensity and a walking pattern are analyzed from the acceleration sensor. Furthermore, using the image recognition application, it is also possible to manage ingredients in a refrigerator, recognize a medication package, confirm a garbage disposal status, and the like. Specifically, the present behavior data acquisition unit acquires multidimensional physical quantity data from various sensors mounted on the user terminal. The present behavior data acquisition unit converts the acquired physical quantity data into a multidimensional vector. The present behavior data acquisition unit uses a convolutional neural network in the image recognition application. The present behavior data acquisition unit uses an RGB image tensor acquired from a camera as input data to this neural network. The present behavior data acquisition unit defines the number of dimensions of the input data as a three-dimensional array of width, height, and color channels. The present behavior data acquisition unit executes normalization and resizing processing of an image as preprocessing of the input data. The present behavior data acquisition unit inputs an image tensor obtained by photographing ingredients in a refrigerator or an image tensor obtained by photographing a medication package as a specific example of the input data. The present behavior data acquisition unit acquires output data from the neural network. The present behavior data acquisition unit outputs a probability distribution for each predefined object class as a format of the output data. The present behavior data acquisition unit configures each output value to mean a probability that a specific object exists. The present behavior data acquisition unit outputs a probability of 0.95 that milk exists or a probability of 0.88 that an antihypertensive drug package exists as a specific example of the output data. The present behavior data acquisition unit uses this output result for subsequent processing. The present behavior data acquisition unit executes a process of recording an object label whose probability exceeds a threshold value in a database as the subsequent processing. The present behavior data acquisition unit uses a recurrent neural network in time-series behavior recognition. The present behavior data acquisition unit inputs time-series data of the acceleration sensor to the recurrent neural network, and classifies a behavior state such as walking or resting. The present behavior data acquisition unit realizes highly accurate behavior tracking that does not rely on human visual observation by this unconventional procedure. The present behavior data acquisition unit is used for a life rhythm monitoring system for an elderly person living alone and a rehabilitation support system as specific application fields.

The communication data acquisition unit acquires a conversation frequency (for example, a number of telephone calls with family and friends, a number of times of sending and receiving messages, an SNS posting frequency, a number of video calls, a number of times of sending emails, a number of times of sharing photos and videos, and the like) and contents and a number of times of interpersonal communication (for example, a length of conversation, a diversity of topics, presence or absence of emotional expression, repetition of the same topic, a response speed to a question, a topic switching frequency, presence or absence of a joke or laughter, calling a wrong name of a partner, confusion of a family structure, confusion of a date or a day of the week, and the like) of the user using a call history, a message application, a usage status of an SNS, a voice recognition function, a video call application, an email application, a camera application, and the like of the user terminal. For example, contents of daily conversation are converted into text using the voice recognition function, and fluency of conversation, diversity of vocabulary, logical connection, emotional expression, transition of topics, consistency of conversation, expression of consideration for a partner, and the like are analyzed by natural language processing technology. From the usage status of the SNS or the message application, a frequency and a time zone of interaction, a reply speed, a tendency to ignore a read message, a usage frequency of a stamp or a pictogram, and the like can also be acquired. Specifically, the present communication data acquisition unit implements a natural language processing pipeline for analyzing voice data and text data. The present communication data acquisition unit extracts a mel-frequency cepstrum coefficient from the acquired voice waveform in the voice recognition function. The present communication data acquisition unit inputs the extracted acoustic feature amount to a transformer-based voice recognition model, and converts it into text data. The present communication data acquisition unit inputs the converted text data to a large language model. The present communication data acquisition unit uses a word embedding vector as input data to the large language model. The present communication data acquisition unit defines the number of dimensions of the input data as, for example, a 768-dimensional dense vector. The present communication data acquisition unit includes a semantic representation of utterance contents as element contents of the input data. The present communication data acquisition unit executes removal of a stop word and tokenization processing as preprocessing of the input data. The present communication data acquisition unit inputs an embedding vector of a conversation text with family or an embedding vector of a posted sentence to the SNS as a specific example of the input data. The present communication data acquisition unit acquires output data from the large language model. The present communication data acquisition unit outputs a numerical vector indicating an emotion score or a fluency index as a format of the output data. The present communication data acquisition unit configures each output value to mean a level of a psychological state or a language ability of the user. The present communication data acquisition unit outputs a positive emotion score of 0.8 or a vocabulary diversity score of 0.6 as a specific example of the output data. The present communication data acquisition unit uses this output result for subsequent processing. The present communication data acquisition unit executes a process of accumulating these scores in chronological order and transmitting them to the data integration unit as the subsequent processing. The present communication data acquisition unit detects a minute cognitive change that is difficult for a human to notice by calculation in a high-dimensional space. The present communication data acquisition unit is used for a mental health care application and an early dementia detection system as specific application fields.

The data integration unit integrates the health data, the behavior data, and the communication data for each user on the server to generate an integrated data set managed in chronological order. For example, vital information, an outing history, conversation contents, a record of social activities, a medication status, meal contents, a sleep time, an amount of exercise, an SNS usage status, interaction with family, an implementation status of hobby activities, and the like on a certain day are summarized as one record so that a long-term change and tendency can also be grasped. The data integration unit also performs correction of data missing or an abnormal value, anonymization processing for privacy protection, and normalization and standardization of data. Specifically, the present data integration unit executes an early fusion algorithm or a late fusion algorithm for integrating heterogeneous multimodal data. The present data integration unit combines feature vectors extracted from each of the health data, the behavior data, and the communication data on a memory. The present data integration unit generates a combined high-dimensional integrated feature vector. The present data integration unit executes a normalization algorithm in a process of data integration. The present data integration unit applies Z-score normalization or min-max scaling as the normalization algorithm. The present data integration unit thereby unifies a scale of each feature amount. For data missing, the present data integration unit estimates and complements a missing value with high accuracy using a machine learning-based multiple imputation method. The present data integration unit anonymizes personal identification information using an irreversible hash function for privacy protection. The present data integration unit saves the anonymized data in a secure storage area. The present data integration unit significantly improves a learning convergence speed of a subsequent machine learning model by these processes. The present data integration unit brings about technical effects of calculation efficiency improvement and prediction accuracy improvement of the model. The present data integration unit is used for a large-scale medical data analysis platform and a personal health record management system as specific application fields. The present data integration unit can also adopt a configuration in which the integrated data set is stored in a graph database and a relationship between each data is expressed by a node and an edge. The present data integration unit thereby realizes high-speed search and analysis of a complex correlation.

The cognitive function evaluation unit analyzes the integrated data set on the server, and calculates a cognitive function score from daily conversation contents and behavior patterns of the user using a generative AI. For example, contents of conversation are analyzed in detail using natural language processing technology by a generative AI, and repetition of the same topic, stuttering, a response speed to a question, diversity of vocabulary, logical connection, richness of emotional expression, use of a joke or a metaphor, accurate recognition of a partner's name or a date, consistency of conversation, a topic switching frequency, deviation of a topic, expression of consideration for a partner, and the like are used as evaluation indexes. In addition, a change in behavior patterns (for example, a rapid decrease in a frequency of going out, a decline in motivation to participate in hobby activities, an increase in forgetfulness, a disturbance of a sleep rhythm, a decrease in a number of meals, an increase in forgetting to take medication, a procedural mistake in housework, and the like) is also reflected in scoring. Furthermore, using a generative AI, a minute change in cognitive function is extracted from the entire life of the user, and is quantified as a score such as a perfect score of 100. For example, a weekly score transition is graphed, and an abnormal value is detected by comparing it with a past average value or standard deviation. Specifically, the present cognitive function evaluation unit calculates the cognitive function score using a large language model based on a transformer architecture. The present cognitive function evaluation unit inputs data to the large language model. The present cognitive function evaluation unit uses a multimodal feature vector generated by the data integration unit as input data. The present cognitive function evaluation unit sets the number of dimensions of this input data to, for example, 1024 dimensions. The present cognitive function evaluation unit includes an embedding representation of a conversation text, a numerical array of a behavior frequency, and a time-series statistic of vital data as element contents of the input data. The present cognitive function evaluation unit executes a linear transformation process of projecting data of each modality into the same latent space as preprocessing of the input data. The present cognitive function evaluation unit inputs a numerical vector indicating a number of times of going out in the past one week or a time-series array indicating an utterance interval during conversation as a specific example of the input data. The present cognitive function evaluation unit acquires output data from the large language model. The present cognitive function evaluation unit outputs a continuous value score from 0 to 100 and a probability distribution of each cognitive domain as a format of the output data. The present cognitive function evaluation unit configures each output value to mean a current comprehensive cognitive function level of the user or a decline risk of a specific function such as memory or language ability. The present cognitive function evaluation unit outputs a numerical value of a comprehensive cognitive score of 85 or a floating-point number of a language ability decline probability of 0.2 as a specific example of the output data. The present cognitive function evaluation unit uses this output result for subsequent processing. The present cognitive function evaluation unit executes a process of inputting the output score to a time-series anomaly detection algorithm and calculating a degree of deviation from a past baseline as the subsequent processing. The present cognitive function evaluation unit trains this model in advance using self-supervised learning and a cross-entropy error function. The present cognitive function evaluation unit realizes objective and highly accurate evaluation that does not depend on human subjectivity by this technical improvement. The present cognitive function evaluation unit is used for an online cognitive function test service and a smart home system for the elderly as specific application fields.

The risk prediction unit individually predicts a dementia onset risk using a machine learning model (for example, a deep learning model, a decision tree model, a random forest model, a gradient boosting model, and the like) by a generative AI based on the cognitive function score and the integrated data set on the server. For example, a plurality of factors such as a family history, a medical history, vital information, a transition of a cognitive function score, a frequency of social activities, quality of communication, lifestyle habits (for example, smoking, drinking, exercise, a meal, sleep, stress, hobby activities, social participation, intellectual activities, emotional expression, and the like), a medication status, a medical institution consultation history, a fall history, an accident history, a driving status, an economic status, a living environment, and a support system are used as inputs, and a risk level (for example, low, medium, high) is calculated based on a pattern learned from an enormous amount of past data by a generative AI. Furthermore, a generative AI can explain an explanation of a risk factor and which factor contributes to a risk increase to the user and family in natural language. For example, it specifically explains, "Because a frequency of going out has recently decreased and repetition of conversation has increased, a dementia risk is increasing." Specifically, the present risk prediction unit adopts an ensemble learning architecture combining a gradient boosting model and a deep learning model. The present risk prediction unit inputs data to the machine learning model. The present risk prediction unit uses an integrated feature vector and time-series transition data of the cognitive function score as input data. The present risk prediction unit sets the number of dimensions of this input data to, for example, 2048 dimensions. The present risk prediction unit includes a numerical vector of age and blood pressure, an array of a social activity frequency, and a genetic risk score as element contents of the input data. The present risk prediction unit executes a dimension reduction process by principal component analysis as preprocessing of the input data. The present risk prediction unit inputs an array indicating a cognitive score transition in the past six months or a numerical value indicating a coefficient of variation of a sleep time as a specific example of the input data. The present risk prediction unit acquires output data from the machine learning model. The present risk prediction unit outputs a score from 0.0 to 1.0 indicating an onset probability and a SHAP value indicating a risk contribution degree of each feature amount as a format of the output data. The present risk prediction unit configures each output value to mean a statistical probability of developing dementia within a specific period in the future and a specific factor boosting the probability. The present risk prediction unit outputs an onset probability of 0.75 within three years or a contribution degree of 0.3 of a decrease in going out as a specific example of the output data. The present risk prediction unit uses this output result for subsequent processing. The present risk prediction unit executes a branching process of transmitting a trigger signal to the intervention plan generation unit when the onset probability exceeds a predetermined threshold value as the subsequent processing. The present risk prediction unit optimizes a weight using a gradient descent method and a backpropagation algorithm in learning of the model. The present risk prediction unit resolves a black box problem of AI by calculating the SHAP value, and ensures transparency of a prediction basis. The present risk prediction unit is used for a preventive medical support system and a health promotion program of an insurance company as specific application fields.

The intervention plan generation unit automatically generates an individually optimized prevention program using a generative AI based on the risk prediction result and interests and a living situation of the user on the server. For example, when the user is interested in puzzles, music, cooking, gardening, reading, travel, photography, handicrafts, Go, Shogi, karaoke, walking, dancing, yoga, volunteer activities, local events, interaction with family, pet breeding, and the like, a generative AI proposes a combination of a plurality of types of interventions such as a brain training program (for example, a crossword, Sudoku, a memory game, a calculation problem, wordplay, illustration memory, story creation, photo classification, music appreciation, singing, playing a musical instrument, cooking recipe memory, gardening diary creation, travel record creation, book report creation, photo album creation, handicraft work recording, Go/Shogi match, karaoke scoring, walking course proposal, dance video viewing, yoga pose instruction, volunteer activity introduction, local event participation guidance, common topic proposal with family, play style proposal with a pet, and the like), lifestyle improvement advice (for example, meal balance, exercise habits, a sleep rhythm, stress management, medication management, smoking cessation/drinking reduction, fall prevention, infectious disease prevention, oral care, excretion management, bathing habits, hand washing/gargling, weight management, blood pressure management, blood glucose management, supplement utilization, health examination consultation recommendation, and the like), introduction of a social participation event (for example, a local circle, a hobby class, a sports club, a volunteer group, neighborhood association activity, a travel tour, a cultural festival, a lecture, a movie screening, a karaoke competition, a cooking class, a gardening class, a reading group, a photo exhibition, a Go/Shogi tournament, a pet event, and the like), and recommendation of a medical examination at a specialized institution (for example, a dementia specialist, neurology, psychiatry, psychosomatic medicine, rehabilitation, a comprehensive community support center, a nursing care provider, visiting nursing, pharmacist consultation, dietitian consultation, social worker consultation, and the like) according to the preference. Furthermore, using image generation technology by a generative AI, it is also possible to automatically generate an illustration or a quiz for brain training dedicated to the user, and personalized cognitive stimulation contents (for example, memory training using a family photo of the user, a quiz about a birthplace or a memorable place, an illustration or a video related to a hobby, brain training contents tailored to a season or an event, and the like). Specifically, the present intervention plan generation unit adopts a hybrid architecture integrating a reinforcement learning algorithm and an image generation AI based on a diffusion model. The present intervention plan generation unit inputs data to the reinforcement learning model. The present intervention plan generation unit uses a profile vector of the user, a risk prediction score, and a past intervention history tensor as input data. The present intervention plan generation unit defines the number of dimensions of this input data as a dynamically variable tensor. The present intervention plan generation unit includes a categorical variable indicating a hobby and preference of the user and a numerical array indicating a past task completion rate as element contents of the input data. The present intervention plan generation unit executes one-hot encoding processing of the categorical variable as preprocessing of the input data. The present intervention plan generation unit inputs a flag vector indicating a love of music or a numerical value indicating a past puzzle completion rate of 0.8 as a specific example of the input data. The present intervention plan generation unit acquires output data from the reinforcement learning model. The present intervention plan generation unit outputs an identifier array of optimal intervention contents and a schedule matrix as a format of the output data. The present intervention plan generation unit configures each output value to mean a specific type of program to be provided to the user and an optimal date and time to present it. The present intervention plan generation unit outputs an identifier of brain training ID 102 or a time vector indicating a recommended time zone as a specific example of the output data. The present intervention plan generation unit uses this output result for subsequent processing. The present intervention plan generation unit executes a process of transmitting the generated schedule to the AI coaching unit as the subsequent processing. The present intervention plan generation unit further inputs a text prompt vector to the image generation AI, and causes it to output an image tensor for brain training dedicated to the user. The present intervention plan generation unit realizes a dramatic improvement in personalization accuracy and efficient allocation of computing resources by this technical improvement. The present intervention plan generation unit is used for a digital therapy application and an automatic recreation generation system for a nursing care facility as specific application fields.

The AI coaching unit distributes the prevention program generated on the server to the user terminal, and proposes it to the user through an interactive interface by voice or text (for example, a voice assistant, a chatbot, a notification application, calendar linkage, a reminder function, a push notification, a vibration notification, a screen display, video playback, music playback, and the like) on the user terminal. For example, it makes a specific action proposal every morning, such as "Let's do a 10-minute puzzle brain training today," "Why don't you participate in a neighborhood circle activity in the afternoon?", "You have been going out less recently, but how about taking a walk for a change of pace?", "Let's make a video call with your family today," "Why don't you try a new cooking recipe?", and "There is a local movie screening this week." When the user follows the proposal, the implementation status is fed back from the terminal to the server, and the AI coaching unit analyzes motivation and the implementation status of the user using a generative AI, and provides encouragement, a reminder, and feedback at an optimal timing and method. For example, when the user cannot continue the activity, it changes a call, such as "Let's continue within a possible range without overdoing it," "Why don't you work on it with your family?", "Let's listen to your favorite music for a change of pace today," "You did your best yesterday," and "Let's try something new this week." Furthermore, it also analyzes a reaction and emotional expression of the user, an activity implementation status, a life rhythm, a physical condition change, feedback from family, and the like, and dynamically optimizes coaching contents. Specifically, the present AI coaching unit includes a dialogue generation engine using a large language model and a voice synthesis module. The present AI coaching unit inputs data to the dialogue generation engine. The present AI coaching unit uses a voice text vector of the user and a current context vector as input data. The present AI coaching unit defines the number of dimensions of this input data as a matrix depending on the number of dimensions of a token embedding space. The present AI coaching unit includes a text representation of an immediately preceding user utterance, a current time, and a fatigue degree estimated value of the user as element contents of the input data. The present AI coaching unit executes prompt combination processing of context information as preprocessing of the input data. The present AI coaching unit inputs a text vector of a user utterance "I'm tired" or a time vector of a current time "3:00 PM" as a specific example of the input data. The present AI coaching unit acquires output data from the dialogue generation engine. The present AI coaching unit outputs a token probability distribution of a response text as a format of the output data. The present AI coaching unit configures each output value to mean a likelihood of a word to be generated next. The present AI coaching unit outputs a text character string "Let's rest without overdoing it" as a specific example of the output data. The present AI coaching unit uses this output result for subsequent processing. The present AI coaching unit executes a process of transmitting the generated text to the voice synthesis module, generating natural voice waveform data, and outputting it from a speaker as the subsequent processing. The present AI coaching unit sets a proposal execution rate of the user as a reward function, and continuously updates a weight of a dialogue strategy by reinforcement learning. The present AI coaching unit realizes an improvement in user engagement and dynamic state adaptation by this technical improvement. The present AI coaching unit is used for a virtual health assistant and an interactive companion robot for the elderly as specific application fields.

In addition, the AI coaching unit periodically re-executes the cognitive function evaluation, and analyzes a change in the score and a change in the behavior pattern using a generative AI. For example, when the cognitive function score rapidly decreases, or when an abnormal pattern in conversation contents (for example, an increase in meaningless remarks, a delayed response to a question, repetition of the same topic, confusion of dates and days of the week, confusion of family structure, loss of emotional expression, abandonment of hobby activities, refusal to go out, a decrease in the number of meals, an increase in forgetting to take medication, an increase in the number of falls, and the like) is detected, the generative AI automatically summarizes the contents and issues an alert to the user and the family, such as "We recommend a medical examination at a specialized institution", "Please consult your family doctor", or "Let's contact the comprehensive community support center". Furthermore, with the consent of the user, it is also possible to cooperate with a family doctor, a nursing care provider, a comprehensive community support center, a family, a social worker, a care manager, a pharmacist, a dietitian, a rehabilitation staff, and the like, and share necessary information. Specifically, the AI coaching unit implements a time-series anomaly detection algorithm to execute the periodic re-evaluation. The AI coaching unit uses an autoencoder architecture as an anomaly detection model. The AI coaching unit inputs data to the anomaly detection model. The AI coaching unit uses a time-series tensor of the latest cognitive score and behavior feature amounts as the input data. The AI coaching unit defines the number of dimensions of this input data as a two-dimensional tensor consisting of the product of the number of time steps and the number of feature amounts. The AI coaching unit includes daily score fluctuations and the occurrence frequency of a specific behavior as element contents of the input data. The AI coaching unit executes a data clipping process by a sliding window method as preprocessing of the input data. As a specific example of the input data, the AI coaching unit inputs a cognitive score array for the past seven days or a numerical vector indicating the number of repetitions of the same topic per day. The AI coaching unit acquires output data from the anomaly detection model. The AI coaching unit outputs a reconstruction error score of the input data and an anomaly flag as a format of the output data. The AI coaching unit configures each output value to mean how much the current user state deviates from a normal pattern and whether an emergency response is necessary. As a specific example of the output data, the AI coaching unit outputs a reconstruction error score of 0.85 or an anomaly flag of 1. The AI coaching unit uses this output result for subsequent processing. As the subsequent processing, when the anomaly flag is 1, the AI coaching unit executes a process of activating an alert generation module and transmitting an API call to an external medical institution system. By this technical improvement, the AI coaching unit realizes real-time anomaly detection and a rapid fail-safe mechanism. As a specific application field, the AI coaching unit is used for a telemedicine monitoring system or an emergency call service.

In this way, the system of the present invention realizes advanced data analysis, risk prediction, intervention plan generation, and coaching control utilizing a generative AI on the server, and the user terminal side is responsible for data acquisition, a user interface, voice input/output, notification, feedback transmission, and the like, thereby continuously and effectively realizing dementia prevention activities optimized for each user. For example, if the user likes traveling, the generative AI can automatically generate memory training related to traveling, brain training using travel photos, a social activity proposal at a travel destination, creation of a travel record, a quiz about the history and culture of a travel destination, promotion of communication with travel companions, and the like, and naturally incorporate them into the life of the user. For example, for a user whose hobby is cooking, a recipe memory quiz, a proposal to try a new dish, an invitation to participate in a cooking class, creation of an album of cooking photos, a proposal to treat family and friends to a dish, advice on food management and nutritional balance, a recipe proposal using seasonal ingredients, and the like are personalized and provided. For example, for a user whose conversation with family is decreasing, activation of communication is also supported by providing a reminder prompting a video call or message exchange with family, contents proposing a common topic with family, memory training using family photos, a proposal to celebrate a family birthday or anniversary, a proposal for a joint activity with family (for example, cooking, gardening, traveling, games, reading, photography, and the like). Specifically, the system constructs an end-to-end data pipeline and executes distributed processing by a multi-agent system. The system causes each processing unit to function as an independent agent, and asynchronously exchanges messages between the agents. With this architecture, the system improves the scalability of the entire system. The system dynamically distributes the calculation load even when the number of users increases, and reduces the latency of the entire system. The system executes inference processing of the generative AI at high speed on a dedicated GPU instance on the cloud. The system introduces a federated learning method that coordinates lightweight inference processing on the user terminal side and heavy inference processing on the cloud side. Thereby, the system improves the accuracy of a global model while keeping the privacy data of the user in the terminal. By this technical improvement, the system realizes both enhancement of data security and personalization accuracy. As a specific application field, the system is used for a nationwide healthy life expectancy extension project or a local government-led elderly support platform. When dynamically generating contents tailored to the hobbies and lifestyle habits of the user, the system uses a hybrid recommendation system combining a content-based filtering algorithm and a collaborative filtering algorithm. Thereby, the system uncovers the potential interests of the user and arouses a continuous motivation for use.

Furthermore, the generative AI analyzes a change in the life rhythm and preferences of the user, a transition of the implementation status, seasons and weather, a holding status of a regional event, a change in physical condition and mood, a situation of family and friends, social news and topics, regional medical and nursing care resources, and the like in real time, and dynamically optimizes the intervention plan and coaching contents. For example, physical condition management and infectious disease prevention are strengthened at the turn of the seasons, participation is encouraged when a regional event is held, a joint activity with family is proposed when there is a scheduled visit by family, and when the user complains of poor physical condition, an activity proposal within a reasonable range, a recommendation for rest, and a medical examination guide to a medical institution as necessary are automatically performed. For example, when the user falls, an emergency response can also be incorporated, such as recording details of the fall situation, proposing a fall prevention program or rehabilitation, and prompting contact with family or a medical institution. Specifically, the generative AI executes real-time analysis using a stream data processing architecture. The generative AI continuously receives environmental sensor data and information from an external API via an event-driven messaging system. The generative AI inputs data to a stream processing engine. The generative AI uses real-time environmental sensor data or a text vector of a news feed as the input data. The generative AI defines the number of dimensions of this input data as a variable-length tensor according to a batch size of the stream. The generative AI includes current temperature/humidity data or holding information text of a regional event as element contents of the input data. The generative AI executes noise filtering and text vectorization processing as preprocessing of the input data. As a specific example of the input data, the generative AI inputs numerical data indicating a temperature of 35 degrees or an embedding vector of text "summer festival held". The generative AI acquires output data from the stream processing engine. The generative AI outputs an update difference vector of the intervention plan as a format of the output data. The generative AI configures each output value to mean a change instruction for an existing schedule or an additional intervention task. As a specific example of the output data, the generative AI outputs a cancellation instruction flag for an outdoor activity or an additional task vector for a hydration reminder. The generative AI uses this output result for subsequent processing. As the subsequent processing, the generative AI executes a process of asynchronously updating a schedule matrix in a database. By this technical improvement, the generative AI ensures the responsiveness of the system to environmental changes and realizes leveling of the calculation load. As a specific application field, the generative AI is used for an elderly monitoring infrastructure in a smart city or a health management application linked with meteorological data.

In this way, the embodiment of the present invention has an extremely multifaceted and profound configuration, such as cooperation between a server and a user terminal, multilayered and dynamic utilization of a generative AI, intervention and continuous support optimized for each user, real-time data analysis and feedback, cooperation with medical, nursing care, family, and regional resources, emergency response, privacy protection, and improvement of user experience, and comprehensively realizes dementia prevention, cognitive function maintenance, healthy life expectancy extension, medical expense burden reduction, improvement of the quality of life of the elderly, burden reduction on families and local communities, and welfare improvement of the entire society. Specifically, the system according to the present embodiment is implemented as a containerized microservices architecture in a cloud computing environment. The system deploys each functional module as an independent container, and dynamically manages resources using an orchestration tool. Thereby, the system ensures high availability of the system, and realizes fault tolerance that automatically recovers without stopping the entire system even when a failure occurs in some modules. The system adopts an end-to-end encryption protocol in data transmission and reception, and completely prevents data leakage on a communication path. The system introduces a role-based access control model in access control to a database, and blocks access from an unauthorized user or process. By these technical improvements, the system satisfies strict security requirements essential for handling medical information. The system maximizes the utilization efficiency of hardware resources and reduces operation costs. As a specific application field, the system is used for a national-level medical data infrastructure or a globally deployed healthcare cloud service. The system constructs an MLOps pipeline that automates continuous data collection and a model re-learning loop, and always keeps the inference accuracy of the AI model up to date.

### System Configuration

The system according to the present embodiment comprises a health data acquisition unit, a behavior data acquisition unit, a communication data acquisition unit, a data integration unit, a cognitive function evaluation unit, a risk prediction unit, an intervention plan generation unit, an AI coaching unit, a user interface unit, a feedback management unit, and an external cooperation unit.

The health data acquisition unit automatically acquires various health-related data such as a heart rate, a blood pressure, a body temperature, a number of steps, a sleep time, a body weight, a blood glucose level, an oxygen saturation, consumed calories, a resting heart rate, an exercise intensity, a wake-up/bedtime, a medical history, a family history, a medication history, allergy information, and a periodic health examination result from a wearable device such as a smart watch, an activity meter, a sphygmomanometer, a thermometer, a pulse oximeter, or a blood glucose meter worn by the user, a health management application installed on a smartphone or a tablet, electronic medical record data of a periodic health examination, a medication management application, or the like. For example, data is collected in chronological order from a plurality of devices and applications, such as acquiring a blood pressure measurement value every morning from a smart watch via Bluetooth communication, collecting a total number of steps per week from an activity meter, acquiring a monthly body weight transition from a weight scale via Wi-Fi, and acquiring a medication status from a medication management application, and is transmitted to the server. Specifically, the health data acquisition unit executes a data compression algorithm on the edge device side. The health data acquisition unit inputs data to a microcontroller of the edge device. The health data acquisition unit uses raw waveform data acquired from a biosensor as the input data. The health data acquisition unit defines the number of dimensions of this input data as a one-dimensional array with a high sampling rate. The health data acquisition unit includes a voltage value of an electrocardiogram or continuous data of acceleration as element contents of the input data. The health data acquisition unit executes analog-to-digital conversion and band-pass filtering processing as preprocessing of the input data. As a specific example of the input data, the health data acquisition unit inputs a heartbeat waveform array sampled at 100 Hz or continuous blood pressure fluctuation data. The health data acquisition unit acquires output data from the microcontroller. The health data acquisition unit outputs a compressed vector after feature amount extraction as a format of the output data. The health data acquisition unit configures each output value to mean a statistical feature such as a peak interval or a frequency component extracted from the raw waveform. As a specific example of the output data, the health data acquisition unit outputs a numerical value indicating an average heart rate of 72 or a floating-point number indicating a standard deviation of heart rate variability. The health data acquisition unit uses this output result for subsequent processing. As the subsequent processing, the health data acquisition unit executes a process of transmitting the compressed vector to the server using a secure communication protocol. By this technical improvement, the health data acquisition unit realizes saving of a communication band and reduction of battery consumption of the edge device. As a specific application field, the health data acquisition unit is used for a wearable medical device requiring long-term continuous monitoring or a data collection system in the sports science field.

The behavior data acquisition unit acquires a behavior pattern in daily life such as a frequency of going out, a moving distance, an amount of exercise, a number of times of participation in shopping or hobby activities, an implementation status of housework, a sleep rhythm, a meal time, a bathing time, a number of times of going to a toilet, a television viewing time, a reading time, presence or absence of a nap, a diversity of walking courses, and a usage status of public transportation, using a GPS function, an acceleration sensor, a gyro sensor, a calendar application, a behavior recording application, a voice input application, an image recognition application, or the like of the user terminal. For example, in cooperation with a calendar application, input, execution, and forgetting of a schedule are automatically recorded, a destination and a moving route are automatically determined from GPS data, an exercise intensity and a walking pattern are analyzed from an acceleration sensor, and food management in a refrigerator, recognition of a medication package, confirmation of a garbage disposal status, and the like are also performed using an image recognition application. Furthermore, contents input to a diary application by the user and a behavior record by voice input are also targeted for acquisition. Specifically, the behavior data acquisition unit executes inference processing using an edge AI chip on the user terminal. The behavior data acquisition unit inputs data to an edge AI model. The behavior data acquisition unit uses a time-series tensor of 3-axis acceleration and a GPS coordinate array as the input data. The behavior data acquisition unit defines the number of dimensions of this input data as a two-dimensional tensor consisting of a time axis and a sensor axis. The behavior data acquisition unit includes an inclination of the terminal, an amount of change in acceleration, and latitude/longitude information as element contents of the input data. The behavior data acquisition unit executes removal of a gravity component and coordinate normalization processing as preprocessing of the input data. As a specific example of the input data, the behavior data acquisition unit inputs a tensor indicating acceleration fluctuation for the past 10 seconds or a coordinate array indicating a moving trajectory. The behavior data acquisition unit acquires output data from the edge AI model. The behavior data acquisition unit outputs a probability distribution of a behavior class as a format of the output data. The behavior data acquisition unit configures each output value to mean a probability of a behavior (walking, running, stationary, vehicle movement, or the like) currently performed by the user. As a specific example of the output data, the behavior data acquisition unit outputs a walking probability of 0.9 or a stationary probability of 0.1. The behavior data acquisition unit uses this output result for subsequent processing. As the subsequent processing, the behavior data acquisition unit executes a process of transmitting only a behavior label with the highest probability and a time stamp to the server as lightweight metadata. By this technical improvement, the behavior data acquisition unit realizes enhancement of privacy protection by not transmitting raw data to the server and improvement of processing speed on the edge side. As a specific application field, the behavior data acquisition unit is used for an elderly monitoring application considering privacy or a basic technology of behavioral targeting advertisement.

The communication data acquisition unit acquires contents and a number of times of interpersonal communication, such as a number of telephone calls with family and friends, a number of times of sending and receiving messages, an SNS posting frequency, a number of video calls, a number of times of sending emails, a number of times of sharing photos and videos, a length of conversation, a diversity of topics, presence or absence of emotional expression, repetition of the same topic, a response speed to a question, a topic switching frequency, presence or absence of a joke or laughter, calling a wrong name of a partner, confusion of family structure, and confusion of dates and days of the week, using a call history, a message application, a usage status of an SNS, a voice recognition function, a video call application, an email application, a camera application, or the like of the user terminal. For example, daily conversation contents are converted into text using a voice recognition function, and a frequency and a time zone of exchange, a reply speed, a tendency to ignore a read message, a usage frequency of a stamp or an emoji, and the like are also acquired from a usage status of an SNS or a message application. Specifically, the communication data acquisition unit implements a deep learning model utilizing an attention mechanism in natural language processing. The communication data acquisition unit inputs data to the deep learning model. The communication data acquisition unit uses a token embedding matrix of text as the input data. The communication data acquisition unit defines the number of dimensions of this input data as a two-dimensional matrix consisting of the product of a sequence length and the number of embedding dimensions. The communication data acquisition unit includes a transcription text of a conversation or a word vector of a message as element contents of the input data. The communication data acquisition unit executes subword tokenization and position encoding addition processing as preprocessing of the input data. As a specific example of the input data, the communication data acquisition unit inputs a token matrix of a sentence "It was fun today" or an embedding matrix of a short post text on an SNS. The communication data acquisition unit acquires output data from the deep learning model. The communication data acquisition unit outputs a feature amount vector considering a context as a format of the output data. The communication data acquisition unit configures each output value to mean a semantic representation of the entire sentence or a polarity of emotion. As a specific example of the output data, the communication data acquisition unit outputs a high-dimensional vector indicating a positive emotion or a latent vector indicating a category of a topic. The communication data acquisition unit uses this output result for subsequent processing. As the subsequent processing, the communication data acquisition unit executes a process of inputting this feature amount vector to an emotion analysis classifier and calculating a final emotion score. By this technical improvement, the communication data acquisition unit realizes improvement of accuracy of context understanding and improvement of robustness against noise. As a specific application field, the communication data acquisition unit is used for an automatic response system of customer support or a flaming detection system of an SNS.

The data integration unit integrates the health data, the behavior data, and the communication data for each user to generate an integrated data set managed in chronological order. For example, vital information, an outing history, conversation contents, a record of social activities, a medication status, meal contents, a sleep time, an amount of exercise, an SNS usage status, an exchange with family, an implementation status of hobby activities, and the like on a certain day are summarized as one record so that a long-term change and tendency can also be grasped. The data integration unit also performs correction of missing data or an abnormal value, anonymization processing for privacy protection, and normalization or standardization of data. Specifically, the data integration unit executes relationship modeling processing using a graph database. The data integration unit inputs data to a graph construction algorithm. The data integration unit uses a feature amount node and edge information extracted from each data source as the input data. The data integration unit defines the number of dimensions of this input data as a node feature amount matrix and an adjacency matrix. The data integration unit includes a node indicating a health condition of the user, a node indicating a behavior history, and a weight of an edge indicating a temporal/causal relationship thereof as element contents of the input data. The data integration unit executes scale adjustment between heterogeneous nodes and edge weighting calculation processing as preprocessing of the input data. As a specific example of the input data, the data integration unit inputs a node vector indicating a blood pressure abnormality or an edge weight matrix connecting sleep deprivation and a blood pressure increase. The data integration unit acquires output data from the graph construction algorithm. The data integration unit outputs an integrated knowledge graph representation as a format of the output data. The data integration unit configures each output value to mean an overall state of the user and a complex interaction between respective factors. As a specific example of the output data, the data integration unit outputs an optimized adjacency matrix or an embedding vector of the entire graph. The data integration unit uses this output result for subsequent processing. As the subsequent processing, the data integration unit executes a process of inputting this knowledge graph representation to a graph convolutional network and further performing higher-order feature extraction. By this technical improvement, the data integration unit realizes efficient calculation of a complex relationship and a dramatic improvement in data search speed. As a specific application field, the data integration unit is used for a drug discovery target search system or a factor analysis platform for a complex disease.

The cognitive function evaluation unit analyzes the integrated data set and calculates a cognitive function score from daily conversation contents and behavior patterns of the user using a generative AI. For example, the cognitive function evaluation unit analyzes the contents of the conversation in detail using a natural language processing technology by the generative AI, and uses repetition of the same topic, stuttering, a response speed to a question, a diversity of vocabulary, a logical connection, a richness of emotional expression, use of a joke or a metaphor, accurate recognition of a name of a partner or a date, consistency of the conversation, a topic switching frequency, a deviation of a topic, an expression of consideration for the partner, and the like as evaluation indexes. In addition, a change in the behavior pattern (a rapid decrease in a frequency of going out, a decline in motivation to participate in hobby activities, an increase in forgetfulness, a disturbance of a sleep rhythm, a decrease in a number of meals, an increase in forgetting to take medication, a procedural mistake in housework, and the like) is also reflected in the scoring. Furthermore, the cognitive function evaluation unit extracts a minute change in cognitive function from the entire life of the user using the generative AI, and quantifies it as a score such as a maximum of 100 points. A prompt sentence such as "Extract a sign of a change or decline in cognitive function from a conversation record and a behavior record of this user for the past one month and score it" or "Detect a pattern such as repetition of conversation, a response delay, or a decrease in vocabulary, and evaluate a risk of cognitive function decline" is given to the generative AI. Specifically, the cognitive function evaluation unit implements a generative AI control architecture combining prompt engineering and fine-tuning. The cognitive function evaluation unit inputs data to a generative AI model. The cognitive function evaluation unit uses a prompt text vector and a multimodal history tensor of the user as the input data. The cognitive function evaluation unit defines the number of dimensions of this input data as a high-dimensional vector in which a text token and a numerical feature amount are combined. The cognitive function evaluation unit includes an embedding representation of an instruction sentence automatically generated by the system and statistical data of past conversations and behaviors as element contents of the input data. The cognitive function evaluation unit executes variable embedding into a prompt template and tokenization processing as preprocessing of the input data. The cognitive function evaluation unit inputs a prompt vector "Evaluate a cognitive function decline risk from a conversation embedding matrix of the past 30 days" or an actual conversation history tensor as a specific example of the input data. The cognitive function evaluation unit acquires output data from the generative AI model. The cognitive function evaluation unit outputs numerical data of the cognitive function score and a text generation token serving as a basis as a format of the output data. The cognitive function evaluation unit configures each output value to mean a quantitative evaluation result and a logical explanatory sentence leading to the evaluation. The cognitive function evaluation unit outputs a numerical value of a score of 75 or a basis text "The score was lowered because a decrease in vocabulary was confirmed" as a specific example of the output data. The cognitive function evaluation unit uses this output result for subsequent processing. The cognitive function evaluation unit executes processing of transferring the score to the risk prediction unit and transmitting the basis text to a user interface unit to display it on a screen as the subsequent processing. The cognitive function evaluation unit realizes ensuring of transparency of evaluation and reduction of hallucination of the AI by this technical improvement. The cognitive function evaluation unit is used for a diagnosis support system for medical workers or an automatic evaluation platform requiring transparency as a specific application field.

The risk prediction unit individually predicts a dementia onset risk using a machine learning model by a generative AI based on the cognitive function score and the integrated data set. A plurality of factors such as a family history, a medical history, vital information, a transition of the cognitive function score, a frequency of social activities, a quality of communication, lifestyle habits, a medication status, a medical institution consultation history, a fall history, an accident history, a driving status, an economic status, a living environment, and a support system are used as inputs, and the generative AI calculates a risk level based on a pattern learned from a vast amount of past data. The generative AI can also explain an explanation of a risk factor and which factor contributes to a risk increase to the user and the family in a natural language. A prompt sentence such as "Predict a dementia onset risk based on the integrated data set of this user and explain a risk factor" or "Extract lifestyle habits or a behavior pattern contributing to a risk increase and create an improvement proposal" is given to the generative AI. Specifically, the risk prediction unit is configured by combining a multilayer perceptron and a transformer-based large language model provided with a self-attention mechanism. The risk prediction unit receives a numerical vector including time-series vital information and a natural language token sequence including textified lifestyle habit information as the input data. The risk prediction unit normalizes the numerical vector to convert it into a fixed-dimensional tensor. The risk prediction unit inputs the natural language token sequence to a word embedding layer to generate a high-dimensional embedding vector. The risk prediction unit combines these tensor and embedding vector to generate, for example, a 512-dimensional integrated feature tensor. The risk prediction unit inputs this integrated feature tensor to an encoder of the large language model. The large language model is pre-trained using past electronic medical record data and lifestyle habit data. The large language model is fine-tuned using a cross-entropy error function and a gradient descent method. The risk prediction unit outputs a risk score taking a continuous value in a range of 0.0 to 1.0 from a decoder of the large language model. The risk prediction unit further outputs an attention weight vector indicating a contribution degree of a feature amount contributing to the risk increase. The risk prediction unit specifies top three factors having a high contribution degree based on this attention weight vector. The risk prediction unit inputs the specified factors to a natural language generation module. The natural language generation module generates a specific explanatory text such as "A lack of sleep time increases the risk by 15 percent" or "A lack of exercise increases the risk by 10 percent". When the output risk score exceeds a predetermined threshold value, the system transmits an emergency flag to the subsequent intervention plan generation unit. Thereby, the system quantitatively evaluates an interaction between complex feature amounts in a high-dimensional space without depending on a subjective judgment by a human doctor. As a result, the system exhibits a technical effect of dramatically improving accuracy of risk prediction. The present technology is applicable to a use case such as a preventive medical system in an elderly facility or a health management application for an individual.

The intervention plan generation unit automatically generates an individually optimized prevention program using a generative AI based on the risk prediction result and interests and a living situation of the user. When the user is interested in a puzzle, music, cooking, gardening, reading, travel, photography, handicrafts, Go, Shogi, karaoke, walking, dance, yoga, volunteer activities, a regional event, interaction with family, pet breeding, or the like, the generative AI proposes a combination of a plurality of types of interventions such as a brain training program, lifestyle improvement advice, introduction of a social participation event, and recommendation of a medical examination at a specialized institution in accordance with the preference. An illustration or a quiz for brain training dedicated to the user and personalized cognitive stimulation contents are also automatically generated using an image generation technology by the generative AI. A prompt sentence such as "Create a brain training program and lifestyle improvement advice for one week in accordance with the interests and the risk of this user", "Propose a social participation event or a communication promotion measure considering the hobby and the family structure of the user", or "Generate contents for memory training using a photograph or a memory of the user" is given to the generative AI. Specifically, the intervention plan generation unit includes an arithmetic module implementing a reinforcement learning algorithm and a generative adversarial network. The intervention plan generation unit receives the risk score output from the risk prediction unit and a one-hot vector of a categorical variable indicating the hobby and preference of the user as the input data. The intervention plan generation unit combines these input data to generate a state vector. The intervention plan generation unit inputs this state vector to a deep Q-network. The deep Q-network is trained using an intervention history of a past user and a subsequent fluctuation of the cognitive function score as a reward. The deep Q-network updates a weight parameter so as to minimize a temporal difference error based on a Bellman equation. The intervention plan generation unit calculates a Q-value vector indicating an action value for a plurality of intervention candidates as an output of the deep Q-network. The intervention plan generation unit selects an index having a maximum value in the Q-value vector, and determines an optimal combination of intervention plans. When the determined intervention plan requires image contents, the intervention plan generation unit activates the generative adversarial network. The generative adversarial network is composed of a generator and a discriminator. The generator receives a feature vector extracted from a photograph of a past memory of the user combined with a noise vector in a latent space as an input. The generator repeats a deconvolution operation to generate, for example, a 256-pixel square RGB image tensor. The discriminator compares the generated image tensor with an actual image tensor for brain training to determine authenticity. The generator generates a high-quality cognitive stimulation image optimized for the user by advancing learning so as to deceive the discriminator. The intervention plan generation unit transmits the generated image tensor and the textified intervention plan to the subsequent AI coaching unit. Thereby, the system breaks away from a conventional method of providing a uniform program, and realizes content generation dynamically adapting to an individual state of the user. As a result, the system exhibits a technical effect of improving a continuation rate of the user and maximizing an intervention effect. The present technology is applicable to a use case such as a home nursing care support system or a personalized education platform for dementia prevention.

The AI coaching unit distributes the generated prevention program to the user terminal, and proposes it to the user through an interactive interface by voice or text on the user terminal. The AI coaching unit makes a specific action proposal every morning, such as "Let's do a 10-minute puzzle brain training today", "Why don't you participate in a neighborhood circle activity in the afternoon?", "You have been going out less recently, but how about taking a walk for a change of pace?", "Let's make a video call with your family today", "Why don't you try a new cooking recipe?", or "There is a local movie screening this week". When the user follows the proposal, the implementation status is fed back from the terminal to the server, and the AI coaching unit analyzes motivation and the implementation status of the user using a generative AI, and provides encouragement, a reminder, and feedback at an optimal timing and method. A prompt sentence such as "Generate an optimal encouragement or reminder sentence based on an activity implementation status and an emotional expression of the user" or "Generate 10 patterns of calling examples when the user cannot continue the activity" is given to the generative AI. Specifically, the AI coaching unit includes a multimodal dialogue engine integrating a voice synthesis model and a natural language processing model. The AI coaching unit receives action proposal data in a text format received from the intervention plan generation unit and voice waveform data acquired from a microphone of the user terminal as the input data. The AI coaching unit performs a fast Fourier transform on the voice waveform data to extract an acoustic feature amount tensor including a mel-frequency cepstrum coefficient. The AI coaching unit inputs this acoustic feature amount tensor to a recurrent neural network. The recurrent neural network learns a time-series dependency relationship using a long short-term memory unit. The recurrent neural network outputs an emotion vector indicating an emotional state of the user. The AI coaching unit combines the emotion vector and the action proposal data, and inputs them to a prompt generation module. The prompt generation module generates an encouraging text message optimized for the current emotion of the user using a large language model. The AI coaching unit inputs the generated text message to the voice synthesis model. The voice synthesis model converts the text message into a phoneme sequence, adjusts a pitch and an intonation, and generates synthesized voice waveform data. The AI coaching unit outputs the synthesized voice waveform data to a speaker of the user terminal. The AI coaching unit receives a binary flag indicating whether or not the user has implemented the proposed action from the user terminal. When the binary flag indicates non-implementation, the AI coaching unit transmits an alert signal to a subsequent feedback management unit. Thereby, the system realizes dynamic dialogue generation on a computer in accordance with a real-time emotional state of the user, instead of a mere notification of a fixed phrase. As a result, the system exhibits a technical effect of preventing a decrease in motivation of the user and improving naturalness of dialogue with the system. The present technology is applicable to a use case such as a smart speaker for an elderly person or an interactive health management robot.

A user interface unit provides various interfaces such as voice input/output, text display, image/video display, a notification, a reminder, a chatbot, calendar linkage, a push notification, a vibration notification, screen display, video playback, and music playback on the user terminal, and enables the user to intuitively and continuously use the system. For example, the user interface unit realizes a dialogue by a voice assistant, a selection by a touch operation, an image input by a camera, a voice input by a microphone, a reminder display on a notification bar, automatic schedule registration in a calendar, and the like. Specifically, the user interface unit includes a graphical user interface control module and a sensor data integration module. The user interface unit receives coordinate data on a touch screen of the user, a moving image tensor of 30 frames per second acquired from the camera, and voice stream data acquired from the microphone as the input data. The user interface unit inputs the moving image tensor to a convolutional neural network. The convolutional neural network extracts landmark coordinates of a face of the user, and calculates a line-of-sight direction vector. The user interface unit determines which region on the screen the user is gazing at based on the line-of-sight direction vector. The user interface unit executes rendering processing of automatically enlarging and displaying an icon in a gaze region. The user interface unit inputs the voice stream data to a voice recognition engine to convert it into text data. The user interface unit specifies a command of the user from the text data using an intention extraction algorithm. The user interface unit generates and executes an SQL query for inserting a schedule record into a calendar database based on the specified command. The user interface unit calls a notification API of an operating system to generate a push notification 5 minutes before a start time of the schedule. The user interface unit outputs a control signal for driving a vibration motor of the terminal at a specific frequency simultaneously with the generation of the push notification. Thereby, the system dynamically changes the interface by anticipating an intention of the user from a multimodal input such as a line of sight or a voice without waiting for an explicit operation by the user. As a result, the system exhibits a technical effect of enabling an intuitive operation even for a user unfamiliar with an operation of an IT device and reducing an input error rate. The present technology is applicable to a use case such as a dedicated tablet terminal for an elderly person or a wearable device emphasizing accessibility.

A feedback management unit centrally manages an activity implementation status of the user, a transition of the cognitive function score, a change in a risk level, an implementation result of the intervention plan, feedback from a family or a medical institution, and the like, and provides optimal feedback and advice to the user, the family, and medical and nursing care personnel using a generative AI. For example, the feedback management unit generates feedback such as "The number of times of going out has increased this week, and the cognitive function score is also on an upward trend", "Since repetition of conversation has increased recently, let's increase communication with your family", or "Please consider consulting a specialist". A prompt sentence such as "Summarize an activity history and a transition of a cognitive function score for one month of the user and create a report sentence for a family" or "Summarize a risk factor and a recommended intervention measure for a medical institution" is given to the generative AI. Specifically, the feedback management unit includes a time-series data analysis engine and a natural language generation model. The feedback management unit receives a time-series matrix indicating an activity implementation status for the past 30 days and a floating-point array indicating a transition of the cognitive function score as the input data. The feedback management unit inputs the time-series matrix to an autoregressive integrated moving average model to separate a trend component and a seasonal component of an amount of activity. The feedback management unit inputs the floating-point array to a gradient boosting decision tree algorithm to extract a main feature amount contributing to a fluctuation of the score. The feedback management unit combines the extracted feature amount and the trend component to generate a summary vector. The feedback management unit inputs the summary vector to an encoder of the natural language generation model. The natural language generation model adopts a transformer architecture, and is pre-trained using a specialized corpus for medical workers and a plain corpus for families. The feedback management unit inputs metadata indicating an attribute of an output destination to a decoder. When the output destination is a family, the feedback management unit generates plain text data excluding technical terms. When the output destination is a medical institution, the feedback management unit generates structured report data including specific numerical data and a risk index. The feedback management unit transmits the generated text data and report data to a subsequent external linkage unit. Thereby, the system eliminates a work of manually creating a report from a vast amount of time-series data by a human, and automatically generates feedback in an optimal format in accordance with an attribute of a recipient. As a result, the system exhibits a technical effect of preventing a delay in information sharing and dramatically improving communication efficiency among related parties. The present technology is applicable to a use case such as a remote medical monitoring system or a business support system in a nursing care facility.

An external linkage unit links with a medical institution, a nursing care provider, a community comprehensive support center, a family, a social worker, a care manager, a pharmacist, a dietitian, a rehabilitation staff, a regional event organizer, a hobby circle, a volunteer group, an administrative agency, and the like, and safely shares necessary information. For example, the external linkage unit transmits a cognitive function score, a risk level, and an activity history to a medical institution with consent of the user, adjusts a nursing care plan in linkage with a nursing care provider, or automatically acquires regional event information and proposes it to the user. A prompt sentence such as "Create an information sharing sentence for a medical institution or a nursing care provider based on a health condition and a living situation of the user" or "Generate a message conveying motivation of the user to participate for a regional event organizer" is given to the generative AI. Specifically, the external linkage unit includes a secure communication protocol stack and a data conversion gateway. The external linkage unit receives the report data output from the feedback management unit and an encrypted digital token indicating a consent state of the user as the input data. The external linkage unit decrypts the digital token using a public key cryptography method, and verifies an authority level of information sharing. When determining that the authority level is valid, the external linkage unit converts the report data into a JSON payload in an HL7 FHIR format, which is a standard for medical information exchange. The external linkage unit encrypts the converted JSON payload using a TLS 1.3 protocol, and transmits it to an external server of the medical institution via a RESTful API. The external linkage unit confirms success of data transfer by receiving an HTTP status code 200 for the transmission. The external linkage unit further periodically acquires XML data including a holding date and time and a place of an event from an RSS feed or a Web API provided by an organizer of a regional event. The external linkage unit parses the acquired XML data, and stores event information in an internal database. The external linkage unit inputs the event information to a natural language processing model, and calculates a cosine similarity with an interest vector of the user. The external linkage unit extracts event information having a cosine similarity exceeding a predetermined threshold value, and transmits it to the subsequent intervention plan generation unit. Thereby, the system automatically executes secure and seamless data linkage with an external system having a different data format on a computer. As a result, the system exhibits a technical effect of eliminating data silos and constructing a comprehensive support system utilizing regional resources. The present technology is applicable to a use case such as a healthy life expectancy extension project in a smart city or a platform of a community comprehensive care system.

As described above, the system according to the present embodiment comprehensively realizes dementia prevention activities and continuous support optimized for each user, real-time data analysis and feedback, linkage with medical care, nursing care, family, and regional resources, emergency response, privacy protection, and improvement of user experience by closely linking each unit and utilizing a generative AI in a multilayered and dynamic manner. Specifically, the system operates on a distributed computing environment in which a plurality of arithmetic nodes are connected by a high-speed network. The system containerizes each unit as a microservice architecture, and dynamically allocates resources using an orchestration tool. The system receives streaming data continuously transmitted from the user terminal as the input data. The system temporarily stores the streaming data in an in-memory database, and executes analysis without delay using a real-time processing engine. The system executes inference processing of a generative AI model in parallel based on an analysis result. The system arranges an intermediate tensor generated in a process of the inference processing in a shared memory space, and transfers data at high speed between each unit. In order to protect privacy of the user, the system performs homomorphic encryption processing on all input data, and executes inference of a machine learning model in an encrypted state. The system decrypts only an inference result and transmits it to the user terminal. Thereby, the system enables real-time processing of large-scale and complex multimodal data, which cannot be realized by conventional batch processing by a single server. As a result, the system exhibits a technical effect of shortening a response speed of the system to a state change of the user to a millisecond unit and preventing a delay in response in an emergency. The present technology is applicable to a use case such as a national-scale healthcare platform supporting millions of users simultaneously or a medical data analysis infrastructure requiring high security.

### Implementation Steps

Step 1: Collection of User Information and Health Data The user registers in the system using a smartphone, a tablet, a personal computer, a wearable device, or the like, and health-related data such as a heart rate, a blood pressure, a body temperature, a number of steps, a sleep time, a body weight, a blood glucose level, an oxygen saturation, consumed calories, a resting heart rate, an exercise intensity, a wake-up/bedtime, a medical history, a family history, a medication history, allergy information, and a periodic health examination result is automatically acquired from a health management application or the wearable device, and transmitted to the server. For example, various data is collected in chronological order, such as acquiring a blood pressure measurement value every morning from a smart watch, collecting a total number of steps per week from an activity meter, and acquiring a medication status from a medication management application. Specifically, in this step, the system executes a data collection agent program in the background on the user terminal. The system receives an analog voltage signal acquired from a photoplethysmography sensor built in the wearable device as the input data. The system inputs the analog voltage signal to an analog-to-digital converter, and converts it into digital waveform data having a sampling rate of 100 hertz, for example. The system applies a bandpass filter to the digital waveform data to remove a baseline fluctuation and high-frequency noise. The system calculates a heartbeat interval from the waveform data after noise removal using a peak detection algorithm, and generates a numerical vector including a heart rate and a heart rate variability index. The system further calls a healthcare API provided by an operating system of the user terminal, and acquires data such as a number of steps and a sleep time in a JSON format. The system parses the acquired JSON data, and combines it with the numerical vector to construct a health data payload. The system adds a time stamp and a user identifier to the health data payload, and asynchronously transmits it to the server using a message queuing protocol. The system stores the health data payload received on the server side in a time-series database. Thereby, the system continuously and seamlessly collects heterogeneous mixed data generated from various sensors without requiring an explicit input operation by the user. As a result, the system exhibits a technical effect of improving comprehensiveness and accuracy of data collection and ensuring prediction accuracy of a subsequent machine learning model. The present technology is applicable to a use case such as a remote monitoring system for a chronic disease patient or a condition management system for a professional athlete.

Step 2: Collection of behavior data and communication data. Using a GPS function, an acceleration sensor, a calendar application, a behavior recording application, a voice input application, an image recognition application, a call history, a message application, an SNS usage status, a voice recognition function, a video call application, an email application, a camera application, and the like of a user terminal, a frequency of going out, a moving distance, an amount of exercise, a number of times of participation in shopping or hobby activities, an implementation status of housework, a sleep rhythm, a meal time, a bathing time, a number of times of going to a toilet, a television viewing time, a reading time, presence or absence of a nap, a diversity of walking courses, a number of calls, a number of times of sending and receiving messages, an SNS posting frequency, a length of conversation, a diversity of topics, presence or absence of emotional expression, repetition of the same topic, a response speed to a question, a topic switching frequency, and the like are acquired and transmitted to a server. Specifically, in this step, the system executes a context awareness module on the user terminal. The system receives, as input data, latitude and longitude coordinate data acquired from a GPS module and a three-axis acceleration tensor acquired from an acceleration sensor. The system inputs the coordinate data to a Kalman filter to correct a positioning error, and generates a spatial vector indicating a moving trajectory of the user. The system performs a short-time Fourier transform on the acceleration tensor to extract a feature amount matrix in a frequency domain. The system inputs the feature amount matrix to a support vector machine to classify a behavior state such as walking, running, or resting. The system further scrapes text data displayed on a screen of the message application using an accessibility API of an operating system. The system inputs the acquired text data to a morphological analysis engine to generate a feature vector indicating an appearance frequency of words and a distribution of parts of speech. The system inputs voice data during a call acquired from a microphone to a voice section detection algorithm to separate an utterance section and a silence section. The system calculates a call time by integrating a length of the utterance section. The system integrates these behavior states, feature vectors, and call times to construct a behavior/communication data payload. The system transmits this payload to the server. Thereby, unlike a conventional questionnaire method depending on human self-reporting, the system automatically extracts an objective and quantitative behavior index in the background. As a result, the system exhibits a technical effect of capturing a minute change in daily life of the user without omission and contributing to early detection of cognitive function decline. The present technology is applicable to use cases such as a monitoring service for elderly people living alone and a mental health management system for employees.

Step 3: Data integration and preprocessing. Health data, behavior data, and communication data are integrated for each user on the server to generate an integrated data set managed in chronological order. Correction of data omission and abnormal values, anonymization processing for privacy protection, and data normalization and standardization are also performed. For example, vital information, an outing history, conversation contents, a record of social activities, a medication status, meal contents, a sleep time, an amount of exercise, an SNS usage status, interaction with family, an implementation status of hobby activities, and the like on a certain day are summarized as one record. Specifically, in this step, the system executes a data pipeline processing engine constructed on the server. The system receives, as input data, the health data payload and the behavior/communication data payload collected in Step 1 and Step 2. The system extracts a time stamp from these payloads and groups the data in a predetermined time window (for example, in units of one hour). The system applies a linear interpolation algorithm or a spline interpolation algorithm to the grouped data to complement a missing value caused by a communication error of a sensor or the like. The system applies an isolation forest as an outlier detection algorithm to specify and exclude or smooth a record indicating a statistically abnormal value. The system inputs personally identifiable information such as a name and a telephone number of the user to a hash function to convert it into an irreversible anonymized ID. The system applies Z-score normalization or min-max scaling to numerical data to unify scales of all feature amounts. The system applies a TF-IDF method to text data to convert it into a fixed-dimensional vector representation. The system combines these preprocessed data to generate a multidimensional tensor in which, for example, 1024-dimensional feature amount vectors are arranged along a time axis. The system stores this multidimensional tensor as an integrated data set in a distributed file system. Thereby, the system converts unstructured data having different sampling rates and data formats into a structured tensor that can be directly processed by a machine learning model. As a result, the system exhibits a technical effect of improving a learning convergence speed of a subsequent AI model and preventing a calculation error during inference. The present technology is applicable to use cases such as construction of a large-scale medical data warehouse and a learning data generation pipeline of a multimodal AI.

Step 4: Cognitive function evaluation (utilization of generative AI). The integrated data set is analyzed, and a cognitive function score is calculated from daily conversation contents and behavior patterns of the user using a generative AI. Prompt sentences such as "Extract signs of change or decline in cognitive function from conversation records and behavior records of this user for the past one month and score them" and "Detect patterns such as repetition of conversation, reaction delay, and vocabulary decrease, and evaluate a risk of cognitive function decline" are given to the generative AI. The generative AI analyzes the contents of the conversation in detail using natural language processing technology, uses repetition of the same topic, stuttering, a reaction speed to a question, a diversity of vocabulary, a logical connection, richness of emotional expression, use of jokes and metaphors, accurate recognition of a partner's name and a date, consistency of conversation, a topic switching frequency, topic digression, an expression of consideration for a partner, and the like as evaluation indexes, and reflects a change in behavior pattern in scoring. Specifically, in this step, the system includes a large language model specialized for natural language processing and a graph neural network for time series analysis. The system receives, as input data, a text vector and a behavior trajectory vector included in the multidimensional tensor generated in Step 3. The system inputs the text vector to an encoder of the large language model. This large language model has hundreds of millions of parameters and is pre-trained in an autoregressive language modeling task. The system calculates a dependency relationship between words in an internal attention layer of the large language model, and calculates an entropy value indicating a diversity of vocabulary and a coherence score indicating a logical connection. The system inputs the behavior trajectory vector to the graph neural network. This graph neural network constructs a graph structure in which a visited place of the user is a node and a moving route is an edge, calculates a degree centrality and a clustering coefficient of the node, and generates a graph embedding vector indicating a diversity of behavior. The system inputs the entropy value, the coherence score, and the graph embedding vector to a fully connected layer. This fully connected layer performs non-linear transformation using a ReLU activation function, and outputs a final cognitive function score as a continuous value from 0 to 100. The system stores the output cognitive function score in a time series database, and calculates a difference from a past score. When the difference exceeds a predetermined threshold, the system transmits a trigger signal to a subsequent risk prediction unit. Thereby, the system substitutes for cognitive function evaluation by a conventional paper test, and continuously and non-invasively quantifies a cognitive function from a daily digital footprint. As a result, the system exhibits a technical effect of ensuring objectivity of evaluation and eliminating fluctuation caused by subjectivity of an examiner. The present technology is applicable to use cases such as a development platform for digital biomarkers and a screening application for dementia.

Step 5: Risk prediction (utilization of generative AI). Based on the cognitive function score and the integrated data set, a dementia onset risk is individually predicted using a machine learning model by a generative AI. Prompt sentences such as "Predict a dementia onset risk based on the integrated data set of this user and explain a risk factor" and "Extract lifestyle habits and behavior patterns contributing to a risk increase and create an improvement proposal" are given to the generative AI. A plurality of factors such as a family history, a medical history, vital information, a transition of a cognitive function score, a frequency of social activities, a quality of communication, lifestyle habits, a medication status, a medical institution consultation history, a fall history, an accident history, a driving status, an economic status, a living environment, and a support system are input, a risk level is calculated, and an explanation of the risk factor is also output in natural language by the generative AI. Specifically, in this step, the system includes an ensemble learning model and a causal inference engine. The system receives, as input data, a time series array of the cognitive function score calculated in Step 4 and the multidimensional tensor generated in Step 3. The system inputs the time series array to a long short-term memory network to extract a hidden state vector indicating a decline trend of the score. The system inputs the multidimensional tensor to a random forest algorithm to calculate an importance score of each feature amount. The system combines the hidden state vector and the importance score to generate an integrated feature vector. The system inputs the integrated feature vector to the causal inference engine. This causal inference engine models a causal relationship between feature amounts using a Bayesian network, and calculates a probabilistic influence of specific lifestyle habits on future cognitive function decline. The system generates a probability distribution vector indicating a dementia onset probability after one year, three years, and five years as an output of the causal inference engine. The system classifies the risk level as categorical data of "low", "medium", and "high" based on the highest probability value in the probability distribution vector. The system inputs the classified risk level and a causal path obtained from the causal inference engine to a natural language generation model. This natural language generation model generates a specific risk factor explanation text such as "A decrease in social activities over the past three months increases an onset risk after three years by 20 percent". The system transmits the generated text and the risk level to a subsequent intervention plan generation unit. Thereby, the system not only presents a mere correlation but also unravels a complex causal relationship in a high-dimensional data space and outputs an evidence-based prediction result. As a result, the system exhibits a technical effect of improving transparency and explainability of prediction and enhancing a user's sense of conviction. The present technology is applicable to use cases such as a risk assessment system in an insurance company and a personal health record system for preventive medicine.

Step 6: Generation of individually optimized intervention plan (utilization of generative AI). Based on the risk prediction result and interests and a living situation of the user, an individually optimized prevention program is automatically generated using a generative AI. Prompt sentences such as "Create a brain training program and lifestyle improvement advice for one week according to interests and a risk of this user", "Propose a social participation event and a communication promotion measure considering hobbies and a family structure of the user", and "Generate contents for memory training using photos and memories of the user" are given to the generative AI. A plurality of types of interventions such as a brain training program, lifestyle improvement advice, introduction of a social participation event, and recommendation of a medical examination at a specialized institution are combined and proposed, and illustrations and quizzes for brain training dedicated to the user and personalized cognitive stimulation contents are also automatically generated by image generation technology. Specifically, in this step, the system includes a diffusion model for content generation and a collaborative filtering algorithm for a recommendation system. The system receives, as input data, the risk level and the risk factor explanation text generated in Step 5, and a hobby/preference vector acquired from a profile database of the user. The system calculates an inner product between the hobby/preference vector and a vector of another user, and extracts an ID list of intervention plans from which a user group having a high similarity has obtained a high effect in the past. The system combines the extracted ID list and the risk factor explanation text and inputs them to a prompt encoder. This prompt encoder converts text information into a conditioning vector in a latent space. The system inputs the conditioning vector to the diffusion model. This diffusion model starts from Gaussian noise and repeats a noise removal process using a U-Net architecture for several tens of steps to generate a high-quality image tensor for brain training related to the hobby of the user. At the same time, the system inputs the conditioning vector to a transformer model for text generation to generate question text and answer text of a quiz related to the image. The system packages the generated image tensor, question text, and answer text as an intervention plan object in a JSON format. The system transmits the intervention plan object to a subsequent AI coaching unit. Thereby, the system breaks away from a conventional method of distributing static contents prepared in advance, and generates dynamic contents perfectly matching a current state and preference of the user on the fly. As a result, the system exhibits a technical effect of preventing the user from getting bored and dramatically increasing engagement with the intervention program. The present technology is applicable to use cases such as an adaptive learning system in an educational field and a rehabilitation support system.

Step 7: Proposal, implementation, and monitoring by AI coaching (utilization of generative AI). The generated prevention program is distributed to the user terminal, and is proposed to the user through an interactive interface by voice or text on the user terminal. Prompt sentences such as "Generate optimal encouragement and reminder text based on an implementation status of activities and emotional expression of the user" and "Generate 10 patterns of calling examples when the user cannot continue activities" are given to the generative AI. Specific behavior proposals such as "Let's do a 10-minute puzzle brain training today" every morning, "Why don't you participate in a neighborhood circle activity in the afternoon?", "You have been going out less recently, but how about taking a walk for a change of pace?", and "Let's make a video call with your family today" are made, a reaction and an implementation status of the user are monitored, and feedback and a reminder for continuing activities and maintaining motivation are dynamically optimized. Specifically, in this step, the system includes a reinforcement learning-based dialogue management module and a convolutional neural network for emotion recognition. The system receives, as input data, the intervention plan object generated in Step 6 and a face image tensor acquired from an in-camera of the user terminal. The system inputs the face image tensor to the convolutional neural network, extracts a feature map indicating movement of facial muscles, and calculates a probability vector indicating an emotional state such as joy, sadness, or fatigue. The system inputs the probability vector and the intervention plan object to the dialogue management module. This dialogue management module evaluates a current state based on a Markov decision process, and determines an optimal timing and utterance style for proposing an intervention to the user. The system generates personalized proposal text such as "You look a little tired, but would you like to take a simple quiz for just 5 minutes?" using a large language model based on the determined utterance style. The system converts the proposal text into voice waveform data by a voice synthesis engine, and reproduces it from a speaker of the user terminal. The system collects performance data such as a screen tap interval and a correct answer rate in real time while the user is implementing the intervention plan. When the performance data falls below a predetermined standard, the system feeds back a control signal for lowering a difficulty level to the intervention plan generation unit. After the intervention is completed, the system generates and presents reward text for enhancing a user's sense of accomplishment. Thereby, the system infers emotion and a fatigue level of the user in real time instead of a one-way notification, and realizes a bidirectional adaptive interaction on a computer. As a result, the system exhibits a technical effect of reducing a psychological burden on the user and promoting long-term behavior modification. The present technology is applicable to use cases such as a virtual trainer of a fitness application and digital therapeutics supporting medication compliance.

Step 8: Periodic re-evaluation and feedback (utilization of generative AI). Cognitive function evaluation and risk prediction are periodically re-executed, and a change in score and a change in behavior pattern are analyzed by a generative AI. Prompt sentences such as "Summarize an activity history for one month and a transition of a cognitive function score of the user, and create a report text for a family" and "Summarize a risk factor and a recommended intervention measure for a medical institution" are given to the generative AI. When the cognitive function score drops sharply or when an abnormal pattern is detected in conversation contents, the generative AI automatically summarizes the contents and issues an alert such as "We recommend a medical examination at a specialized institution" to the user and the family. Specifically, in this step, the system includes a distributed data processing framework for batch processing and an anomaly detection algorithm. The system receives, as input data, time series data of the cognitive function score accumulated over the past one month and a record of a structured database including an activity log of the user. The system inputs the time series data to an autoregressive moving average model to analyze a fluctuation trend and periodicity of the score. The system calculates a residual between an expected value predicted from an analysis result and an actual score, and flags a data point where the residual exceeds a statistical allowable range as an abnormal value. When an abnormal value is detected, the system inputs the activity log of that period to a natural language processing model. This natural language processing model extracts a peculiar pattern such as "a sharp decrease in the number of times of going out" or "an extreme decrease in vocabulary in conversation" from the activity log. The system inputs the extracted pattern and transition data of the score to a transformer model for summary generation. This transformer model converts the extracted features into report text in natural language that is easy for humans to understand using an encoder-decoder architecture. When a destination of the report text is a family, the system executes a filtering process of replacing a technical term with a plain expression. When the destination is a medical institution, the system generates a structured report to which numerical data such as a p-value and a confidence interval indicating statistical significance of the abnormal value is added. The system push-notifies the generated report text and structured report to a terminal of a designated recipient via a secure communication channel. Thereby, the system automatically extracts a minute change that humans tend to overlook from a huge amount of log data, and issues an alert at an appropriate timing. As a result, the system exhibits a technical effect of enabling early intervention for a sharp decline in cognitive function and preventing aggravation. The present technology is applicable to use cases such as a resident management system of an elderly facility and a triage system in telemedicine.

Step 9: External cooperation and emergency response. With consent of the user, a cognitive function score, a risk level, and an activity history are linked with a medical institution, a nursing care provider, a community comprehensive support center, a family, a social worker, a care manager, a pharmacist, a dietitian, a rehabilitation staff, a local event organizer, and the like, and necessary information is safely shared. For example, the cognitive function score and the risk level are transmitted to a medical institution, a nursing care plan is adjusted in cooperation with a nursing care provider, local event information is automatically acquired and proposed to the user, and a family and a medical institution are automatically notified in an emergency such as a fall or a sharp decline in cognitive function. Specifically, in this step, the system includes an event-driven message broker and an API gateway. The system receives, as input data, the structured report generated in Step 8 and impact waveform data indicating a rapid gravity change acquired from an acceleration sensor of the user terminal. The system inputs the impact waveform data to a support vector machine to calculate a probability of a fall accident. When the fall probability exceeds a predetermined threshold (for example, 95 percent), the system immediately activates an emergency interrupt process. In the emergency interrupt process, the system packages GPS coordinate data indicating a current position of the user and the latest vital information tensor, and transmits an HTTPS POST request to a server of an emergency institution. At the same time, the system push-distributes a real-time alert notification to a smartphone of the family using a WebSocket protocol. In normal operation other than an emergency, the system converts the structured report into an XML format compliant with an HL7 FHIR standard. The system periodically transmits the converted XML data to a RESTful API endpoint of an electronic medical record system operated by a medical institution or a nursing care provider. The system further analyzes event information scraped from a database of local events using a natural language processing model, and matches it with a hobby/preference vector of the user. The system generates a URL for application for participation in an event having a high matching score, and displays it on an interface of the user terminal. Thereby, the system constructs an autonomous network seamlessly linked with an external medical/nursing care infrastructure without being completed inside the system. As a result, the system exhibits a technical effect of minimizing a response time in an emergency and dramatically enhancing safety of the user. The present technology is applicable to use cases such as a monitoring network in a smart home and a community comprehensive care platform led by a local government.

### Specific Use Case

For example, when a couple around 80 years old uses the system of the present invention, first, the health data acquisition unit automatically acquires health-related data such as a heart rate, a blood pressure, a number of steps, a sleep time, a body weight, a blood glucose level, a medication history, a medical history, a family history, and a periodic health examination result from a wearable device such as a smart watch, an activity meter, a sphygmomanometer, and a thermometer, and a health management application, and transmits it to the server. The behavior data acquisition unit acquires a frequency of going out, a moving distance, an amount of exercise, a number of times of participation in hobby activities, an implementation status of housework, a sleep rhythm, a meal time, a bathing time, a television viewing time, a reading time, a diversity of walking courses, and the like using a GPS, an acceleration sensor, a calendar application, a behavior recording application, a voice input application, an image recognition application, and the like of the user terminal. The communication data acquisition unit acquires a number of telephone calls with family and friends, a number of times of sending and receiving messages, an SNS posting frequency, a length of conversation, a diversity of topics, presence or absence of emotional expression, repetition of the same topic, a response speed to a question, a topic switching frequency, and the like using a call history, a message application, an SNS usage status, a voice recognition function, a video call application, an email application, and the like. Specifically, the system includes a relational database that links and manages a plurality of user accounts, and an edge computing device. The system receives, as input data, a three-axis acceleration tensor of 50 samples per second acquired from a smart watch of a husband, and numerical data of systolic and diastolic blood pressures transmitted via Bluetooth from a sphygmomanometer of a wife. The system executes a lightweight convolutional neural network on the edge computing device, and infers a behavior class probability vector such as walking, housework, or sleep from the acceleration tensor in real time. The system serializes the inferred behavior class probability vector and the numerical data of the blood pressure into a JSON payload together with a time stamp and a user ID. The system transmits this JSON payload to a cloud server using an MQTT protocol. On the cloud server side, the system receives conversation voice data between the couple acquired from a microphone of a smart speaker. The system inputs the conversation voice data to a speaker diarization algorithm to separate an utterance section of the husband and an utterance section of the wife. The system inputs each separated utterance section to a voice recognition model to convert it into text data. The system inputs the text data to a natural language processing model to calculate a number of utterance turns, an overlap frequency, and an emotion polarity score. The system extracts these communication indexes as a numerical vector. The system integrates the health data, the behavior data, and the communication data to construct a multidimensional feature tensor for each of the couple. Thereby, the system synchronizes and processes multimodal data asynchronously generated from a plurality of IoT devices without depending on a single device. As a result, the system exhibits a technical effect of quantifying a complex interaction in daily life of elderly people and improving a resolution of data collection. The present technology is applicable to use cases such as a family monitoring system in a smart home and a solution for facilities that simultaneously manages health conditions of a plurality of people.

The data integration unit integrates these health data, behavior data, and communication data for each user to generate an integrated data set managed in chronological order. The cognitive function evaluation unit analyzes the integrated data set and calculates a cognitive function score from daily conversation contents and behavior patterns of the user using a generative AI. For example, prompt sentences such as "Extract signs of change or decline in cognitive function from conversation records and behavior records of this user for the past one month and score them" and "Detect patterns such as repetition of conversation, reaction delay, and decrease in vocabulary, and evaluate a risk of cognitive function decline" are given to the generative AI. The generative AI analyzes contents of the conversation in detail, uses repetition of the same topic, stuttering, a response speed to a question, a diversity of vocabulary, a logical connection, richness of emotional expression, use of a joke or a metaphor, accurate recognition of a name of a partner or a date, consistency of conversation, a topic switching frequency, topic digression, an expression of consideration for a partner, and the like as evaluation indexes, and also reflects a change in a behavior pattern in scoring. Specifically, the data integration unit executes high-speed data combination processing using an in-memory data grid. The data integration unit receives a plurality of unstructured data streams including the health data, the behavior data, and the communication data as input data. The data integration unit maps these data streams to a common time axis and fills missing values by spline interpolation to generate, for example, a 2048-dimensional integrated feature tensor. The cognitive function evaluation unit inputs this integrated feature tensor to a large language model and a time-series transformer model. The time-series transformer model detects periodicity or abnormal deviation of the behavior pattern and outputs a behavior abnormality score vector. The large language model analyzes text data of the conversation using a self-attention mechanism. The large language model receives, as inputs, an appearance frequency of the same noun in the text data, metadata indicating a time gap between utterances, and syntax tree data indicating complexity of a grammatical structure. The large language model calculates a repetition score indicating repetition of the same topic, a fluency score indicating stuttering, and a TTR value indicating a diversity of vocabulary based on these inputs. The cognitive function evaluation unit inputs these scores and the behavior abnormality score vector to a fully connected neural network. The fully connected neural network multiplies each index by an optimal weight, linearly combines them, applies a sigmoid function, and outputs a final cognitive function score normalized in a range of 0 to 100. The cognitive function evaluation unit transmits the calculated score to the subsequent risk prediction unit. Thereby, the system replaces qualitative evaluation performed by a human expert through a long-time interview with quantitative calculation of high-dimensional data by a computer. As a result, the system exhibits a technical effect of ensuring objectivity and reproducibility of evaluation and detecting a minute decline in cognitive function at an early stage. The present technology is applicable to use cases such as an automatic medical interview system in telemedicine and a calculation tool for an objective evaluation index in a clinical trial.

The risk prediction unit individually predicts a dementia onset risk using a machine learning model by a generative AI based on the cognitive function score and the integrated data set. For example, prompt sentences such as "Predict a dementia onset risk based on the integrated data set of this user and explain a risk factor" and "Extract lifestyle habits and behavior patterns contributing to an increase in risk and create an improvement proposal" are given to the generative AI. A plurality of factors such as a family history, a medical history, vital information, a transition of the cognitive function score, a frequency of social activities, quality of communication, lifestyle habits, a medication status, a medical institution consultation history, a fall history, an accident history, a driving status, an economic status, a living environment, and a support system are used as inputs, a risk level is calculated, and the generative AI also outputs an explanation of the risk factor in natural language. Specifically, the risk prediction unit includes a hybrid inference engine integrating a gradient boosting decision tree algorithm and a transformer model for natural language generation. The risk prediction unit receives, as input data, a time-series array of the cognitive function score and a feature vector consisting of dozens of types of categorical variables and continuous variables including the family history and the vital information. The risk prediction unit inputs the feature vector to the gradient boosting decision tree algorithm. The algorithm captures a complex non-linear interaction between features by learning a large number of decision trees in series, and outputs a continuous value score from 0.0 to 1.0 indicating a future dementia onset probability. The risk prediction unit further executes a SHAP algorithm to calculate a contribution degree of each feature to the output score. The risk prediction unit extracts top five features having a high contribution degree (for example, a decrease in sleep time, forgetting to take a specific antihypertensive drug, a decrease in frequency of going out, and the like). The risk prediction unit inputs structured data indicating the extracted features and their contribution degrees to an encoder of the transformer model. The transformer model outputs text data in natural language such as "A recent decrease in frequency of going out pushes up the risk by 15 percent. In addition, a disturbance in sleep time also has an influence" from a decoder. The risk prediction unit determines the risk level by performing threshold determination on the continuous value score, and transmits it to the subsequent intervention plan generation unit together with the text data. Thereby, the system provides explainability based on a mathematical basis to a prediction result of the machine learning model which tends to be a black box. As a result, the system exhibits a technical effect of strongly supporting decision-making for a medical worker or a user to trust the prediction result and move on to a next action. The present technology is applicable to use cases such as a risk assessment tool in a preventive medicine clinic and a health guidance support system for a health insurance society.

The intervention plan generation unit automatically generates an individually optimized prevention program using a generative AI based on the risk prediction result and interests and a living situation of the user. For example, prompt sentences such as "Create a brain training program and lifestyle improvement advice for one week according to interests and a risk of this user", "Propose a social participation event and a communication promotion measure considering hobbies and a family structure of the user", and "Generate memory training contents using photos and memories of the user" are given to the generative AI. A plurality of types of interventions such as a brain training program, lifestyle improvement advice, introduction of a social participation event, and recommendation of a medical examination at a specialized institution are combined and proposed, and illustrations and quizzes for brain training dedicated to the user and personalized cognitive stimulation contents are also automatically generated by image generation technology. Specifically, the intervention plan generation unit includes a constrained optimization solver and a multimodal generative AI model. The intervention plan generation unit receives, as input data, the risk level output from the risk prediction unit, a profile vector indicating hobbies of the user, and a matrix indicating a past intervention history. The intervention plan generation unit inputs these input data to the constrained optimization solver. The solver calculates an optimal allocation ratio of intervention categories (for example, exercise, cognitive training, and social participation) that maximizes an expected value of an intervention effect, using a fatigue degree and available time of the user as constraint conditions. The intervention plan generation unit inputs a prompt vector to the multimodal generative AI model based on the calculated allocation ratio. The multimodal generative AI model has an architecture integrating a large language model for text generation and a latent diffusion model for image generation. The multimodal generative AI model receives an image tensor of a past travel photo of the user as an input, adds noise in a latent space, and then conditionally removes the noise, thereby generating an image tensor for spot-the-difference in which a part of the photo is processed, together with a text "Where was this photo taken?". Furthermore, when the hobby of the user is "gardening", the intervention plan generation unit acquires event information of a local gardening circle by web scraping, and generates a guidance text prompting participation. The intervention plan generation unit packages the generated image tensor and text data into an intervention plan object in a JSON format as a schedule for one week. The intervention plan generation unit transmits this intervention plan object to a subsequent user interface unit. Thereby, the system dynamically generates contents deeply rooted in a personal context of the user, rather than imposing a uniform program. As a result, the system exhibits a technical effect of drawing out a spontaneous participation motivation of the user and dramatically improving a continuation rate of the intervention program. The present technology is applicable to use cases such as a personalized digital cognitive behavioral therapy application and an entertainment-type rehabilitation system for the elderly.

The AI coaching unit distributes the generated prevention program to the user terminal, and proposes it to the user through an interactive interface by voice or text on the user terminal. For example, prompt sentences such as "Generate optimal encouragement and a reminder sentence based on an implementation status of activities and emotional expression of the user" and "Generate 10 patterns of calling examples when the user cannot continue activities" are given to the generative AI. The AI coaching unit makes specific action proposals every morning such as "Let's do a 10-minute puzzle brain training today", "Why don't you participate in a neighborhood circle activity in the afternoon?"\n"Going out has decreased recently, but how about taking a walk for a change of pace?", and "Let's make a video call with your family today", monitors a reaction and an implementation status of the user, and dynamically optimizes feedback and a reminder for continuing activities and maintaining motivation. Specifically, the AI coaching unit includes a natural language generation engine having a large language model as a core. The engine executes dynamic prompt generation processing according to a context of the user. Input data to the engine are a multidimensional vector indicating the implementation status of activities of the user and a numerical score indicating emotional expression. Specific examples of the implementation status of activities include a 7-dimensional integer array indicating the number of steps in the past 7 days and a scalar value indicating the number of times of implementation of a puzzle game. Specific examples of the emotional expression include a floating-point vector in a range of 0.0 to 1.0 indicating joy or sadness output from a voice analysis module. The engine normalizes these input data as preprocessing and embeds them in a prompt template in a text format. The engine inputs this prompt to the large language model. Output data from the engine are a generated text character string and a probability distribution score indicating a certainty factor of each action proposal. Specific examples of the output text include a natural language sentence encouraging the user and a reminder sentence prompting a specific activity. Specific examples of the probability distribution score include a numerical array such as a score proposing a walk being 0.85 and a score proposing a puzzle being 0.42. The AI coaching unit compares the output probability distribution score with a preset threshold as subsequent processing. The AI coaching unit extracts only a proposal whose score exceeds the threshold, and transmits it to a display control module of the user terminal. The display control module pop-up displays the received text on a screen. Alternatively, the display control module activates a voice synthesis engine and reads out the text as voice. By such processing, the system selects an intervention most suitable for a current state of the user in real time. The system prevents fatigue of the user due to an irrelevant notification. The system exhibits a technical effect of effectively prompting behavior modification of the user and dramatically improving a continuation rate of the prevention program. The system exhibits extremely high usefulness in specific application fields such as a dementia prevention application for the elderly and a rehabilitation support system.

The cognitive function evaluation and the risk prediction are periodically re-executed, and a change in the score and a change in the behavior pattern are analyzed by the generative AI. For example, prompt sentences such as "Summarize a transition of an activity history and a cognitive function score for one month of the user and create a report sentence for a family" and "Summarize a risk factor and a recommended intervention measure for a medical institution" are given to the generative AI. When the cognitive function score rapidly declines or when an abnormal pattern is detected in conversation contents, the generative AI automatically summarizes the contents and transmits an alert such as "We recommend a medical examination at a specialized institution" to the user and the family. Specifically, the system periodically executes a re-evaluation process using a time-series data analysis model. The analysis model adopts a neural network architecture equipped with a self-attention mechanism. Input data to the analysis model is a time-series tensor indicating a transition of the activity history and the cognitive function score for a certain past period. Specific examples of the activity history include a 30-dimensional integer array indicating the daily number of steps and a 30-dimensional floating-point array indicating a sleep time. Specific examples of the transition of the cognitive function score include a 4-dimensional floating-point array indicating a score calculated weekly. The analysis model combines these input data along a time axis and performs normalization processing. Output data from the analysis model are an abnormality detection flag, a summary text, and an importance score of a risk factor. Specific examples of the abnormality detection flag include a binary value of 0 indicating normal or 1 indicating abnormal. Specific examples of the summary text include a natural language character string explaining a factor of score decline. Specific examples of the importance score include a numerical vector such as a contribution degree of lack of sleep being 0.6 and a contribution degree of lack of exercise being 0.3. The system determines whether or not the abnormality detection flag is 1 as subsequent processing. When the flag is 1, the system immediately activates an alert generation module. The alert generation module transmits a push notification including the generated summary text to a terminal of the family. By such processing, the system mathematically detects a minute decline tendency of the score that tends to be overlooked by human visual inspection. The system exhibits a technical effect of realizing early abnormality detection and preventing a delay in medical intervention. The system greatly contributes to ensuring safety of a user in specific application fields such as telemedicine monitoring and a home monitoring service.

In this way, the system of the present invention can collect and integrate the health data, the behavior data, and the communication data multilaterally and comprehensively, realize cognitive function evaluation, risk prediction, individually optimized intervention plan generation, AI coaching, and feedback generation using a generative AI, and continuously and effectively provide a dementia prevention activity optimized for each user. Specifically, the system constructs an advanced calculation pipeline that integrally processes multimodal data. The pipeline includes an encoder group that maps heterogeneous data to the same feature space. Input data to the pipeline is an integrated tensor combining the health data, the behavior data, and the communication data. Specific examples of the health data include a time-series array of a heart rate. Specific examples of the behavior data include trajectory data of GPS coordinates. Specific examples of the communication data include voice waveform data of conversation. The pipeline executes preprocessing of missing value complementation and dimensionality reduction on these input data. Output data from the pipeline is a parameter set defining an optimized intervention plan. Specific examples of the parameter set include a numerical value indicating an intensity of an exercise task, a time stamp indicating an execution time of the task, and an identifier of a recommended communication partner. The system applies this parameter set to an operation control module of the entire system as subsequent processing. The operation control module updates an operation schedule of each subsystem based on the parameter set. By such processing, the system provides a data-driven prevention activity fundamentally different from a conventional rule-based system depending on a single data source. The system exhibits a technical effect of dynamically adjusting intervention contents following a minute state change of the user and maximizing a prevention effect. The system provides an innovative solution in specific application fields such as personalized medicine and a next-generation healthcare platform.

(Application Example 1) The flow of the specific processing in Application Example 1 will be described. Each part of the system described below is realized by the data processing device 12 and the smart device 14. Additionally, the data processing device 12 is referred to as a "server," and the smart device 14 is referred to as a "terminal."

### Embodiment for carrying out the present invention

Embodiments for carrying out the present invention will be described in more detail and comprehensively with higher specificity.

The system of the present invention is a system that collects diverse data such as a health condition, daily behavior, a communication status, and a nursing care record of each user in real time and continuously in a nursing care facility or a home nursing care site, evaluates a change in cognitive function and physical function with high accuracy using a generative AI, performs risk prediction, and automates and advances an individually optimized nursing care plan, a rehabilitation menu, a life support proposal, feedback for a family and a nursing care staff, early abnormality detection, and medical cooperation. Specifically, the system adopts a distributed processing architecture in which an edge computing device and a cloud server are linked. The system includes an event-driven data collection module that processes streaming data asynchronously generated from each data source. Input data to the module is a stream of raw data transmitted from various sensors. Specific examples of the raw data include time-series data of a heart rate sampled at 1 hertz and an array of binary states output from an indoor motion detection sensor. The module adds a time stamp to these input data and applies a noise removal filter. Output data from the system are a risk prediction score and structured data constituting the nursing care plan. Specific examples of the risk prediction score include a floating-point number in a range of 0.0 to 1.0 indicating a fall risk. Specific examples of the structured data include a record in a JSON format including a task name, an execution time, and a person-in-charge ID. The system activates a task assignment engine when the risk prediction score exceeds a predetermined threshold as subsequent processing. The engine transmits a task execution instruction to a terminal of an optimal nursing care staff based on the structured data. By such processing, the system analyzes a huge amount of data in real time and derives an optimal countermeasure at a speed exceeding human cognitive ability. The system exhibits a technical effect of significantly reducing a work burden on the nursing care staff and equalizing quality of care. The system realizes a dramatic improvement in operational efficiency in specific application fields such as a large-scale special nursing home for the elderly and a home-visit nursing care service deployed over a wide area.

First, the health data acquisition unit automatically acquires diverse health-related data such as a heart rate, a blood pressure, a body temperature, a number of steps, a sleep time, a body weight, a blood glucose level, an oxygen saturation, consumed calories, a resting heart rate, an exercise intensity, a wake-up/bedtime, a medical history, a family history, a medication history, allergy information, and a periodic health examination result from a wearable device such as a smart watch, an activity meter, a sphygmomanometer, a thermometer, a pulse oximeter, and a blood glucose meter worn by a user, a health management application installed in a smartphone or a tablet, electronic medical record data of a periodic health examination, a medication management application, and the like. For example, it is also possible to acquire a blood pressure measurement value every morning from a smart watch by Bluetooth communication, collect a total number of steps per week from an activity meter, acquire a monthly body weight transition from a weight scale via Wi-Fi, acquire a medication status from a medication management application, and automatically link electronic medical record data of a periodic health examination from a medical institution, and for example, a blood test value, an image diagnosis result, a doctor's finding, and the like are also acquisition targets. Furthermore, when the user consults a plurality of medical institutions, a function of integrating data from each medical institution and automatically detecting and correcting duplicated or contradictory data is also provided. Specifically, the health data acquisition unit includes a data cleansing and normalization processing engine for integrating data in heterogeneous formats. Input data to the engine are unstructured and semi-structured data acquired from a plurality of external systems. Specific examples of the input data include blood pressure data described in a JSON format, step count data described in a CSV format, and electronic medical record data described in an HL7 format. The engine executes schema mapping on these input data, and unifies units and interpolates missing values. Output data from the engine is a normalized health data vector converted into a format processable by a machine learning model. Specific examples of the output data include a 128-dimensional numerical vector having each vital sign as an element and a one-hot encoding vector expressing a medical history. The health data acquisition unit stores the generated normalized health data vector in a time-series database as subsequent processing. At the same time, the health data acquisition unit inputs this vector to an outlier detection algorithm and determines whether or not a statistical outlier exists. By such processing, the system absorbs noise due to a difference in data format or an input error, and exhibits a technical effect of dramatically improving inference accuracy in subsequent AI analysis. The system provides a highly reliable data infrastructure in specific application fields such as a community-based integrated care system in which a plurality of medical institutions and nursing care providers cooperate.

The daily activity data acquisition unit acquires a behavior pattern in daily life such as a frequency of going out, a moving distance, an amount of exercise, a number of times of participation in shopping or hobby activities, an implementation status of housework, a sleep rhythm, a meal time, a bathing time, a number of times of going to a toilet, a television viewing time, a reading time, presence or absence of a nap, a diversity of walking courses, and a usage status of public transportation using a GPS function, an acceleration sensor, a gyro sensor, a calendar application, a behavior recording application, a voice input application, an image recognition application, and the like of a terminal of a user. For example, it cooperates with a calendar application to automatically record input, execution, and forgetting of a schedule, automatically determines a destination and a moving route from GPS data, analyzes an exercise intensity and a walking pattern from an acceleration sensor, and also performs food management in a refrigerator, recognition of a medication package, confirmation of a garbage disposal status, and the like using an image recognition application. Furthermore, contents input to a diary application by the user and a behavior record by voice input are also acquisition targets, and subjective behavior records such as "I took a walk to a neighborhood park today", "I watched television for 2 hours after lunch", and "I prepared dinner by myself" are also accumulated as data. In addition, a number of times of entering and leaving a living room, a number of times of going to a toilet at night, a number of times of getting out of bed, a change in room temperature and humidity, and the like are also acquired from IoT devices such as a door opening/closing sensor, a bed sensor, an illumination sensor, and a temperature/humidity sensor in a facility to grasp a life rhythm and a sign of abnormal behavior. Specifically, the daily activity data acquisition unit includes a behavior analysis module combining sensor fusion technology and a time-series pattern recognition algorithm. Input data to the module is a multidimensional time-series data stream acquired synchronously from a plurality of sensors. Specific examples of the input data include a time-series array of GPS coordinates indicating latitude and longitude, continuous tensor data obtained from a 3-axis acceleration sensor, and a binary state array of an IoT sensor indicating an open/closed state of a door. The module applies a Kalman filter to these input data to remove noise, and executes feature extraction. Output data from the module are an inferred behavior label and its certainty score. Specific examples of the behavior label include a categorical character string such as sleep, walking, and a meal. Specific examples of the certainty score include a numerical value such as a probability of walking being 0.92 and a probability of running being 0.05. The daily activity data acquisition unit records a behavior label whose certainty score exceeds a certain threshold in a time-series database as subsequent processing. Furthermore, the daily activity data acquisition unit calculates a baseline of a life rhythm from the recorded behavior history, and calculates a deviation degree score indicating how much a current behavior deviates from the baseline. By such processing, the system accurately grasps a complex behavior in daily life, which is difficult to recognize by a single sensor, by integrating a plurality of sensor data. The system exhibits a technical effect of quantifying a minute change in a life pattern of the user and contributing to early discovery of cognitive function decline. The system exhibits extremely high practicality in specific application fields such as a monitoring service for elderly people living alone and an independence support system utilizing a smart home.

The communication data acquisition unit acquires contents and a number of times of interpersonal communication, such as a number of telephone calls with family and friends, a number of times of sending and receiving messages, an SNS posting frequency, a number of video calls, a number of times of sending emails, a number of times of sharing photos and videos, a length of conversation, a diversity of topics, presence or absence of emotional expression, repetition of the same topic, a response speed to a question, a topic switching frequency, presence or absence of a joke or laughter, calling a partner's name by mistake, confusion of a family structure, and confusion of a date or a day of the week, using a call history of a terminal of a user, a message application, a usage status of an SNS, a voice recognition function, a video call application, an email application, a camera application, and the like. For example, the communication data acquisition unit converts daily conversation contents into text using the voice recognition function, and also acquires a frequency and a time zone of interaction, a reply speed, a tendency to ignore a read message, a usage frequency of a stamp or a pictogram, and the like from the usage status of the SNS or the message application. Furthermore, the communication data acquisition unit converts a change in facial expression, a movement of a line of sight, and emotional expression such as a smile or surprise into data by video analysis of the video call application, and evaluates a quality of communication from multiple angles. In addition, the communication data acquisition unit also acquires a conversation frequency and contents with other users and staffs, a participation status in group activities, a degree of excitement of conversation, a number of utterances, a diversity of utterances, and the like from a conversation recording system or a recreation participation record in a facility. Specifically, the communication data acquisition unit includes an emotion/intent analysis engine integrating natural language processing and computer vision technology. Input data to the engine is unstructured data in a multimedia format. Specific examples of the input data include voice waveform data acquired from a microphone, an array of text character strings extracted from the message application, and a tensor of an image frame captured from a video call. The engine executes preprocessing such as text conversion by voice recognition, morphological analysis, and facial landmark detection on the input data. Output data from the engine is a vector of quantified communication metrics. Specific examples of the output data include an emotion score vector such as 0.8 for joy and 0.1 for sadness, a numerical value of a topic diversity index indicating richness of used vocabulary, and a number of conversation repetitions indicating a number of appearances of the same phrase. As subsequent processing, the communication data acquisition unit normalizes these index vectors and combines them with another data set as an input feature amount of a cognitive function evaluation model. By such processing, the system extracts the quality of communication, which has depended on human subjective observation, as objective and continuous numerical data. The system exerts a technical effect of highly accurately capturing a sign of cognitive function decline from a conversation tempo and a minute change in facial expression. The system greatly contributes to grasping a mental state of the user in specific application fields such as an auxiliary tool for online medical treatment and a communication support robot in a nursing care facility.

The nursing care record acquisition unit acquires a record of a meal, bathing, excretion, movement, a fall, forgetfulness, a state of conversation, a recreation participation status, medication management, vital measurement, a rehabilitation implementation status, an accident, abnormal behavior, and the like input by a nursing care staff using a tablet terminal or a nursing care recording system. For example, a meal intake amount and meal contents, presence or absence and a time of bathing, a number of times and a status of excretion, use of a walking aid during movement, an occurrence date and time and a status of a fall or a drop, a frequency and contents of forgetfulness, contents and a reaction of conversation, a participation status and a reaction to recreation, an implementation status of medication and forgetting to take medicine, a vital measurement value, implementation contents and an achievement degree of rehabilitation, details of an accident or abnormal behavior, and the like can be recorded in detail. Furthermore, the nursing care staff can also input a facial expression and an attitude of the user, an abnormality during a meal or excretion, a skin condition during bathing, a movement and motivation during rehabilitation, a sleep status at night, an amount of activity during the day, a state during a visit with a family, and the like by free description, and these free description data are also subject to natural language analysis by a generative AI. Specifically, the nursing care record acquisition unit includes a natural language understanding module configured to convert free description text into structured data. Input data to the module is a text character string and selection-type category data input by the nursing care staff. Specific examples of the input data include free description text that the user had no appetite and was a little absent-minded today, and numerical data that the meal intake amount is 50 percent. The module executes named entity extraction and dependency parsing on the input text. Output data from the module is a structured event tag and an importance score thereof. Specific examples of the output data include a character string of a standardized event tag such as appetite decline or vitality decline, and an importance score in a range of 0.0 to 1.0 indicating a severity of the event. As subsequent processing, the nursing care record acquisition unit appends the generated event tag and importance score to a record of the corresponding user in an integrated database. Furthermore, when the importance score exceeds a predetermined threshold value, the nursing care record acquisition unit immediately triggers an inference process of a risk prediction model. By such processing, the system converts subjective free description including orthographical variants and ambiguity into an objective data point processable by a machine learning model. The system exerts a technical effect of extracting an important sign buried in the nursing care record without omission, and improving comprehensiveness and accuracy of data analysis. The system achieves both reduction of a burden on the staff and improvement of care quality in specific application fields such as efficiency improvement support for nursing care recording work and an automated system for care plan creation.

The data integration unit integrates health data, daily activity data, communication data, and nursing care record data for each user to generate an integrated data set managed in chronological order. For example, vital information, an outing history, conversation contents, a record of social activities, a medication status, meal contents, a sleep time, an amount of exercise, an SNS usage status, interaction with a family, an implementation status of hobby activities, a nursing care record, and the like on a certain day are summarized as one record so that a long-term change and tendency can also be grasped. The data integration unit also performs correction of data missing or an abnormal value, anonymization processing for privacy protection, and normalization and standardization of data. For example, the data integration unit deduplicates step count data and sleep data acquired from a plurality of devices and applications, automatically detects and corrects an abnormal value, and converts all data into a common chronological format for management. Specifically, the data integration unit includes an advanced data alignment engine for constructing a multidimensional time-series tensor. Input data to the engine is a time-series data stream with a different sampling rate transmitted asynchronously from each acquisition unit. Specific examples of the input data include heart rate data recorded at one-minute intervals, text data of a nursing care record recorded irregularly, and body weight data recorded once a day. The engine executes time stamp synchronization processing on these input data, and applies a missing value imputation algorithm using spline interpolation or a K-nearest neighbor algorithm. Output data from the engine is a multidimensional tensor resampled at a constant time interval. Specific examples of the output data include a two-dimensional floating-point tensor having a number of time steps and a number of feature dimensions as axes. As subsequent processing, the data integration unit expands the generated multidimensional tensor in a cache area on a memory. The data integration unit provides this tensor as an input for batch processing of the cognitive function evaluation model and the risk prediction model. By such processing, the system eliminates a time lag of heterogeneous data and makes all variables comparable on the same time axis. The system exerts a technical effect of dramatically improving learning efficiency and inference accuracy of the machine learning model and reducing false detection. The system functions as a core of a data infrastructure in specific application fields such as construction of a large-scale medical data warehouse and a real-time health condition monitoring platform.

The cognitive function and physical function evaluation unit analyzes the integrated data set, and calculates a cognitive function score and a physical function score from daily conversation contents, a behavior pattern, health data, and a nursing care record of the user utilizing a generative AI. For example, the cognitive function and physical function evaluation unit analyzes conversation contents in detail using a natural language processing technology by a generative AI, and uses repetition of the same topic, stuttering, a response speed to a question, a diversity of vocabulary, a logical connection, richness of emotional expression, use of a joke or a metaphor, accurate recognition of a partner's name or a date, consistency of conversation, a topic switching frequency, a topic digression, an expression of consideration for a partner, and the like as evaluation metrics. In addition, a change in a behavior pattern (a rapid decrease in a frequency of going out, a decline in motivation to participate in hobby activities, an increase in forgetfulness, a disturbance of a sleep rhythm, a decrease in a number of meals, an increase in forgetting to take medicine, a procedure mistake in housework, and the like) is also reflected in scoring. Furthermore, the cognitive function and physical function evaluation unit calculates the physical function score from a walking speed, a moving range, a number of falls, an achievement degree of rehabilitation, a meal intake amount, an excretion status, a bathing frequency, an amount of exercise, stability of vitals, and the like. For example, if the walking speed is decreased, the physical score is decreased, and if the number of falls is increased, the risk is increased. The generative AI is given a prompt sentence such as "Extract a sign of a change or decline in cognitive function or physical function from a conversation record, a behavior record, health data, and a nursing care record of this user for the past one month, and score it" or "Detect a pattern such as repetition of conversation, a response delay, a decrease in vocabulary, a decrease in walking speed, an increase in a number of falls, and a decrease in a meal intake amount, and evaluate a risk" to perform analysis. Specifically, the evaluation unit includes an advanced score calculation engine using a multimodal neural network. Input data to the engine is a multidimensional tensor of the integrated data set supplied from the data integration unit. Specific examples of the input data include matrix data indicating a behavior feature amount for the past 30 days and a text embedding vector of conversation. The engine inputs these input data to a plurality of specialized subnetworks, and extracts and combines a hidden state vector of each modality. Output data from the engine is the cognitive function score and the physical function score expressed as continuous values, and a confidence interval of each score. Specific examples of the output data include a floating-point number such as 75.5 for the cognitive function score and 68.2 for the physical function score, and a numerical value such as plus or minus 3.1 for the confidence interval. As subsequent processing, the evaluation unit compares the calculated score with past history data to calculate a rate of change. When the score is decreased by 10 percent or more compared to the previous week, the evaluation unit sets an alert flag indicating a rapid functional decline. By such processing, the system highly accurately detects a minute functional decline that tends to be overlooked in a single test by integrating and evaluating a plurality of modalities. The system exerts a technical effect of continuously providing an objective index complementing a diagnosis by a specialist. The system provides extremely high clinical value in specific application fields such as an early screening tool for dementia and an effect measurement system for rehabilitation.

The risk prediction unit comprehensively analyzes a family history, a medical history, a transition of cognitive and physical scores, a fall history, a medication status, a frequency of social interaction, a change in a meal or sleep, and the like using a machine learning model by a generative AI to individually predict a risk of dementia or physical function decline. For example, the risk prediction unit gives a prompt sentence such as "Predict a risk of dementia or physical function decline based on the integrated data set of this user, and explain a risk factor" or "Extract a lifestyle habit or a behavior pattern contributing to a risk increase, and create an improvement proposal" to the generative AI, determines a risk level (low, medium, high), and outputs the risk factor and an improvement point in natural language. For example, when the cognitive function score is rapidly decreased and the number of falls is increased, the risk prediction unit determines that "a dementia risk and a fall risk are high", and automatically generates an improvement proposal such as "strengthening of attendance when going out", "introduction of a walking aid", and "recommendation of a medical examination by a specialist". Specifically, the risk prediction unit includes an ensemble learning engine integrating a gradient boosting decision tree and a self-attention mechanism-based prediction model. Input data to the engine is a feature vector including a static feature amount and a dynamic feature amount of the user. Specific examples of the input data include a one-hot vector indicating a family history or a medical history, and a time-series vector indicating a cognitive score transition for the past six months. The engine executes feature scaling on these input data, and inputs them to the prediction model to perform inference. Output data from the engine is a future functional decline probability, a categorical value of the risk level, and a score indicating an importance of each feature amount. Specific examples of the output data include a floating-point number that a fall probability after six months is 0.78, a character string that the risk level is high, and a numerical vector that an importance of lack of sleep is 0.45. As subsequent processing, when the output risk level is high, the risk prediction unit transmits a control signal instructing the nursing care plan generation unit to create a preferential intervention plan. At the same time, the risk prediction unit generates natural language text explaining the risk factor based on the feature importance. By such processing, the system imparts explainability based on a mathematical basis to a prediction of the AI that tends to be a black box. The system exerts a technical effect of enhancing a sense of conviction of the nursing care staff and the family with respect to a prediction result, and promoting a transition to appropriate preventive behavior. The system strongly supports data-based decision making in specific application fields such as a risk stratification tool in preventive medicine and a benefit optimization system for nursing care insurance.

The nursing care plan generation unit gives a prompt sentence such as "Create a rehabilitation menu, life support advice, a recreation proposal, and feedback for a family and a staff for one week according to a risk and interests of this user" or "Generate memory training contents using a photograph or a memory of the user" to a generative AI based on a risk prediction result, interests (for example, music, exercise, gardening, cooking, reading, handicrafts, Go, Shogi, karaoke, a pet, travel, and the like), a living situation, a family structure, a past activity history, and the like of the user, and automatically generates an individually optimized nursing care plan. For example, when the risk is high, the nursing care plan generation unit strongly recommends a medical institution consultation or a specialist consultation, proposes music therapy or singing recreation to a user who likes music, and proposes individual rehabilitation or a walking program to a user who likes exercise. Furthermore, the nursing care plan generation unit also automatically generates feedback such as "a recent change in cognitive function or physical function", "a point to be noted in the future", and "an example of calling out in daily life" for the family and the nursing care staff. For example, the nursing care plan generation unit generates advice for the family such as "Recently, repetition of conversation is increasing, so it is good to speak in a slow tone and give a specific trigger when changing a topic". Specifically, the nursing care plan generation unit includes a scheduling engine configured to optimize a plan using a reinforcement learning algorithm. Input data to the engine is the risk prediction result, a profile vector of the user, and reaction history data to a past plan. Specific examples of the input data include a numerical value of a fall risk score, a multidimensional vector encoding interests, and a percentage indicating a participation rate in past music therapy. The engine defines these input data as a state space, sets an expected improvement effect as a reward function, and executes an optimization calculation. Output data from the engine is structured data defining a schedule for one week and an expected effect score of each task. Specific examples of the output data include a task list array in a JSON format including a start time, an end time, and contents of a task, and a numerical value indicating an expected value of cognitive function improvement by the task. As subsequent processing, the nursing care plan generation unit transmits the generated schedule data to a terminal of the nursing care staff. The nursing care plan generation unit receives an approval or correction input from the staff, feeds back the result as a reward of a reinforcement learning model, and updates a weight of the model. By such processing, the system continuously learns a preference and a past reaction history of the user, and improves accuracy of personalization. The system exerts a technical effect of automatically generating a nursing care plan with a high continuation rate, and significantly reducing a time required for plan creation work of a care manager. The system simultaneously realizes efficiency improvement of work and quality improvement of a service in specific application fields such as a calculation support system for an individual functional training addition and an automatic recreation proposal system in a day service.

The AI care coaching unit proposes these nursing care plan, rehabilitation menu, life support advice, and feedback to the user and the nursing care staff through a tablet, a smartphone, a voice assistant, a chatbot, or the like, and monitors an implementation status and a reaction of the user. For example, the AI care coaching unit makes a specific action proposal or an alert such as "Let's implement 10 minutes of music therapy today", "Let's take a walk and stretch in the afternoon", "Conversation has been decreasing recently, so let's make a video call with your family", and "Falls are increasing, so let's consider using a walking aid". When the user or the staff inputs implemented contents or a reaction, the information is also accumulated in the data integration unit again, and is utilized for evaluation and plan generation from the next time onward. Furthermore, the AI care coaching unit analyzes an activity implementation status, emotional expression, a life rhythm, a physical condition change, feedback from a family and a nursing care staff, and the like of the user in real time using a generative AI, dynamically generates and provides encouragement, a reminder, an alert, and an action proposal at an optimal timing and method for each user, and automatically updates the nursing care plan and the rehabilitation menu according to a reaction and an implementation status of the user. Specifically, the AI care coaching unit includes an intervention management module configured to execute a context-aware notification control algorithm. Input data to the module is a current time, a current position of the user, a current activity state, and task data of the nursing care plan. Specific examples of the input data include a time stamp indicating the current time, GPS coordinates, a status flag indicating whether sleeping or awake, and a task ID scheduled to be executed. The module calculates a timing at which the user has the highest probability of accepting a notification based on these input data. Output data from the module is an execution timing of the notification, an optimal notification channel, and generated message text. Specific examples of the output data include a time stamp indicating execution after 5 minutes, a channel identifier designating a voice speaker, and a natural language character string prompting a walk. As subsequent processing, the AI care coaching unit calls an API of a target device at the designated timing, and executes the notification. At the same time, the AI care coaching unit records a response of the user to the notification, and measures a response time. By such processing, the system eliminates annoyance caused by a uniform notification ignoring a situation of the user. The system exerts a technical effect of increasing an acceptance rate of a proposal and effectively promoting behavior modification by performing intervention at an optimal timing and method. The system acquires continuous engagement of a user in specific application fields such as a medication compliance improvement application and a behavior support system for preventing lifestyle-related diseases.

In addition, the system periodically performs re-evaluation of cognitive function and physical function, analyzes a change in a score or a risk level using a generative AI, gives a prompt sentence such as "Summarize an activity history and a transition of cognitive and physical function scores for one month of this user, and create a report text for a family" or "Summarize a risk factor and a recommended intervention measure for a medical institution", and automatically generates optimal feedback or a report for a family, a medical institution, and a nursing care staff. When cognitive function or physical function is rapidly decreased, or when a fall or an accident occurs, the generative AI automatically summarizes contents thereof, and transmits an alert such as "A medical examination by a specialist is recommended" or "Please strengthen a fall prevention program". For example, when a number of times of going to a toilet at night is rapidly increased and a sleep time is decreased, the system determines that "a fall risk is increased due to nocturia", and automatically proposes strengthening of night lighting, securing a flow line to a toilet, recording a urination diary, recommendation of a urology consultation, and the like. Specifically, the system includes a report generation engine configured to automate document creation using a natural language generation model. Input data to the engine is score transition data for a certain past period, an abnormality detection log, and history data of an implemented nursing care plan. Specific examples of the input data include an array of cognitive function scores for the past one month, an alert history from a fall detection sensor, and a list of completed rehabilitation tasks. The engine maps these input data to a template, and generates a natural sentence according to a context. Output data from the engine is structured report data and an urgency flag. Specific examples of the output data include markup text for PDF generation, and a Boolean value indicating that an urgency is high. As subsequent processing, the system determines whether or not the urgency flag is true. When the flag is true, the system immediately transmits the report to a designated contact using a secure communication protocol. By such processing, the system completely automates routine report creation work. The system exerts a technical effect of creating a time for the nursing care staff to concentrate on direct care, and preventing a delay in information sharing. The system dramatically reduces a communication cost in specific application fields such as an information sharing platform for multidisciplinary cooperation and a periodic report distribution service for a family.

Furthermore, an external cooperation unit is provided to cooperate with a medical institution, a nursing care provider, a community comprehensive support center, a family, a social worker, a care manager, a pharmacist, a dietitian, a rehabilitation staff, a community event organizer, and the like, and safely share necessary information. For example, the external cooperation unit transmits a cognitive function score, a risk level, and an activity history to a medical institution with consent of the user, adjusts a nursing care plan in cooperation with a nursing care provider, automatically acquires community event information and proposes it to the user, and automatically notifies a family or a medical institution in an emergency such as a fall or a rapid cognitive function decline. For example, the external cooperation unit automatically collects event information such as a local health class, a hobby circle, a volunteer activity, a rehabilitation class, and a dementia cafe, and proposes an optimal event according to an interest and a risk of the user. Specifically, the external cooperation unit includes a secure API gateway and a data encryption processing module. Input data to the module is a data set to be shared, an access authority policy, and API specification data of an external system. Specific examples of the input data include a record including the cognitive function score of the user, a policy rule permitting access to the medical institution, and an endpoint URL of a transmission destination. The module applies an advanced encryption algorithm to these input data to generate a payload of data. Output data from the module is an encrypted JSON payload and an authentication token. Specific examples of the output data include encrypted character string data and a JWT token with an expiration date. As subsequent processing, the external cooperation unit transmits a POST request to a RESTful API endpoint of the external system using an HTTPS protocol. The external cooperation unit verifies a received response code, and records success or failure of transmission in a log. By such processing, the system completely prevents leakage of highly confidential medical and nursing care data while ensuring interoperability between systems. The system exerts a technical effect of realizing robust data cooperation and enabling construction of a comprehensive care network in an entire region. The system functions as a secure data hub in specific application fields such as data cooperation with an electronic medical record system and integration with a health promotion platform of a local government.

As described above, the embodiment of the present invention has an extremely multifaceted and thick configuration such as cooperation between a server and a user terminal, multilayered and dynamic utilization of a generative AI, intervention and continuous support optimized for each user, real-time data analysis and feedback, cooperation with medical care, nursing care, a family, and community resources, emergency response, privacy protection, and improvement of user experience, and comprehensively realizes quality improvement of a nursing care site, independence support of a user, burden reduction of a family and a staff, medical cost suppression, and healthy life expectancy extension. Specifically, the present embodiment includes an orchestration engine configured to integrally manage all data streams processed in the entire system. Input data to the engine is system operation metrics and resource usage status data collected from each subsystem. Specific examples of the input data include a numerical array in milliseconds indicating an inference delay time of each AI model, and a percentage indicating a CPU usage rate of a server. The engine monitors these input data in real time, and executes a load balancing algorithm. Output data from the engine is an optimized system operation parameter and a scaling instruction command. Specific examples of the output data include a numerical value indicating a traffic allocation rate to a specific processing node, and a control command instructing activation of a new virtual machine. As subsequent processing, the system calls an API of a cloud infrastructure, and executes auto-scaling control. By such processing, the system maintains a scalable distributed processing architecture, and responds to a sudden increase in data amount without delay. The system exerts a technical effect of simultaneously supporting a large number of users and contributing to solving a nursing care problem on a social scale. The system provides extremely high availability and performance in specific application fields such as a national-level healthcare data infrastructure and a globally deployed digital health service.

### System Configuration

The system according to the present embodiment comprises a health data acquisition unit, a daily activity data acquisition unit, a communication data acquisition unit, a nursing care record acquisition unit, a data integration unit, a cognitive function and physical function evaluation unit, a risk prediction unit, a nursing care plan generation unit, an AI care coaching unit, and an external cooperation unit.

The health data acquisition unit is a unit configured to automatically acquire various health-related data such as a heart rate, a blood pressure, a body temperature, a number of steps, a sleep time, a body weight, a blood glucose level, an oxygen saturation, consumed calories, a resting heart rate, an exercise intensity, a wake-up/bedtime, a medical history, a family history, a medication history, allergy information, and a periodic health examination result from a wearable device such as a smart watch, an activity meter, a sphygmomanometer, a thermometer, a pulse oximeter, and a blood glucose meter worn by a user, a health management application installed in a smartphone or a tablet, electronic medical record data of a periodic health examination, a medication management application, or the like. For example, it is also possible to acquire a blood pressure measurement value every morning from a smart watch via Bluetooth communication, collect a total number of steps per week from an activity meter, acquire a monthly body weight transition from a weight scale via Wi-Fi, acquire a medication status from a medication management application, and automatically link electronic medical record data of a periodic health examination from a medical institution, and for example, a blood test value, an image diagnosis result, a doctor's finding, and the like are also acquisition targets. Furthermore, it also has a function of integrating data from a plurality of medical institutions and automatically detecting and correcting duplicated or contradictory data. Specifically, the health data acquisition unit includes a preprocessing pipeline that complements data loss due to sensor noise or a communication error with an algorithm. Input data to the pipeline is an unprocessed raw data stream transmitted from various devices. Specific examples of the input data include a time-series array of a heart rate sampled at 1 hertz and numerical data of a blood glucose level recorded at irregular intervals. The pipeline applies a moving average filter and an outlier removal algorithm to these input data. Output data from the pipeline is a clean data vector subjected to noise removal and interpolation processing. Specific examples of the output data include a continuous time-series vector in which missing values are linearly interpolated and a numerical array having a standardized unit. The health data acquisition unit transfers this clean data vector to a feature amount extraction module as subsequent processing. By such processing, the system eliminates data uncertainty caused by hardware constraints in a software manner. The system exhibits a technical effect of enhancing robustness of subsequent AI processing and preventing erroneous inference based on erroneous data. The system ensures data reliability in specific application fields such as an open platform that integrates wearable devices of various manufacturers and a remote monitoring system for home patients.

The daily activity data acquisition unit is a unit configured to acquire a behavior pattern in daily life such as a frequency of going out, a moving distance, an amount of exercise, a number of times of participation in shopping or hobby activities, an implementation status of housework, a sleep rhythm, a meal time, a bathing time, a number of times of going to a toilet, a television viewing time, a reading time, presence or absence of a nap, a diversity of walking courses, and a usage status of public transportation using a GPS function, an acceleration sensor, a gyro sensor, a calendar application, a behavior recording application, a voice input application, an image recognition application, or the like of a terminal of the user. For example, it cooperates with a calendar application to automatically record input, execution, and forgetfulness of a schedule, automatically determines a destination and a moving route from GPS data, analyzes an exercise intensity and a walking pattern from an acceleration sensor, and also performs food management in a refrigerator, recognition of a medication package, confirmation of a garbage disposal status, and the like using an image recognition application. Furthermore, contents input to a diary application by the user and a behavior record by voice input are also acquisition targets, and subjective behavior records such as "I took a walk to a nearby park today", "I watched television for 2 hours after lunch", and "I prepared dinner by myself" are also accumulated as data. In addition, a number of times of entering and leaving a living room, a number of times of going to a toilet at night, a number of times of getting out of bed, a change in room temperature and humidity, and the like are also acquired from IoT devices such as a door opening/closing sensor, a bed sensor, an illumination sensor, and a temperature/humidity sensor in a facility to grasp a life rhythm and a sign of abnormal behavior. Specifically, the daily activity data acquisition unit includes a behavior segmentation engine that formulates complex daily life behavior as a discrete state transition model. Input data to the engine is spatial coordinate data, an acceleration tensor, and a numerical array of an environmental sensor. Specific examples of the input data include matrix data indicating a trajectory of latitude and longitude, tensor data indicating a change in 3-axis acceleration, and a floating-point array indicating a change in room temperature. The engine applies a hidden Markov model or a recurrent neural network to these input data to divide continuous data into meaningful behavior units. Output data from the engine is a pair of a start time, an end time, and an inferred behavior class of a behavior segment. Specific examples of the output data include timestamps of a start time and an end time, and a label of a behavior class such as a meal or sleep. The daily activity data acquisition unit stores these behavior segments in a graph database as subsequent processing. The daily activity data acquisition unit calculates a behavior transition probability matrix from the stored data, and monitors whether an unusual behavior transition has occurred. By such processing, the system extracts human intention and a context of life from a mere list of sensor values. The system exhibits a technical effect of enabling mathematical detection of an abnormal behavior pattern and directly leading to early discovery of cognitive function decline. The system provides an advanced situation understanding capability in specific application fields such as a control system of a life support robot for the elderly and a resident monitoring infrastructure in a smart city.

The communication data acquisition unit is a unit configured to acquire contents and a number of times of interpersonal communication, such as a number of telephone calls with family and friends, a number of times of sending and receiving messages, an SNS posting frequency, a number of video calls, a number of times of sending emails, a number of times of sharing photos and videos, a length of conversation, a diversity of topics, presence or absence of emotional expression, repetition of the same topic, a response speed to a question, a topic switching frequency, presence or absence of a joke or laughter, a mistake in calling a partner's name, confusion of a family structure, and confusion of a date or a day of the week, using a call history, a message application, a usage status of an SNS, a voice recognition function, a video call application, an email application, a camera application, or the like of the terminal of the user. For example, it converts contents of daily conversation into text using a voice recognition function, and also acquires a frequency and a time zone of interaction, a reply speed, a tendency of ignoring a read message, a usage frequency of a stamp or a pictogram, and the like from a usage status of an SNS or a message application. Furthermore, by video analysis of a video call application, a change in facial expression, a movement of a line of sight, and emotional expression such as a smile or surprise are also converted into data, and a quality of communication is evaluated from multiple angles. In addition, a conversation frequency and contents with other users and staffs, a participation status in group activities, a degree of excitement of conversation, a number of utterances, a diversity of utterances, and the like are also acquired from a conversation recording system and a recreation participation record in a facility. Specifically, the communication data acquisition unit adopts a multi-thread architecture that processes a plurality of input streams in parallel. The acquisition unit executes a fast Fourier transform on voice data. The acquisition unit converts a time-domain voice signal into a frequency-domain spectrogram tensor. The acquisition unit inputs the spectrogram tensor to a convolutional neural network. The network extracts a feature amount of voice. The acquisition unit inputs the extracted feature amount to a recurrent neural network. The network analyzes a time-series context. The acquisition unit generates text data of an utterance from an analysis result. The acquisition unit inputs the generated text data to a large language model. Input data to the model is an embedding vector of a word. The number of dimensions of the input data to the model is, for example, 768 dimensions. Specific examples of the input data to the model include a text vector indicating utterance contents of the user and a timestamp array indicating a timing of the utterance. The model applies a self-attention mechanism to the input vector group. The model calculates a dependency relationship between words. The model outputs an emotion polarity score and a diversity of topics score. A format of output data from the model is an array of floating-point numbers. Specific examples of the output data from the model include a score of 0.85 indicating joy and a score of 0.12 indicating sadness. The acquisition unit compares these output scores with a predetermined threshold. When detecting an emotion change exceeding the threshold, the acquisition unit transmits a flag indicating the change to the subsequent data integration unit. The acquisition unit executes similar processing on video data. The acquisition unit extracts an image tensor in units of frames from a moving image acquired from a camera. The acquisition unit inputs the image tensor to a facial organ detection model. The model outputs a feature point coordinate vector indicating a movement of an eye or a mouth. The acquisition unit digitizes a degree of facial expression change based on the coordinate vector. The acquisition unit stores these numerical data in a time-series database. With this configuration, the system automatically extracts an objective communication index that does not depend on human subjectivity. The system eliminates variation in evaluation. The system exhibits a technical effect of capturing a minute change in cognitive function with high accuracy. This technology is extremely useful in specific application fields such as a daily monitoring system in a facility for the elderly and an interview support system in telemedicine.

The nursing care record acquisition unit is a unit configured to acquire a record of a meal, bathing, excretion, movement, a fall, forgetfulness, a state of conversation, a recreation participation status, medication management, vital measurement, a rehabilitation implementation status, an accident, and abnormal behavior input by a nursing care staff using a tablet terminal or a nursing care record system. For example, a meal intake amount and meal contents, presence or absence and a time of bathing, a number of times and a status of excretion, use of a walking aid during movement, an occurrence date and time and a status of a fall or a drop, a frequency and contents of forgetfulness, contents and a reaction of conversation, a participation status and a reaction to recreation, an implementation status of medication and forgetting to take medication, a vital measurement value, implementation contents and an achievement degree of rehabilitation, details of an accident or abnormal behavior, and the like can be recorded in detail. Furthermore, the nursing care staff can also input a facial expression and an attitude of the user, an abnormality during a meal or excretion, a skin condition during bathing, a movement and motivation during rehabilitation, a sleep status at night, an amount of activity during the day, a state during a visit with a family, and the like by free description, and these free description data are also targets of natural language analysis by a generative AI. Specifically, the nursing care record acquisition unit includes a natural language processing pipeline that converts free description text, which is unstructured data, into structured data. The acquisition unit inputs the input text data to a morphological analysis engine. The engine divides the text into word tokens. The acquisition unit executes preprocessing for removing unnecessary stop words. The acquisition unit inputs the preprocessed token string to a large language model. Input data to the model is an index array of tokenized text. The number of dimensions of the input data to the model is a maximum of 512 tokens. Specific examples of the input data to the model include a text token indicating choking during a meal and a text token indicating wandering at night. The model includes a multi-layer encoder based on a transformer architecture. The model generates a high-dimensional feature vector considering a context from the input token string. The model inputs the feature vector to a fully connected layer. The model classifies contents of the nursing care record into a plurality of predefined categories. A format of output data from the model is a softmax distribution indicating a probability of belonging to each category. Specific examples of the output data from the model include a probability value of 0.92 for a fall risk category and a probability value of 0.78 for a cognitive function decline category. The acquisition unit assigns a category with the highest probability as a label of the record. The acquisition unit links the extracted label and the original text data and saves them in a relational database. The acquisition unit transfers this label information to the subsequent risk prediction unit. With this configuration, the system exhaustively extracts an important sign from a huge amount of free description data. The system exhibits a technical effect of dramatically improving accuracy of data analysis while reducing a burden of recording work of the nursing care staff. This technology is extremely useful in specific application fields such as a work support system in a large-scale nursing care facility and an information sharing platform for families in home nursing care.

The data integration unit is a unit configured to integrate health data, daily activity data, communication data, and nursing care record data for each user to generate an integrated data set managed in chronological order. For example, vital information, an outing history, conversation contents, a record of social activities, a medication status, meal contents, a sleep time, an amount of exercise, an SNS usage status, interaction with a family, an implementation status of hobby activities, a nursing care record, and the like on a certain day are collected as one record so that a long-term change and tendency can also be grasped. The data integration unit also performs correction of data loss or an abnormal value, anonymization processing for privacy protection, and normalization and standardization of data. For example, it deduplicates step count data and sleep data acquired from a plurality of devices and applications, automatically detects and corrects an abnormal value, and converts all data into a common time-series format for management. Specifically, the data integration unit includes a multimodal integration engine that maps heterogeneous mixed data to the same latent space. The integration unit receives a data stream asynchronously transmitted from each acquisition unit. The integration unit executes synchronization processing based on a timestamp on the received data. The integration unit executes complementation processing using an autoencoder on time-series data including a missing value. The integration unit inputs incomplete data to the autoencoder that has learned a normal data pattern. The integration unit estimates a numerical value of a missing part so as to minimize a reconstruction error. The integration unit executes a prediction model using a long short-term memory network for abnormal value detection. The integration unit predicts a current value from past time-series data. The integration unit calculates a degree of divergence between the predicted value and an actual observation value. The integration unit excludes or smooths data whose degree of divergence exceeds a predetermined threshold as an abnormal value. The integration unit converts the preprocessed data into a multidimensional time-series matrix. Input data to the integration unit is an array of numerical vectors or categorical variables having different sampling rates. The number of dimensions of the input data to the integration unit ranges from several tens to several hundreds of dimensions. Specific examples of the input data to the integration unit include a heart rate vector at one-minute intervals and body weight data once a day. The integration unit resamples these data to a common time resolution. A format of output data from the integration unit is a normalized multidimensional tensor. Specific examples of the output data from the integration unit include a 128-dimensional feature amount tensor aggregated on a daily basis and an activity amount matrix on an hourly basis. The integration unit stores the generated integrated data set in a distributed file system. The integration unit provides the data set at high speed in response to a query from the subsequent evaluation unit. With this configuration, the system automatically generates high-quality analysis data from real environment data including noise and loss. The system exhibits a technical effect of significantly improving inference accuracy of a subsequent artificial intelligence model. This technology is extremely useful in specific application fields such as an integrated management system of personal health records and a medical data sharing infrastructure among a plurality of hospitals.

The cognitive function and physical function evaluation unit is a unit configured to analyze the integrated data set and calculate a cognitive function score and a physical function score from daily conversation contents, a behavior pattern, health data, and a nursing care record of the user using a generative AI. For example, contents of conversation are analyzed in detail using a natural language processing technology by a generative AI, and repetition of the same topic, stuttering, a response speed to a question, a diversity of vocabulary, a logical connection, richness of emotional expression, use of a joke or a metaphor, accurate recognition of a partner's name or a date, consistency of conversation, a topic switching frequency, digression of a topic, an expression of consideration for a partner, and the like are used as evaluation indices. In addition, a change in a behavior pattern (a rapid decrease in a frequency of going out, a decline in motivation to participate in hobby activities, an increase in forgetfulness, a disturbance of a sleep rhythm, a decrease in a number of meals, an increase in forgetting to take medication, a procedure mistake in housework, and the like) is also reflected in scoring. Furthermore, a physical function score is calculated from a walking speed, a moving range, a number of falls, an achievement degree of rehabilitation, a meal intake amount, an excretion status, a bathing frequency, an amount of exercise, stability of vitals, and the like. Analysis is performed by giving the generative AI a prompt sentence such as "Extract a sign of a change or decline in cognitive function or physical function from a conversation record, a behavior record, health data, and a nursing care record of this user for the past one month, and score it" or "Detect a pattern such as repetition of conversation, a reaction delay, a decrease in vocabulary, a decrease in a walking speed, an increase in a number of falls, and a decrease in a meal intake amount, and evaluate a risk". Specifically, the cognitive function and physical function evaluation unit includes an ensemble inference architecture combining a large language model and a time-series analysis model. The evaluation unit acquires the integrated data set from the data integration unit. The evaluation unit inputs the data set to a prompt generation module. The module converts numerical data and categorical data into a text expression of a natural language. The module combines the converted text and a predetermined instruction sentence to generate a prompt character string. The evaluation unit inputs the generated prompt character string to a large language model. Input data to the model is an index array of a tokenized prompt. The number of dimensions of the input data to the model is a maximum of 4096 tokens. Specific examples of the input data to the model include a text token indicating a step count transition for the past one week and a text token pointing out a decrease in vocabulary during conversation. The model is a transformer network having billions of parameters. The model deeply analyzes a context of the input text using a pre-trained language understanding capability. The model infers a score indicating a state of cognitive function and physical function. A format of output data from the model is structured JSON format text data. Specific examples of the output data from the model include a numerical value of 85 indicating a cognitive function score and a numerical value of 72 indicating a physical function score. The evaluation unit parses the output text data. The evaluation unit extracts the numerical score and records it in a database. The evaluation unit transmits the extracted score to the subsequent risk prediction unit. With this configuration, the system realizes understanding of a complex context, which has been difficult with a conventional simple rule-based evaluation. The system exhibits a technical effect of automating highly accurate function evaluation close to a diagnosis by a specialist. This technology is extremely useful in specific application fields such as a screening system in telemedicine and a healthy life expectancy extension program for the elderly of a local government.

The risk prediction unit is a unit configured to comprehensively analyze a family history, a medical history, a transition of cognitive and physical scores, a fall history, a medication status, a frequency of social interaction, a change in a meal or sleep, and the like using a machine learning model by a generative AI to individually predict a risk of dementia or physical function decline. For example, a prompt sentence such as "Predict a risk of dementia or physical function decline based on the integrated data set of this user, and explain a risk factor" or "Extract a lifestyle habit or a behavior pattern contributing to a risk increase, and create an improvement proposal" is given to the generative AI, a risk level (low, medium, high) is determined, and a risk factor and an improvement point are output in a natural language. For example, when a cognitive function score rapidly declines and a number of falls increases, it is determined that "a dementia risk and a fall risk are high", and an improvement proposal such as "strengthening of attendance when going out", "introduction of a walking aid", and "recommendation of a medical examination by a specialist" is automatically generated. Specifically, the risk prediction unit includes a hybrid prediction engine combining a gradient boosting decision tree algorithm and a deep neural network. The prediction unit acquires various scores calculated from the evaluation unit and a feature amount extracted from the integrated data set. The prediction unit combines these data to generate a high-dimensional feature amount vector. The prediction unit inputs the feature amount vector to a deep neural network. Input data to the network is a one-dimensional array of normalized floating-point numbers. The number of dimensions of the input data to the network is 256 dimensions. Specific examples of the input data to the network include a moving average value of a cognitive function score for the past one month and a binary flag indicating a fall history. The network learns a non-linear relationship of the input data through a plurality of hidden layers. The network suppresses overlearning using a dropout layer. The network calculates a probability of each risk level using a softmax function of a final layer. A format of output data from the network is a probability distribution vector for each class of low, medium, and high. Specific examples of the output data from the network include a probability value of 0.82 for a high risk and a probability value of 0.15 for a medium risk. The prediction unit determines a class with the highest probability as a final risk level. The prediction unit calculates a contribution degree of each feature amount to a risk using a gradient boosting decision tree model. The prediction unit specifies a feature amount having a high contribution degree as a risk factor. The prediction unit inputs the specified risk factor to a large language model. The model generates a specific improvement proposal text based on the risk factor. The prediction unit transmits the determined risk level and the generated improvement proposal to the subsequent nursing care plan generation unit. With this configuration, the system clarifies a judgment basis of artificial intelligence that is easy to become a black box. The system exhibits a technical effect of realizing highly accurate risk prediction while ensuring transparency and reliability of prediction. This technology is extremely useful in specific application fields such as a selection system of a preventive benefit target person of nursing care insurance and an assessment system of health promotion type insurance of a private insurance company.

The nursing care plan generation unit is a unit configured to automatically generate an individually optimized nursing care plan by giving a generative AI a prompt sentence such as "Create a rehabilitation menu for one week, life support advice, a recreation proposal, and feedback for a family and a staff in accordance with a risk and interests of this user" or "Generate memory training contents using a photograph or a memory of the user" based on a risk prediction result, interests, a living situation, a family structure, a past activity history, and the like of the user. For example, when a risk is high, a medical institution consultation or a specialist consultation is strongly recommended, music therapy or singing recreation is proposed to a user who likes music, and individual rehabilitation or a walking program is proposed to a user who likes exercise. Furthermore, feedback such as "a recent change in cognitive function or physical function", "a point to be noted in the future", and "an example of calling out in daily life" is also automatically generated for a family and a nursing care staff. Specifically, the nursing care plan generation unit includes a planning engine using a generative model optimized by reinforcement learning. The generation unit acquires a risk level and an improvement proposal from the risk prediction unit. The generation unit acquires data of hobbies and preferences and a family structure of the user from a user profile database. The generation unit integrates these pieces of information to generate a context vector. The generation unit inputs the context vector to a generator of a conditional generative adversarial network. Input data to the generator is a combined tensor of the context vector and a random noise vector. The number of dimensions of the input data to the generator is 512 dimensions. Specific examples of the input data to the generator include an embedding vector of a categorical variable indicating liking music and a numerical vector indicating a high-risk state. The generator generates a plurality of candidates for a nursing care plan for one week based on the input data. The generation unit inputs the generated plan candidates to a discriminator. The discriminator evaluates effectiveness of each plan based on past success case data. The generation unit selects a plan having the highest evaluation score of the discriminator as an optimal plan. The generation unit inputs the selected plan to a large language model. The model converts contents of the plan into text of a natural language or structured data. A format of output data from the model is a hierarchical data structure including a date and time, activity contents, and notes. Specific examples of the output data from the model include schedule data that music therapy is implemented at 10:00 a.m. on Monday and text data that attention is paid to a fall during walking. The generation unit transmits the generated nursing care plan to a subsequent artificial intelligence care coaching unit. With this configuration, the system dynamically generates not a uniform nursing care plan but a tailor-made plan completely adapted to individual characteristics and a state change. The system exhibits a technical effect of dramatically improving a quality of a nursing care service. This technology is extremely useful in specific application fields such as a care plan creation support system for a care manager and an automatic scheduling application for home nursing care.

The AI care coaching unit is a unit configured to propose these nursing care plans, rehabilitation menus, life support advice, and feedback to a user and a nursing care staff through a tablet, a smartphone, a voice assistant, a chatbot, or the like, and monitor an implementation status and a reaction of the user. For example, it makes specific action proposals and alerts such as "Let's perform music therapy for 10 minutes today", "Let's take a walk and stretch in the afternoon", "Since conversation has decreased recently, let's make a video call with your family", and "Since falls are increasing, let's consider using a walking aid". When the user or the staff inputs implemented contents and reactions, the information is also accumulated in the data integration unit again and utilized for evaluation and plan generation from the next time onward. Furthermore, it analyzes an activity implementation status, emotional expression, a life rhythm, a physical condition change, feedback from a family and a nursing care staff, and the like of the user in real time using a generative AI, dynamically generates and provides encouragement, a reminder, an alert, and an action proposal at an optimal timing and method for each user, and automatically updates the nursing care plan and the rehabilitation menu according to a reaction and an implementation status of the user. Specifically, the present artificial intelligence care coaching unit includes a dynamic intervention engine integrating real-time stream processing and a reinforcement learning agent. The present coaching unit receives the optimized nursing care plan from the nursing care plan generation unit. The present coaching unit continuously acquires real-time biometric data and behavior data from a terminal and an environmental sensor of the user. The present coaching unit converts the acquired real-time data into a state vector. The present coaching unit inputs the state vector to a deep reinforcement learning model. Input data to the present model is a multidimensional numerical vector indicating a current state of the user. The number of dimensions of the input data to the present model is 64 dimensions. As a specific example of the input data to the present model, there are a numerical value indicating a current heart rate and a numerical value indicating an amount of activity in the latest one hour. The present model calculates an optimal action using a policy gradient method based on a Markov decision process. The present model determines an intervention timing and intervention contents that maximize motivation of the user and minimize a risk. A format of output data from the present model is a selection probability distribution of each action in a predefined action space. As a specific example of the output data from the present model, there are a probability of 0.75 for executing voice encouragement and a probability of 0.20 for executing a text notification to a screen. The present coaching unit selects and executes an action with the highest probability. The present coaching unit acquires a reaction of the user to the executed intervention from sensor data or voice input. The present coaching unit calculates the reaction as a reward signal. The present coaching unit updates a weight parameter of the reinforcement learning model in real time using the calculated reward signal. When a state change of the user exceeds a predetermined threshold, the present coaching unit transmits a trigger signal requesting regeneration of the nursing care plan to the nursing care plan generation unit. With this configuration, the present system realizes an adaptive intervention according to an instantaneous state of the user instead of static schedule execution. The present system exerts a technical effect of dramatically improving a success rate of intervention and compliance of the user. The present technology is extremely useful in specific application fields such as a medication support robot for chronic disease patients and a personal training system in a fitness gym.

An external cooperation unit is a unit configured to cooperate with a medical institution, a nursing care provider, a community comprehensive support center, a family, a social worker, a care manager, a pharmacist, a dietitian, a rehabilitation staff, a local event organizer, and the like, and safely share necessary information. For example, it transmits a cognitive function score, a risk level, and an activity history to a medical institution with consent of the user, adjusts a nursing care plan in cooperation with a nursing care provider, automatically acquires local event information and proposes it to the user, and automatically notifies a family and a medical institution in an emergency such as a fall or a rapid cognitive function decline. For example, it automatically collects event information such as a local health class, a hobby circle, a volunteer activity, a rehabilitation class, and a dementia cafe, and proposes an optimal event according to interests and a risk of the user. Specifically, the present external cooperation unit includes an information sharing gateway combining a secure data communication protocol and a distributed ledger technology. The present cooperation unit acquires data of an evaluation score and a nursing care plan generated in the system. The present cooperation unit encrypts data to be transmitted using an advanced encryption standard algorithm. The present cooperation unit generates an application programming interface request for transmitting the encrypted data to a system of an external medical institution or nursing care provider. Input data to the present cooperation unit is a data packet including an identifier of a transmission destination and an encrypted payload. The number of dimensions of the input data to the present cooperation unit is a variable-length byte array. As a specific example of the input data to the present cooperation unit, there are a JSON format character string including the latest cognitive function score of the user and an alert flag in an emergency. The present cooperation unit verifies validity of a communication partner using a mutual authentication protocol. The present cooperation unit transmits the data only when the verification is successful. The present cooperation unit records a transmission history and an access log of the data in a blockchain network. The present cooperation unit prevents falsification of the data and ensures traceability. The present cooperation unit executes an external web scraping module. The present cooperation unit automatically extracts a holding date and time and contents of an event from a local event information site using natural language processing. A format of output data from the present cooperation unit is a structured database record of the extracted event information. As a specific example of the output data from the present cooperation unit, there are position information coordinates indicating a holding place of a dementia cafe and text data indicating participation conditions. The present cooperation unit transfers the extracted event information to the artificial intelligence care coaching unit. With this configuration, the present system realizes seamless information sharing among multiple professions while strictly protecting sensitive personal information. The present system exerts a technical effect of strengthening a function as a digital foundation of a community comprehensive care system. The present technology is extremely useful in specific application fields such as a medical information cooperation network system and a welfare service integration platform of a local government.

As described above, the system according to the present embodiment comprehensively realizes nursing care activities and continuous support optimized for each user, real-time data analysis and feedback, cooperation with medical care, nursing care, family, and local resources, emergency response, privacy protection, and improvement of user experience by closely cooperating each unit and utilizing a generative AI in a multilayered and dynamic manner. Specifically, the present system adopts a distributed cooperative architecture in which an edge computing device and a cloud server group are connected by a high-speed network. The present system containerizes each processing unit as an independent microservice. The present system dynamically allocates computational resources according to a load of each service using a container orchestration tool. The present system executes a lightweight inference model on an edge side. The present system completes processing with high real-time property without delay. The present system executes advanced batch processing using a large language model or a deep learning model on a cloud side. The present system realizes precise analysis based on an enormous amount of history data. Input data to the present system is millions of sensor data streams transmitted every second from thousands of users. The number of dimensions of the input data to the present system reaches tens of thousands of dimensions in the entire system. As a specific example of the input data to the present system, there are a real-time heart rate matrix of all users and a tensor stream of all camera images in a facility. The present system processes these big data at high speed with an in-memory database. A format of output data from the present system is an optimized intervention command group for each user and statistical dashboard data for an administrator. As a specific example of the output data from the present system, there are an emergency notification command to a specific user and a fall risk distribution map of the entire facility. The present system provides comprehensive care beyond a boundary between medical care and nursing care through these outputs. With this configuration, the present system creates a new care model of data-driven predictive intervention, not limited to mere automation of business. The present system exerts an extremely important technical effect of providing maximum care quality with limited human resources. The present technology is extremely useful in specific application fields such as a health management infrastructure in a smart city and a next-generation advanced medical and nursing care complex facility.

### Implementation Steps

Step 1: Multidimensional Collection of Health Data Various health-related data such as a heart rate, a blood pressure, a body temperature, a number of steps, a sleep time, a body weight, a blood glucose level, an oxygen saturation, consumed calories, a resting heart rate, an exercise intensity, a wake-up/bedtime, a medical history, a family history, a medication history, allergy information, and a periodic health examination result are automatically acquired from a wearable device such as a smart watch, an activity meter, a sphygmomanometer, a thermometer, a pulse oximeter, and a blood glucose meter worn by a user, a health management application installed in a smartphone or a tablet, electronic medical record data of a periodic health examination, a medication management application, or the like, and transmitted to a server. For example, a blood pressure measurement value every morning is acquired from a smart watch by Bluetooth communication, a total number of steps per week is collected from an activity meter, a monthly body weight transition is acquired from a weight scale via Wi-Fi, a medication status is acquired from a medication management application, and electronic medical record data of a periodic health examination is automatically linked from a medical institution. Specifically, in step 1, the present system executes an edge gateway module that integrally receives biometric signal streams asynchronously transmitted from various Internet of Things devices. The present module simultaneously terminates a plurality of communication protocols such as a Bluetooth Low Energy standard and a Wi-Fi standard. The present module extracts a payload from a received packet. The present module converts the extracted data into a write format of a time-series database. Input data to the present module is a sensor data packet in a binary format transmitted from each device. The number of dimensions of the input data to the present module is a one-dimensional or multidimensional array depending on a sensor type of the device. As a specific example of the input data to the present module, there are a numerical array of an electrocardiogram waveform sampled at 100 hertz and three-axis acceleration data at one-second intervals. The present module applies a low-pass filter to the received data. The present module removes high-frequency noise. The present module constructs an encrypted tunnel for safely transferring the data after noise removal to a cloud server. A format of output data from the present module is a time-series data record structured in a JSON format. As a specific example of the output data from the present module, there are a pair of a time stamp and a heart rate value, and metadata including a media access control address of a measuring instrument. The present system transmits these data to a distributed message queuing system on a cloud. The present system constructs an environment in which a subsequent processing unit can consume data asynchronously and scalably. With this configuration, the present system prevents data loss even against a fluctuation in a communication band or a temporary disconnection of a device. The present system exerts a technical effect of dramatically improving robustness and reliability of large-scale data collection. The present technology is extremely useful in specific application fields such as a health monitoring project targeting tens of thousands of citizens and a real-time vital monitoring system for inpatients in a large-scale hospital.

Step 2: Comprehensive Collection of Daily Activity, Communication, and Nursing Care Record A frequency of going out, a moving distance, an amount of exercise, a number of times of participation in hobby activities, an implementation status of housework, a sleep rhythm, a meal time, a bathing time, a number of times of going to a toilet, a television viewing time, a reading time, presence or absence of a nap, a diversity of walking courses, a number of telephone calls, a number of times of sending and receiving messages, an SNS posting frequency, a length of conversation, a diversity of topics, presence or absence of emotional expression, repetition of the same topic, a response speed to a question, a topic switching frequency, a recreation participation status, a record of an accident or abnormal behavior, and the like are acquired using a GPS function, an acceleration sensor, a calendar application, a behavior recording application, a voice input application, an image recognition application, a call history, a message application, an SNS usage status, a voice recognition function, a video call application, an email application, a camera application of a terminal of a user, an IoT sensor or a conversation recording system in a facility, or the like, and transmitted to a server. Specifically, in step 2, the present system executes a sensor fusion algorithm for quantifying a behavior trajectory and environmental interaction of the user. The present system acquires latitude and longitude coordinates from a global positioning system receiver built in a smartphone. The present system acquires a three-dimensional motion vector from an acceleration sensor and a gyro sensor. The present system inputs these spatial data to a Kalman filter. The present system corrects a measurement error of a sensor and estimates a highly accurate moving trajectory. Input data to the present system is a heterogeneous time-series numerical stream obtained from a plurality of sensors. The number of dimensions of the input data to the present system is an eight-dimensional tensor combining two dimensions of position coordinates and six dimensions of a motion vector. As a specific example of the input data to the present system, there are a floating-point number of latitude and longitude updated every second and a continuous value of an angular velocity. The present system inputs the estimated moving trajectory to a spatial clustering algorithm. The present system extracts a frequent staying place and a moving pattern of the user. The present system inputs unstructured data obtained from a voice input application or a call history to a natural language processing module. The present system measures a length of utterance and a time of silence. A format of output data from the present system is a multidimensional feature vector integrating a behavior feature amount and a communication feature amount. As a specific example of the output data from the present system, there are a numerical value indicating a total moving distance per day and a numerical value in milliseconds indicating an average response time during conversation. The present system transmits these feature vectors to a cloud server via a secure communication channel. With this configuration, the present system continuously captures a minute change in daily life in a background without relying on conscious input of the user. The present system exerts a technical effect of realizing automatic generation of an objective and comprehensive life log. The present technology is extremely useful in specific application fields such as an abnormality detection system for elderly people living alone and a behavior change monitoring system for psychiatric patients.

Step 3: Data Integration and Preprocessing Health data, daily activity data, communication data, and nursing care record data are integrated for each user on a server to generate an integrated data set managed in chronological order. Correction of data loss or an abnormal value, anonymization processing for privacy protection, and normalization or standardization of data are also performed. For example, step count data and sleep data acquired from a plurality of devices and applications are deduplicated, an abnormal value is automatically detected and corrected, and all data are converted into a common time-series format and managed. Specifically, in step 3, the present system executes a data orchestration engine that controls an extraction, transformation, and loading pipeline. The present engine temporarily stores various data streams arriving asynchronously from a distributed message queue in a buffer on a memory. The present engine combines a plurality of data streams using a time stamp as a key. The present engine executes a machine learning model using a bidirectional long short-term memory network for missing value imputation. Input data to the present model is a multivariate time-series matrix arranged along a time axis. The number of dimensions of the input data to the present model is several hundred dimensions equal to types of all collected sensor data. As a specific example of the input data to the present model, there are sleep depth data for one week partially missing and an array of blood pressure values measured irregularly. The present model estimates the most probable value of a missing part using both past and future context information. The present engine executes an isolation forest algorithm for abnormal value detection. The present engine specifies a data point largely deviating from a normal data distribution and applies a smoothing filter. A format of output data from the present engine is a completely imputed and normalized dense multidimensional tensor. As a specific example of the output data from the present engine, there is a 128-dimensional feature amount tensor evenly sampled in units of one hour. The present engine stores this tensor in a column-oriented database. The present engine optimizes a response speed to a subsequent analysis query. With this configuration, the present system automatically converts dirty data including noise and loss peculiar to a real environment into high-quality clean data that can be directly processed by an artificial intelligence model. The present system exerts a technical effect of reducing a calculation cost required for data preprocessing and improving processing efficiency of the entire system. The present technology is extremely useful in specific application fields such as construction of a large-scale medical data warehouse and a nursing care record integration platform of a plurality of facilities.

Step 4: Cognitive Function and Physical Function Evaluation (Utilization of Generative AI) An integrated data set is analyzed, and a cognitive function score and a physical function score are calculated from daily conversation contents, a behavior pattern, health data, and a nursing care record of a user using a generative AI. Analysis is performed by giving the generative AI a prompt sentence such as "Extract a sign of a change or decline in cognitive function or physical function from a conversation record, a behavior record, health data, and a nursing care record of this user for the past one month, and score it" or "Detect a pattern such as repetition of conversation, a reaction delay, a decrease in vocabulary, a decrease in walking speed, an increase in a number of falls, and a decrease in meal intake, and evaluate a risk". Specifically, in step 4, the present system executes a multimodal inference engine having a large language model as a core. The present engine reads the multidimensional tensor generated by the data integration unit. The present engine executes a template generator that converts numerical data into a natural language description. The present engine combines the converted text and a free description text of a nursing care record. The present engine inputs the combined text as a prompt to a large language model. Input data to the present model is an array of token indexes obtained by dividing text by a byte pair encoding method. The number of dimensions of the input data to the present model is a maximum of 8192 tokens. As a specific example of the input data to the present model, there are a text token indicating that a walking speed has decreased by 10 percent compared to the previous month and a text token indicating that the same question was repeated three times during conversation. The present model calculates a complex self-attention weight between input tokens using hundreds of layers of transformer blocks. The present model extracts a sign of a decline in cognitive function and physical function while collating with pre-learned medical knowledge. A format of output data from the present model is a structured JSON object including an evaluation score of each function and a text serving as a basis. As a specific example of the output data from the present model, there are numerical data of a cognitive function score of 65 and text data of an inference reason that a decline in short-term memory is suspected. The present engine parses the output JSON object and appends the score to a time-series database. With this configuration, the present system realizes advanced semantic analysis that integrally interprets numerical data and unstructured text data. The present system exerts a technical effect of automatically and instantaneously executing an evaluation close to a comprehensive assessment performed by a human expert. The present technology is extremely useful in specific application fields such as an early detection screening tool for dementia and an effect measurement system for rehabilitation.

Step 5: Risk Prediction (Utilization of Generative AI) A family history, a medical history, a transition of cognitive and physical scores, a fall history, a medication status, a frequency of social interaction, a change in a meal or sleep, and the like are comprehensively analyzed using a machine learning model by a generative AI to individually predict a risk of dementia or physical function decline. A prompt sentence such as "Predict a risk of dementia or physical function decline based on an integrated data set of this user, and explain a risk factor" or "Extract a lifestyle habit or a behavior pattern contributing to a risk increase, and create an improvement proposal" is given to the generative AI. Specifically, in step 5, the present system executes a risk prediction pipeline linking a deep learning-based survival time analysis model and a large language model. The present system combines a time-series transition of the evaluation score calculated in step 4 and a static feature amount such as a family history or a medication status. The present system inputs the combined data to a multilayer perceptron network. Input data to the present network is a one-dimensional tensor concatenating a continuous value and an embedding vector of a categorical variable. The number of dimensions of the input data to the present network is 512 dimensions. As a specific example of the input data to the present network, there are a numerical value indicating a slope of a cognitive function score for the past six months and a one-hot vector indicating taking of a specific antihypertensive drug. The present network learns a complex interaction between feature amounts using a non-linear activation function. The present network outputs a probability of a dementia onset risk or a fall risk within one year from now. The present system inputs the calculated probability value and a feature amount with a high contribution degree to a large language model. Input data to the present model is a prompt character string including a list of a risk probability and a feature amount. The present model generates a logical explanation of a risk factor and a specific improvement proposal based on these numerical grounds. A format of output data from the present model is a risk report text described in a natural language. As a specific example of the output data from the present model, there are an explanatory text that taking a sleeping pill and an increase in a number of times of going to a toilet at night increase a fall risk, and an improvement proposal to install a sensor light at a bedside. The present system stores the generated report in a database. With this configuration, the present system achieves both highly accurate probability prediction and explanation generation in a natural language understandable by a human. The present system exerts a technical effect of enhancing a sense of conviction of a medical worker or a family regarding a judgment of an artificial intelligence and prompting a rapid intervention action. The present technology is extremely useful in specific application fields such as an accident prevention system in a nursing care facility and an extraction system for a high-risk patient in a community medical network.

Step 6: Individually Optimized Nursing Care Plan Generation (Utilization of Generative AI) Based on a risk prediction result, interests, a living situation, a family structure, a past activity history, and the like of a user, a prompt sentence such as "Create a rehabilitation menu for one week, life support advice, a recreation proposal, and feedback for a family and a staff according to a risk and interests of this user" or "Generate memory training contents using a photograph or a memory of a user" is given to a generative AI to automatically generate an individually optimized nursing care plan. Specifically, in step 6, the present system executes a planning algorithm using a constrained language generation technology. The present system acquires the risk report generated in step 5 and profile information extracted from a hobby and interest database of the user. The present system integrates these pieces of information and embeds them in a prompt template. The present system inputs the completed prompt to a large language model. Input data to the present model is a text token array including a current state of the user, a target health condition, and a constraint condition of an available resource. The number of dimensions of the input data to the present model reaches thousands of tokens. As a specific example of the input data to the present model, there are a text of a constraint condition to avoid strenuous exercise because of a high fall risk and a profile text that gardening was preferred in the past. The present model generates a specific activity plan that attracts an interest of the user while satisfying the constraint condition through an autoregressive decoding process. The present model searches for a sequence of a plan having the highest likelihood and rich in diversity using a beam search algorithm. A format of output data from the present model is structured schedule data including a date and time, an activity name, a required time, and a necessary preparation item. As a specific example of the output data from the present model, there are schedule data of gardening work performed in a state of sitting on a chair for 30 minutes from 2:00 pm on Tuesday and a list of tools necessary at that time. The present system registers the generated schedule data in a calendar system. With this configuration, the present system automatically constructs an executable care plan completely personalized for each user from countless combinations. The present system exerts a technical effect of significantly improving efficiency of a plan creation work of a care manager and enhancing individuality of a service. The present technology is extremely useful in specific application fields such as an automatic organization system of a daily routine in a day service center and a self-care support application for a home care patient.

Step 7: Proposal, implementation, and monitoring by an AI care coaching unit (utilization of a generative AI) The generated nursing care plan, rehabilitation menu, life support advice, and feedback are proposed to a user and a nursing care staff through a tablet, a smartphone, a voice assistant, a chatbot, or the like, and an implementation status and a reaction of the user are monitored. Prompt sentences such as "Generate optimal encouragement, a reminder, an alert, and an action proposal based on an activity implementation status, emotional expression, a life rhythm, a physical condition change, and feedback from a family and a nursing care staff of the user" and "Automatically update the nursing care plan and the rehabilitation menu according to a reaction and an implementation status of the user" are given to the generative AI. Specifically, in step 7, the system executes a reinforcement learning-based dialog manager that controls an interactive artificial intelligence agent. The system reads the nursing care plan generated in step 6 as an action plan of the agent. The system acquires real-time facial expression data and voice data from a camera and a microphone of a terminal of the user. The system inputs these data to a convolutional neural network for emotion recognition. Input data to the network is an image tensor of a face or a mel-frequency cepstral coefficient matrix of a voice. The number of dimensions of the input data to the network is a three-channel tensor of 256 pixels square in the case of an image. As a specific example of the input data to the network, there are image data indicating a fatigued facial expression of the user and voice data with a low voice tone. The network quantifies a current emotional state and a fatigue degree of the user. The system inputs the emotional state and a schedule of the nursing care plan to a large language model. The model generates a text of a greeting optimal for a current situation. A format of output data from the model is a text character string for utterance and a parameter group for controlling a prosody of a synthesized voice. As a specific example of the output data from the model, there are a text saying "You seem a little tired, why don't you stretch for just five minutes without overdoing it?" and a parameter for setting a speaking speed to be slow. The system generates a natural voice using a text-to-speech synthesis engine, and outputs the natural voice from a speaker of the terminal. The system detects presence or absence of execution of the proposal by the user with a sensor, and updates the model using the result as a reward of reinforcement learning. With this configuration, the system realizes a dynamic and empathetic interaction that is close to a state of the user at that moment. The system exhibits a technical effect of effectively promoting a behavior change of the user and dramatically improving a continuation rate of the plan. This technology is extremely useful in specific application fields such as a communication robot for the elderly and a smart speaker application aiming at improving medication compliance.

Step 8: Periodic re-evaluation and feedback (utilization of a generative AI) A cognitive function and a physical function are periodically re-evaluated, a change in a score and a risk level is analyzed using a generative AI, prompt sentences such as "Summarize a transition of an activity history and a cognitive and physical function score for one month of this user, and create a report text for a family" and "Summarize a risk factor and a recommended intervention measure for a medical institution" are given, and optimal feedback and a report are automatically generated for a family, a medical institution, and a nursing care staff. Specifically, in step 8, the system executes a document generation engine that summarizes long-term chronological data and generates a report according to a target person. The system extracts log data of a cognitive function score, a physical function score, and a daily activity record accumulated in the past one month from a database. The system inputs the extracted data to a statistical processing module, and calculates a statistical feature amount such as an average value, a variance, and an inclination of a trend. The system inputs these statistical data and raw log data to a large language model. Input data to the model is a long-sentence context prompt combining an enumeration of numerical values and a text log. The number of dimensions of the input data to the model reaches tens of thousands of tokens, which is a maximum context length of the model. As a specific example of the input data to the model, there are a numerical array expressing a step count transition graph for one month and a summary text of a dialogue history with a care coach. The model extracts an important change point and a notable result from the input huge amount of data. The model adjusts a tone of output and a usage level of technical terms according to an attribute of a reader (a family, a doctor, and a nursing care staff). A format of output data from the model is a report text structured in a markdown format. As a specific example of the output data from the model, there are a warm report text avoiding technical terms for a family, and a bulleted text briefly summarizing an abnormal value of vital data and a risk factor for a doctor. The system publishes the generated report on a portal site, and transmits a notification to a related party. With this configuration, the system automatically extracts an insight that a human can intuitively understand from a huge amount of data. The system exhibits a technical effect of improving the quality of information sharing among multiple professions and strengthening cooperation of team care. This technology is extremely useful in specific application fields such as an automatic discharge summary generation function of an electronic medical record system and an automatic monthly report creation system in a nursing care facility.

Step 9: External cooperation and emergency response In cooperation with a medical institution, a nursing care provider, a community comprehensive support center, a family, a social worker, a care manager, a pharmacist, a dietitian, a rehabilitation staff, a community event organizer, and the like, a cognitive function score, a risk level, and an activity history are transmitted to the medical institution with consent of a user, a nursing care plan is adjusted, community event information is automatically acquired and proposed to the user, and an automatic notification is sent to the family and the medical institution in an emergency such as a fall or a rapid cognitive function decline. Specifically, in step 9, the system executes an external cooperation gateway based on an event-driven asynchronous communication architecture. The system includes a rule-based complex event processing engine that constantly monitors a state of the user. The system inputs a stream of sensor data and an evaluation score to the engine. Input data to the engine is a group of real-time event messages arriving in milliseconds. The number of dimensions of the input data to the engine is a variable-length key-value pair according to a type of an event. As a specific example of the input data to the engine, there are numerical data indicating a rapid impact detected by an acceleration sensor and an alert flag indicating that a heart rate has fallen below a threshold value. The engine analyzes a combination pattern of a plurality of events, and instantaneously determines occurrence of an emergency. When the engine detects an emergency, the system immediately executes an interrupt process. The system refers to a contact database of a medical institution and a family registered in advance. The system calls an application programming interface for emergency notification. A format of output data from the system is a payload of a POST request using a hypertext transfer protocol. As a specific example of the output data from the system, there is JSON data including latitude and longitude information of a current position of the user and a transition of vital signs for the latest five minutes. The system encrypts this data, transmits the encrypted data to an external system, and performs retransmission control until a reception confirmation is obtained. With this configuration, the system detects a life-threatening serious incident with a delay in milliseconds, and reliably transmits the incident to a related institution. The system exhibits an extremely important technical effect of improving a lifesaving rate and preventing aggravation. This technology is extremely useful in specific application fields such as an emergency notification system for the elderly living alone and a wide-area monitoring network in a smart city.

### Specific Use Case

For example, when the system of the present invention is introduced in a nursing care facility, a user constantly wears a wearable device such as a smart watch, an activity meter, a blood pressure monitor, a thermometer, a pulse oximeter, and a blood glucose meter, and health-related data such as a heart rate, a blood pressure, a body temperature, a number of steps, a sleep time, a body weight, a blood glucose level, an oxygen saturation, consumed calories, a resting heart rate, an exercise intensity, and a wake-up/bedtime are automatically acquired. Furthermore, a nursing care staff uses a tablet terminal or a nursing care recording system to record in detail a meal intake amount and contents, presence or absence and a time of bathing, a number of times and a status of excretion, use of a walking aid during movement, an occurrence date and time and a status of a fall or a tumble, a frequency and contents of forgetfulness, contents and a reaction of conversation, a participation status and a reaction to recreation, an implementation status of medication and forgetting to take medication, a vital measurement value, implementation contents and an achievement degree of rehabilitation, and details of an accident or an abnormal behavior. In addition, using a GPS function, an acceleration sensor, a calendar application, a behavior recording application, a voice input application, an image recognition application, a call history, a message application, an SNS usage status, a voice recognition function, a video call application, an email application, and a camera application of a terminal of the user, an IoT sensor and a conversation recording system in the facility, and the like, a frequency of going out, a moving distance, an amount of exercise, a number of times of participation in hobby activities, an implementation status of housework, a sleep rhythm, a meal time, a bathing time, a number of times of going to a toilet, a television viewing time, a reading time, presence or absence of a nap, a diversity of walking courses, a number of calls, a number of times of sending and receiving messages, an SNS posting frequency, a length of conversation, a diversity of topics, presence or absence of emotional expression, repetition of the same topic, a response speed to a question, a topic switching frequency, a recreation participation status, a record of an accident or an abnormal behavior, and the like are also acquired. Specifically, the system constructs a data collection infrastructure combining a high-density sensor network and edge computing in a closed space of a nursing care facility. The system continuously collects biological data from various wearable devices worn by the user using a low power consumption wireless communication standard. The system measures a radio wave intensity from the device using a plurality of receiving antennas arranged in the facility. The system executes a three-point positioning algorithm to specify an indoor position of the user with an accuracy in centimeters. Input data to the system is a numerical array of a received signal strength indicator received by each antenna and a packet of vital data transmitted from the device. The number of dimensions of the input data to the system is a multidimensional vector proportional to a product of the number of antennas and the number of sensor channels. As a specific example of the input data to the system, there are a radio wave intensity value of minus 60 decibel-milliwatts and a numerical value of a blood oxygen saturation of 98 percent. The system aggregates these data in an edge server, adds a time stamp, and stores the data in a time-series database. The system similarly integrates electronic record data input by a nursing care staff and skeleton estimation coordinate data extracted from a camera image in the facility. A format of output data from the system is a multidimensional life log tensor including a spatial and temporal behavior trajectory for each user. As a specific example of the output data from the system, there are a numerical value indicating a stay time in a dining room and a time-series array indicating an approach distance to another person. With this configuration, the system captures all events in the facility as digital data without omission. The system exhibits a technical effect of accurately recording a state change even at night or in a private room where human eyes cannot reach. This technology is extremely useful in specific application fields such as automation of monitoring work in a large-scale special nursing home for the elderly and an incident prevention system in a dementia ward of a hospital.

These diverse data are integrally managed in chronological order for each user by a data integration unit, and correction of a missing value or an abnormal value, an anonymization process, normalization, and standardization are performed. A cognitive function and physical function evaluation unit utilizes a generative AI, and performs an analysis by giving prompt sentences such as "Extract a sign of a change or a decline in a cognitive function and a physical function from a conversation record, a behavior record, health data, and a nursing care record of this user for the past one month, and score the sign" and "Detect a pattern such as repetition of conversation, a response delay, a decrease in vocabulary, a decrease in walking speed, an increase in a number of falls, and a decrease in a meal intake amount, and evaluate a risk". The generative AI calculates a cognitive function score and a physical function score based on multifaceted information such as contents and a frequency of conversation, a declaration of forgetfulness, a walking or moving pattern, a record of a fall or an accident, a status of a meal or excretion, a frequency of social interaction, and a recreation participation status. Specifically, the system inputs the collected multidimensional life log tensor to a large language model on a cloud, and executes advanced semantic inference. The system executes an encoder network that converts heterogeneous mixed data into a common latent space vector in the data integration unit. After complementing a missing value and removing noise, the system passes the data to a prompt generation module. This module maps numerical data and categorical data to a context of a natural language. The system inputs the generated prompt to a transformer-based large language model having billions of parameters. Input data to the model is a long token sequence including a behavior history, a vital transition, and a text of a nursing care record of the user. The number of dimensions of the input data to the model ranges from thousands to tens of thousands of tokens. As a specific example of the input data to the model, there are a text token indicating that wandering at night occurred three times a week and a text token indicating that a meal intake amount decreased to half of a normal amount. The model calculates a hidden causal relationship between these events using a self-attention mechanism. The model executes comprehensive scoring based on medical knowledge, not simple anomaly detection. A format of output data from the model is a continuous value score from 0 to 100 for each domain of a cognitive function and a physical function, and text data indicating a calculation basis thereof. As a specific example of the output data from the model, there are a numerical value of a cognitive score of 50 suggesting progression of disorientation and a numerical value of a physical score of 60 indicating a decline in lower limb muscle strength. The system visualizes these scores on a dashboard and presents the scores to a staff. With this configuration, the system detects a sign of a complex functional decline that is difficult to see from fragmentary data at an early stage. The system exhibits a technical effect of enabling a preemptive care intervention for preventing aggravation. This technology is extremely useful in specific application fields such as an effect measurement system of a nursing care prevention program and a health management platform in housing for the elderly.

A risk prediction unit comprehensively analyzes a family history, a medical history, a transition of cognitive and physical scores, a fall history, a medication status, a frequency of social interaction, a change in a meal or sleep, and the like using a machine learning model by a generative AI, gives prompt sentences such as "Predict a risk of dementia or physical function decline based on an integrated data set of this user, and explain a risk factor" and "Extract lifestyle habits and a behavior pattern contributing to a risk increase, and create an improvement proposal" to the generative AI, determines a risk level (low, medium, high), and outputs a risk factor and an improvement point in a natural language. Specifically, the risk prediction unit functions with a large language model based on a transformer architecture equipped with a self-attention mechanism as a core. The risk prediction unit converts chronological data of the user into a multidimensional numerical vector as input data. The risk prediction unit converts static data such as a family history and a medical history into a categorical vector by one-hot encoding. The risk prediction unit normalizes dynamic data such as a transition of cognitive and physical scores and a change in sleep as a time-series array for each time step. The risk prediction unit combines these vector groups to generate, for example, a 512-dimensional integrated feature tensor. The risk prediction unit inputs this integrated feature tensor to an embedding layer of the large language model. The risk prediction unit divides the aforementioned prompt sentence into a natural language token sequence. The risk prediction unit inputs the token sequence to the model together with positional encoding. The large language model calculates an attention weight between the integrated feature tensor and the token sequence of the prompt. The large language model outputs a probability distribution indicating a risk level through a non-linear operation in a high-dimensional space. Output data from the large language model is expressed as an output value of a softmax function for each class of low, medium, and high. For example, the output data includes a probability distribution vector of low risk 0.1, medium risk 0.2, and high risk 0.7. The large language model simultaneously generates a text token sequence of a natural language explaining a risk factor in an autoregressive manner. For example, the output text includes a character string "A decrease in sleep time and a decline in social interaction frequency in the past three months were extracted as major risk factors for cognitive function decline". When a maximum value of the output probability distribution exceeds a predetermined threshold value, the risk prediction unit determines a corresponding risk level. The risk prediction unit transmits the determined risk level to a subsequent nursing care plan generation unit. This processing method mathematically analyzes a complex correlation among multivariates without depending on an intuitive judgment of a human. By this processing method, the system detects a minute sign of a risk at an early stage. The system significantly improves prediction accuracy compared to a conventional method. The system optimizes a weight parameter in advance using a past user data set by supervised learning using a cross-entropy error function. The system minimizes an inference error of the model using a gradient descent method. As a technical effect, the system shortens an analysis time of a huge amount of medical and nursing care data, and realizes highly accurate risk prediction while suppressing consumption of calculation resources. As a specific application field of the system, the system is applied to a preventive intervention system in a nursing care facility and a remote monitoring system in home nursing care.

A nursing care plan generation unit automatically generates an individually optimized nursing care plan by giving prompt sentences such as "Create a rehabilitation menu for one week, life support advice, a recreation proposal, and feedback for a family and a staff according to a risk and interests of this user" and "Generate contents for memory training using a photograph and a memory of the user" to a generative AI based on a risk prediction result, interests (for example, music, exercise, gardening, cooking, reading, handicrafts, Go, Shogi, karaoke, a pet, travel, and the like), a living situation, a family structure, a past activity history, and the like of the user. For example, when a risk is high, a medical examination at a medical institution or consultation with a specialist is strongly recommended, music therapy or singing recreation is proposed to a user who likes music, and individual rehabilitation or a walking program is proposed to a user who likes exercise. Furthermore, feedback such as "Recent change in cognitive function and physical function", "Points to note in the future", and "Examples of greetings in daily life" for a family and a nursing care staff is also automatically generated. Specifically, the nursing care plan generation unit includes a generative neural network capable of processing multimodal input data. The nursing care plan generation unit acquires a probability distribution vector of a risk level received from a risk prediction unit as input data. The nursing care plan generation unit converts text data indicating interests and a living situation of the user into a feature vector using a natural language processing technology. The nursing care plan generation unit acquires a past activity history as a time-series behavior log matrix. The nursing care plan generation unit integrates these heterogeneous data to construct, for example, a 1024-dimensional context tensor. The nursing care plan generation unit inputs this context tensor and the aforementioned prompt sentence to an encoder-decoder structure of a large language model. The large language model executes mapping of a feature amount in a latent space based on the input context tensor. The large language model generates nursing care plan data in a structured data format as output data. For example, the output data has an identifier of a rehabilitation menu for each day of the week, a category code of recommended recreation, and a text character string including advice for a family as elements. The large language model converts photographic image data of the user into an image feature tensor by a convolutional neural network. The large language model combines the image feature tensor and the text feature vector by a cross-attention mechanism. The large language model outputs a personalized quiz-format text for memory training from this combined data. For example, the output data includes a question text "Where was this photograph taken?" and a correct answer label. The nursing care plan generation unit analyzes the generated structured data, and converts the structured data into a command group interpretable by a subsequent AI care coaching unit. This processing method utilizes a generalization ability of a deep learning model, not a rule-based conditional branch. By this processing method, the system dynamically generates an optimal plan for an infinite number of combinations of user attributes. The system fine-tunes the model using an execution rate and a satisfaction score of the user for a past plan as a reward using a reinforcement learning algorithm. The system updates a weight to generate a more effective plan using a policy gradient method. As a technical effect, the system eliminates a plan creation work depending on a personal experience of a care manager. The system shortens a calculation processing time required for plan creation to milliseconds. The system improves adherence of the user by a data-driven approach. As a specific application field of the system, the system is applied to automatic planning of a daily activity plan in a day service center and a care plan creation support system in a home-visit nursing care station.

An AI care coaching unit proposes these nursing care plan, rehabilitation menu, life support advice, and feedback to a user and a nursing care staff through a tablet, a smartphone, a voice assistant, a chatbot, or the like, and monitors an implementation status and a reaction of the user. For example, a specific action proposal or an alert is given, such as "Let's perform music therapy for 10 minutes today", "Let's take a walk and stretch in the afternoon", "Since conversation has decreased recently, let's make a video call with your family", and "Since falls are increasing, let's consider using a walking aid". When the user or the staff inputs implemented contents or a reaction, the information is also accumulated in a data integration unit again, and is utilized for evaluation and plan generation from the next time onward. Furthermore, an activity implementation status, emotional expression, a life rhythm, a physical condition change, feedback from a family and a nursing care staff, and the like of the user are analyzed in real time using a generative AI, prompt sentences such as "Generate optimal encouragement, a reminder, an alert, and an action proposal based on an activity implementation status, emotional expression, a life rhythm, a physical condition change, and feedback from a family and a nursing care staff of the user" and "Automatically update the nursing care plan and the rehabilitation menu according to a reaction and an implementation status of the user" are given, encouragement, a reminder, an alert, and an action proposal are dynamically generated and provided at an optimal timing and method for each user, and the nursing care plan and the rehabilitation menu are automatically updated according to a reaction and an implementation status of the user. Specifically, the AI care coaching unit is implemented as an edge-cloud cooperative system integrating a real-time stream processing engine and an interactive large language model. The AI care coaching unit receives multimedia data acquired from a camera and a microphone of a user terminal as input data. The AI care coaching unit converts voice data into an acoustic feature amount matrix such as a mel-frequency cepstral coefficient. The AI care coaching unit extracts facial landmark coordinates from image data, and generates a numerical vector indicating an emotional state. The AI care coaching unit acquires a binary flag indicating an activity implementation status and biometric sensor data such as a heart rate as a time-series array. The AI care coaching unit aggregates these real-time data as, for example, a 256-dimensional dynamic state tensor. The AI care coaching unit inputs this dynamic state tensor and the aforementioned prompt sentence to a large language model. The large language model includes a layer of a recurrent neural network or a long short-term memory network, and holds a hidden state of a past dialogue history. The large language model analyzes the input dynamic state tensor, and outputs a text message to be presented to the user, markup language data for voice synthesis, and a time stamp indicating a presentation timing as output data. For example, the output data includes a text character string "It's a wonderful pace", a voice synthesis instruction including an emotion parameter of joy, and a flag indicating immediate execution. When a feature amount indicating a fatigue degree of the user exceeds a predetermined threshold value, the large language model outputs an update command to decrease an intensity of the rehabilitation menu. The AI care coaching unit feeds back the output update command to the data integration unit and the nursing care plan generation unit. This processing method detects a state change with a low delay in milliseconds, unlike an evaluation accompanied by a delay due to human observation. By this processing method, the system immediately executes an adaptive intervention for a minute reaction of the user. The system optimizes a dialogue policy to maximize a positive reaction of the user using a Q-learning algorithm in reinforcement learning. As a technical effect, the system enables a rapid inference process on an edge device side while reducing a network communication traffic. The system simultaneously realizes maintenance of motivation of the user and securing of safety. As a specific application field of the system, the system is applied to an interactive monitoring robot for the elderly living alone and a virtual assistant application in a rehabilitation facility.

In addition, a cognitive function and a physical function are periodically re-evaluated, a change in a score and a risk level is analyzed using a generative AI, prompt sentences such as "Summarize a transition of an activity history and a cognitive and physical function score for one month of this user, and create a report text for a family" and "Summarize a risk factor and a recommended intervention measure for a medical institution" are given, and optimal feedback and a report are automatically generated for a family, a medical institution, and a nursing care staff. When a cognitive function or a physical function rapidly declines, or when a fall or an accident occurs, the generative AI automatically summarizes contents thereof, and transmits an alert such as "A medical examination by a specialist is recommended" and "Please strengthen a fall prevention program". Specifically, the system includes a periodic evaluation module based on a batch processing architecture. The periodic evaluation module acquires a time-series data set of an activity history accumulated in the past one month as input data. The periodic evaluation module configures a transition of cognitive and physical function scores as a multidimensional time-series tensor. The periodic evaluation module applies a one-dimensional convolutional neural network to this time-series tensor, and extracts a feature vector indicating a long-term trend. The periodic evaluation module inputs the extracted feature vector and the aforementioned prompt sentence to a large language model specialized for natural language generation. The large language model sets the input feature vector as an initial state of a decoder network. The large language model outputs a structured document optimized for each destination as output data. For example, output data for a family includes a text character string in which technical terms are replaced with plain expressions, and a coordinate data array for drawing a graph indicating a score transition. Output data for a medical institution includes a list of risk factors based on an International Classification of Diseases code, and numerical data such as a p-value indicating a statistically significant difference. The periodic evaluation module calculates a first derivative value or a second derivative value of the input time-series tensor. When the calculated derivative value exceeds a preset safety threshold value, the periodic evaluation module determines that there is a rapid functional decline. The periodic evaluation module executes calculation of a reconstruction error using an autoencoder as an anomaly detection algorithm. When the reconstruction error exceeds a threshold value, the periodic evaluation module generates short message data for an immediate alert. The periodic evaluation module transmits the generated alert data as a push notification to a designated terminal via a communication interface. This processing method completely replaces manual data aggregation and report creation work by a human. By this processing method, the system provides a consistent evaluation based on objective data. The system adjusts a weight of the model to imitate a description style of a medical professional using a fine-tuning method in natural language processing. As a technical effect, the system reduces human resources required for report creation and prevents a delay in information sharing. The system brings about a medical effect of preventing aggravation by early detection of an abnormality. As a specific application field of the system, the system is applied to a multi-professional cooperation platform in a community comprehensive care system and an automatic summary generation system linked with an electronic medical record system.

As described above, the system of the present invention comprehensively collects and integrates diverse data of a user in real time at a nursing care site, and uses a generative AI to automate and sophisticate cognitive function and physical function evaluation, risk prediction, individually optimized nursing care plan generation, continuous support and feedback by an AI care coach, early abnormality detection, and medical cooperation, thereby comprehensively realizing quality improvement of the nursing care site, independence support for the user, burden reduction for a family and a staff, medical cost suppression, and healthy life expectancy extension. Specifically, the present system functions as a comprehensive cloud computing platform integrating a plurality of neural network models and a distributed database. The present system continuously receives a stream of unstructured data and structured data transmitted from an edge device group as input data. The present system stores the received data in a data lake and converts the received data into a normalized multidimensional tensor through a preprocessing pipeline. The present system routes these tensors to each inference endpoint of evaluation, prediction, plan generation, and coaching. The present system drives a parallel computing cluster using a GPU at each inference endpoint. The present system executes matrix multiplication and activation function calculation by a large language model or a time series analysis model at high speed. The present system writes a probability distribution, a text token sequence, and a control command generated from each module into an integrated database as output data. The present system directly controls a display and voice output hardware of a user terminal based on the output control command. The present processing method is not limited to mere digitization of information, but forms a data-driven autonomous feedback loop. By the present processing method, the present system simultaneously processes variables on a scale exceeding human cognitive limits and derives a global optimum solution. The present system adopts a federated learning architecture and shares only a weight gradient of a model among a plurality of facilities while protecting privacy of the user. The present system continuously updates a global model using the shared gradient. As the present technical effect, the present system maximizes processing throughput of the entire system and minimizes latency of data communication. The present system ensures scalability and fault tolerance by dynamic allocation of hardware resources. As a specific application field of the present system, the present system is applied to a national-scale healthcare data infrastructure system and an elderly support infrastructure in a smart city.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

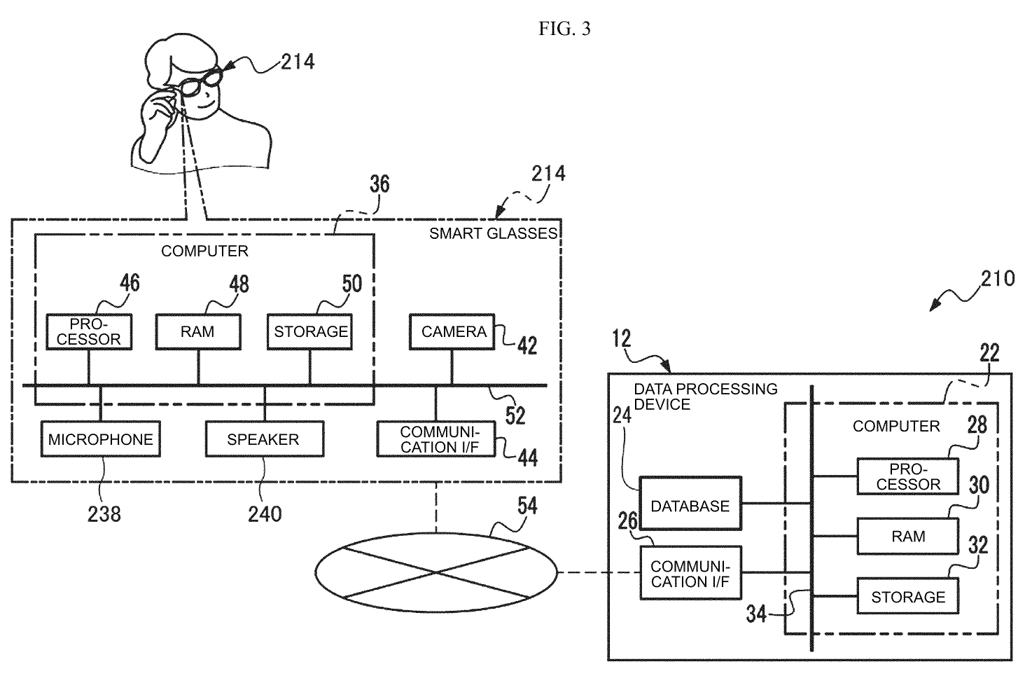

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

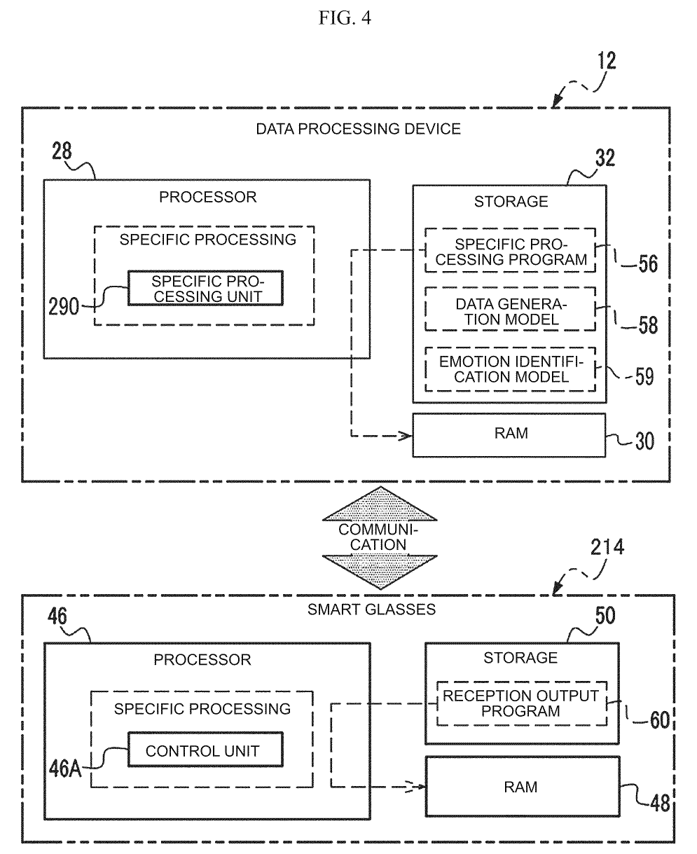

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a "server," and the smart glasses 214 are referred to as a "terminal."

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

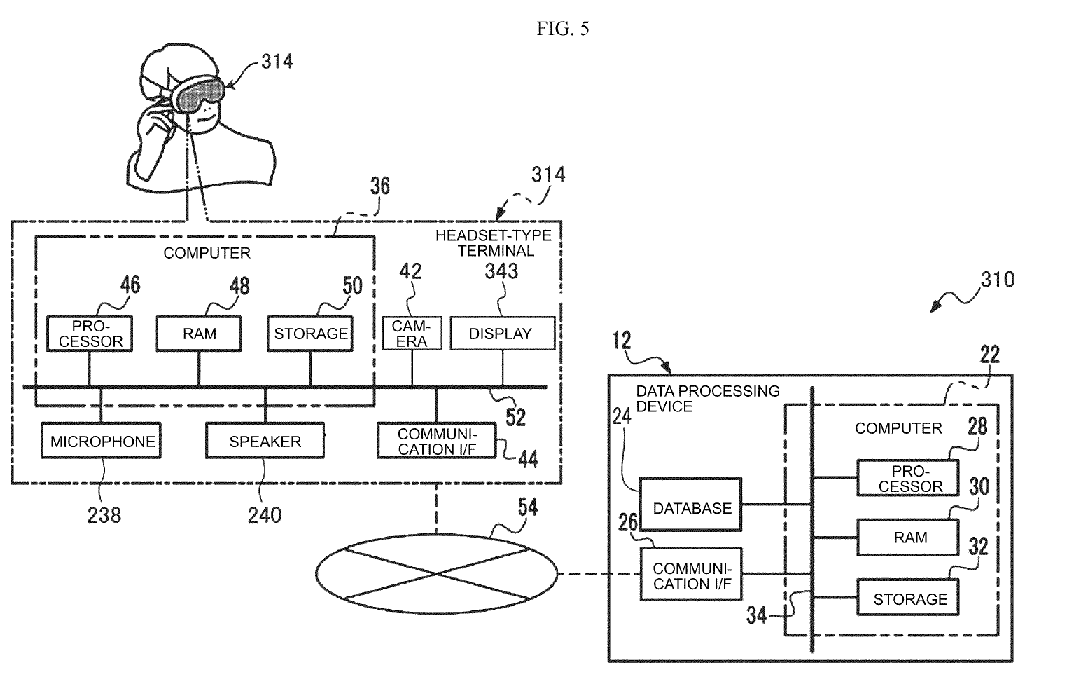

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

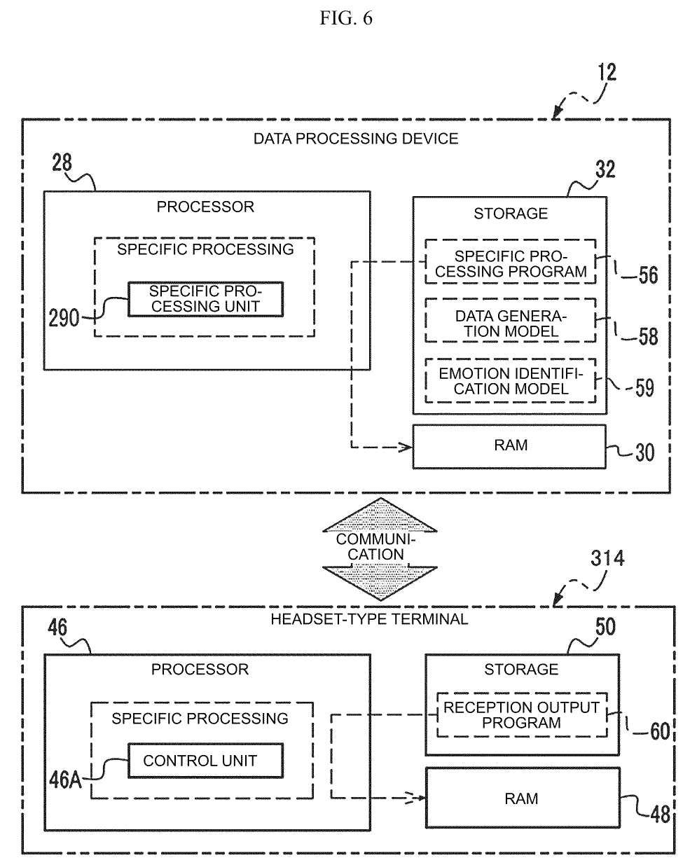

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a "server," and the headset-type terminal 314 is referred to as a "terminal."

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

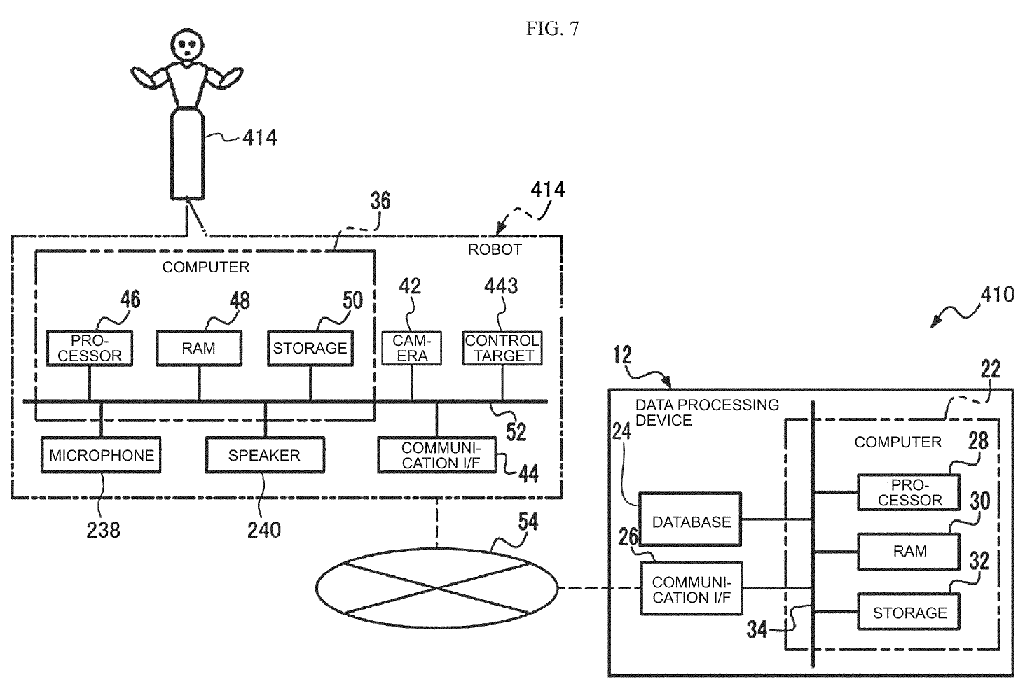

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

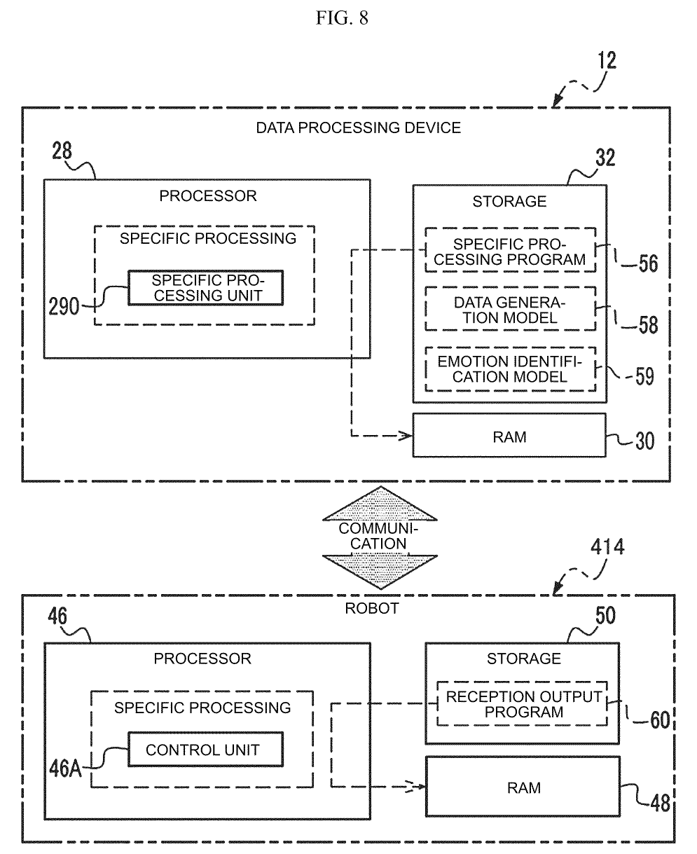

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a "server," and the robot 414 is referred to as a "terminal."

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

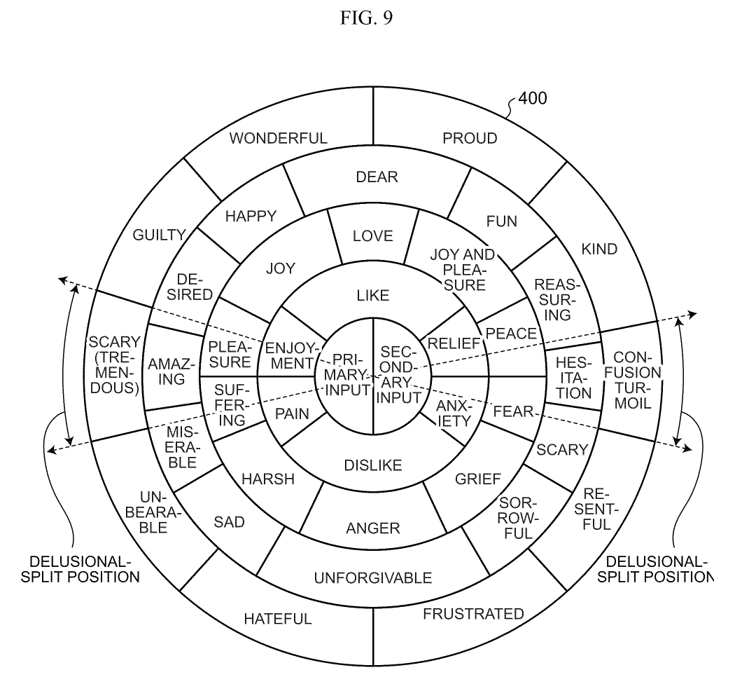

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

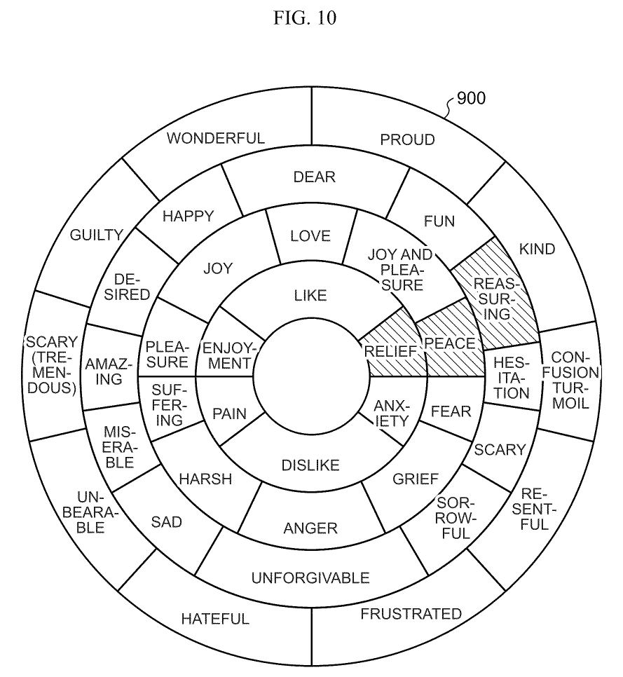

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### SUPPLEMENTARY NOTE 1

A system comprising: a health data acquisition unit; a daily activity data acquisition unit; a communication data acquisition unit; a nursing care record acquisition unit; a data integration unit; a cognitive function and physical function evaluation unit; a risk prediction unit; a nursing care plan generation unit; and an AI care coaching unit, wherein the health data acquisition unit is configured to automatically acquire health-related data such as a heart rate, a blood pressure, a body temperature, a number of steps, a sleep time, a body weight, a blood glucose level, a medication history, a medical history, a family history, and a periodic health examination result of a user from a wearable device, a health management application, or the like; the daily activity data acquisition unit is configured to acquire, from a sensor or a terminal, a frequency of going out, a moving distance, an amount of exercise, a number of times of participation in hobby activities, an implementation status of housework, a sleep rhythm, a meal time, a bathing time, a television viewing time, a reading time, a diversity of walking courses, and the like of the user; the communication data acquisition unit is configured to acquire a conversation frequency, conversation contents, a diversity of topics, presence or absence of emotional expression, repetition of the same topic, a response speed to a question, a topic switching frequency, a usage status of an SNS or a message application, and the like of the user; the nursing care record acquisition unit is configured to acquire a record by a nursing care staff such as a meal, bathing, excretion, movement, a fall, forgetfulness, and a recreation participation status; the data integration unit is configured to integrally manage these data in chronological order for each user; the cognitive function and physical function evaluation unit is configured to analyze an integrated data set using a generative AI to calculate a cognitive function score and a physical function score from contents and a frequency of conversation, a declaration of forgetfulness, a walking or moving pattern, a record of a fall or an accident, a status of a meal or excretion, a frequency of social interaction, a recreation participation status, and the like; the risk prediction unit is configured to comprehensively analyze a family history, a medical history, a transition of cognitive and physical scores, a fall history, a medication status, a frequency of social interaction, a change in a meal or sleep, and the like using a machine learning model by a generative AI to individually predict a risk of dementia or physical function decline; the nursing care plan generation unit is configured to automatically generate an individually optimized nursing care plan, a rehabilitation menu, a life support proposal, and feedback for a family and a nursing care staff using a generative AI based on a risk prediction result, interests, a living situation, a family structure, a past activity history, and the like of the user; and the AI care coaching unit is configured to propose the nursing care plan, the rehabilitation menu, life support advice, and the feedback to the user and the nursing care staff through a terminal, a voice assistant, a chatbot, or the like, monitor an implementation status and a reaction of the user, and perform periodic re-evaluation and alert transmission at the time of abnormality detection.

### Supplementary Note 2

The system according to Supplementary Note 1, wherein the AI care coaching unit is configured to analyze an activity implementation status, emotional expression, a life rhythm, a physical condition change, feedback from a family and a nursing care staff, and the like of the user in real time using a generative AI, dynamically generate and provide encouragement, a reminder, an alert, and an action proposal at an optimal timing and method for each user, and automatically update the nursing care plan and the rehabilitation menu according to a reaction and an implementation status of the user.

### Supplementary Note 3

The system according to Supplementary Note 1, wherein the nursing care plan generation unit is configured to comprehensively consider a plurality of factors such as a cognitive function score, a physical function score, interests, a living situation, a family structure, a past activity history, a social interaction status, a health condition, a fall history, a medication status, and a medical institution consultation history of the user using a generative AI, automatically generate an individually optimized nursing care plan combining a plurality of types of interventions such as music therapy, individual rehabilitation, life support advice, a recreation proposal, introduction of a social participation event, recommendation of a medical examination by a specialist, and feedback for a family and a staff, and further customize contents and a difficulty level of the rehabilitation menu and cognitive stimulation contents for each user using a generative AI.

What is claimed is:

1. A system comprising:
circuitry configured to:
receive, via a communication interface coupled to a packet-switched network, heterogeneous time-series data streams from a plurality of IoT sensor devices, execute primary noise removal and timestamp processing at an edge computing node to generate edge-processed feature vectors, and transmit the edge-processed feature vectors to a cloud computing node via the communication interface;
retrieve structured data records from external data service endpoints via the communication interface, and construct an integrated data tensor at the cloud computing node by fusing the edge-processed feature vectors with the structured data records;
apply a natural language processing model to text data streams received via the communication interface to extract linguistic feature vectors comprising vocabulary complexity scores, sentence length distributions, and topic diversity scores;
apply a generative neural network model to the integrated data tensor and the linguistic feature vectors to compute a state transition prediction score comprising a plurality of risk dimension components; and
generate an output instruction sequence by applying a retrieval-augmented generation process to the state transition prediction score with reference to context data retrieved from a vector database, activate a processing pipeline when the state transition prediction score exceeds a threshold parameter, and transmit the output instruction sequence to a terminal device via the communication interface.

2. The system according to claim 1, wherein the circuitry is configured to
apply a motion classification model to time-series acceleration and angular velocity arrays received from IoT sensor devices via the communication interface to generate activity state classification labels, aggregate activity state classification labels over a time window to compute behavioral frequency metrics for each activity state category, and incorporate the behavioral frequency metrics as feature dimensions in the integrated data tensor.

3. The system according to claim 2, wherein the circuitry is configured to
compare behavioral frequency metrics against historical baseline behavioral frequency distributions stored in the storage device, compute a behavioral deviation score for each activity state category, and generate a deviation alert when a behavioral deviation score exceeds a deviation threshold parameter.

4. The system according to claim 1, wherein the circuitry is configured to
accumulate the integrated data tensor in a longitudinal data structure in the storage device in chronological order, apply a moving average filter to continuous value dimensions of the longitudinal data structure to extract trend components, and detect a trend deviation by comparing current trend components against historical baseline trend components.

5. The system according to claim 4, wherein the circuitry is configured to
apply the generative neural network model to the longitudinal data structure to identify correlated change events across different feature dimensions over multiple time windows, generate a multivariate correlation feature vector representing inter-variable dependency patterns, and incorporate the multivariate correlation feature vector into the integrated data tensor prior to state transition prediction score computation.

6. The system according to claim 1, wherein the circuitry is configured to
compute a temporal change metric for the linguistic feature vectors by comparing current linguistic feature vectors against longitudinal baseline linguistic feature vectors stored in the storage device, and incorporate the temporal change metric as an additional input feature to the generative neural network model during state transition prediction score computation.

7. The system according to claim 1, wherein the circuitry is configured to
apply an anomaly detection model to the time-series data streams to compute reconstruction error scores by comparing predicted sensor values against observed sensor values, generate an anomaly signal when a reconstruction error score exceeds an anomaly threshold parameter, and update the state transition prediction score when an anomaly signal is generated.

8. The system according to claim 7, wherein the circuitry is configured to
issue an escalated control command to terminal devices associated with designated contact user identifiers when the state transition prediction score transitions above a first threshold parameter, and issue an emergency response command via the communication interface when the state transition prediction score exceeds a second threshold parameter higher than the first threshold parameter.

9. The system according to claim 1, wherein the circuitry is configured to
apply the generative neural network model to the linguistic feature vectors by tokenizing text data streams and computing attention-weighted representations of semantically salient token sequences, extract a vocabulary complexity score by computing type-token ratio statistics, and extract a topic diversity score by computing entropy over topic category label distributions.

10. The system according to claim 1, wherein the circuitry is configured to
generate a progress report data record from the state transition prediction score and output instruction sequence implementation status received from terminal devices via the communication interface, and transmit the progress report data record to designated contact terminal devices at configurable periodic intervals.

11. The system according to claim 1, wherein the circuitry is configured to
receive updated structured data records from external data service endpoints via the communication interface at configurable polling intervals, update the integrated data tensor with the received data records, and regenerate the state transition prediction score by re-applying the generative neural network model to the updated integrated data tensor.

12. The system according to claim 11, wherein the circuitry is configured to
monitor the regenerated state transition prediction score after each polling update, and issue an alert control command to a terminal device associated with a contact user identifier when the score increases above an alert threshold parameter between consecutive updates.

13. The system according to claim 1, wherein the circuitry is configured to
monitor an implementation status of the output instruction sequence by receiving completion event records from the terminal device via the communication interface, compute an implementation rate metric from the completion event records, and regenerate the output instruction sequence with adjusted prioritization when the implementation rate metric falls below an implementation threshold parameter.

14. The system according to claim 13, wherein the circuitry is configured to
update a machine learning model used for state transition prediction score computation by generating training pairs from historical integrated data tensors and corresponding validated state transition outcome records, and fine-tune the machine learning model on the training pairs to improve prediction accuracy.

15. The system according to claim 1, wherein the circuitry is configured to
execute the natural language processing model and generative neural network model inference on graphics processing unit accelerators in the cloud computing node, and distribute computation between the edge computing node and the cloud computing node based on current network latency measurements.

16. The system according to claim 1, wherein the circuitry is configured to
enforce a privacy access control policy by restricting access to the integrated data tensor and output instruction sequences to terminal devices associated with authorized user role parameters, and apply data minimization to return only fields within the permission scope of the requesting user role.

17. The system according to claim 1, wherein the IoT sensor devices comprise wearable monitoring devices configured to measure physiological parameter values, the structured data records comprise behavioral event records and contextual attribute data from domain-specific data service systems, and the output instruction sequence specifies prioritized operational response steps corresponding to the state transition prediction score.

18. A system comprising:
circuitry configured to:
receive, via a communication interface coupled to a packet-switched network, heterogeneous time-series data streams from a plurality of IoT sensor devices, execute noise removal and timestamp processing at an edge computing node to generate edge-processed feature vectors, and transmit the edge-processed feature vectors to a cloud computing node;
retrieve structured data records from external data service endpoints and construct an integrated data tensor by fusing the edge-processed feature vectors with the structured data records;
apply a natural language processing model to text data streams to extract linguistic feature vectors comprising vocabulary complexity scores, sentence length distributions, and topic diversity scores;
apply a generative neural network model to the integrated data tensor and the linguistic feature vectors to compute a state transition prediction score; and
generate an output instruction sequence by retrieval-augmented generation conditioned on the state transition prediction score, activate a processing pipeline when the score exceeds a threshold parameter, and transmit the output instruction sequence to a terminal device.

19. The system according to claim 18, wherein the circuitry is configured to
accumulate the integrated data tensor in a longitudinal data structure to detect trend deviations by comparing current trend components against historical baselines, apply an anomaly detection model to update the state transition prediction score when reconstruction error exceeds an anomaly threshold, and issue an escalated control command when the score exceeds a first threshold and an emergency response command when it exceeds a second higher threshold.

20. A method comprising:
receiving, via a communication interface coupled to a packet-switched network, heterogeneous time-series data streams from a plurality of IoT sensor devices, executing noise removal and timestamp processing at an edge computing node to generate edge-processed feature vectors, and transmitting the edge-processed feature vectors to a cloud computing node;
retrieving structured data records from external data service endpoints and constructing an integrated data tensor by fusing the edge-processed feature vectors with the structured data records;
applying a natural language processing model to text data streams to extract linguistic feature vectors comprising vocabulary complexity scores, sentence length distributions, and topic diversity scores;
applying a generative neural network model to the integrated data tensor and the linguistic feature vectors to compute a state transition prediction score comprising a plurality of risk dimension components; and
generating an output instruction sequence by retrieval-augmented generation conditioned on the state transition prediction score, activating a processing pipeline when the state transition prediction score exceeds a threshold parameter, and transmitting the output instruction sequence to a terminal device via the communication interface.
